(19) United States
(12) Patent Application Publication
(10) Pub. No.: US 2007/0046674 A1
(43) Pub. Date: Mar. 1, 2007

(54) Graphic display control device for displaying graph and graphic and recording medium

(75) Inventor: Tomohiro Sudoh, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: CASIO COMPUTER CO., LTD., Tokyo (JP)

(21) Appl. No.: 11/592,353

(22) Filed: Nov. 3, 2006

Related U.S. Application Data
(62) Division of application No. 10/868,868, filed on Jun. 15, 2004.
Application No. 10/868,868 is a continuation of application No. PCT/JP03/12368, filed on Sep. 26, 2003.

(30) Foreign Application Priority Data
Sep. 27, 2002 (JP) 2002-284076
Sep. 30, 2002 (JP) 2002-286117
Sep. 30, 2002 (JP) 2002-287092

(51) Int. Cl. G06T 11/20

(52) U.S. Cl. 345/440

(57) ABSTRACT

A graphic display control device easily changes a display of a graph or graphic by operating an area where a graph or graphic is generally displayed. When a CPU detects trace execution inputting, the CPU displays a trace pointer on a graph, and simultaneously displays coordinates at which the trace pointer is positioned. Further, when the CPU detects an operation of a graph controller by an input pen, the CPU adds a predetermined value to an x-coordinate value of the trace pointer to perform tracing of the graph.

### CROSS-REFERENCE TO RELATED APPLICATIONS

This application is a Divisional Application of application Ser. No. 10/868,868, filed Jun. 15, 2004 which is a Continuation Application of PCT Application No. PCT/JP03/12368, filed Sep. 26, 2003, which was published by the International Bureau on 8 Apr. 2004 (08.04.2004) under No. WO 2004/029791.

This application is based upon and claims the benefit of priority from prior Japanese Patent Applications No. 2002-284076, filed Sep. 27, 2002; No. 2002-286117, filed Sep. 30, 2002; and No. 2002-287092, filed Sep. 30, 2002, the entire contents of all of which are incorporated herein by reference.

### BACKGROUND OF THE INVENTION

1. Field of the Invention

The present invention relates to a graphic display control device for displaying a graph and a graphic, and a recording medium.

2. Description of the Related Art

Conventionally, a function electronic calculator comprising a graph display function or a graphic display function has been used in the field of education or for technical calculation by engineers. The function electronic calculator incorporates various function calculation programs therein, and designates a function equation to be expressed by a graph so that a graph indicating the function equation can be drawn on a display screen.

There has been known a function electronic calculator which displays various icons for controlling display of a graph or graphic on a screen and moves or changes a graph according to a selected icon as one of such function electronic calculators.

However, in the case of the function electronic calculator described above, since an icon for instructing to move or change a displayed graph is displayed on the screen, for example, when the number of graph display functions is increased, the number of icons is accordingly increased so that the screen must be increased for the display of the icons or the display area of a graph or graphic must be reduced.

In the case where a plurality of windows in association with execution of an application are displayed on the screen, since, when the application is changed, the display of the window is also eliminated, a function equation or the like displayed on the window cannot be processed by another application.

Conventionally, a graph function electronic calculator having a graph (or graphic) display function has been used in the field of education or for technical calculation by engineers. The function electronic calculator incorporates various function calculation programs, and is capable of displaying a graph based on an input function equation.

Generally, the graph function electronic calculator means a device which calculates a coordinate according to a set coordinate range when a function equation is input, and continuously displays a plot on the coordinate axes displayed on a display screen on the basis of the calculated coordinate to draw a graph.

As one of such graph function electronic calculators, there has been known a graph function electronic calculator which draws a graph having a desired shape (for example, quadratic curve) on the screen of the graph function electronic calculator, displays a corresponding function equation (y=ax²) when a minimum point of the graph and an arbitrary coordinate are input, and displays a graph corresponding to the function equation.

However, when a graph is displayed on the graph function electronic calculator described above, it is required that the entire function equation is input or the graph is drawn to input the minimum point of the graph and an arbitrary coordinate. Therefore, for example, when a graph based on a partial term is desired to display in a function equation constituted by a plurality of terms, the partial term is required to input as one function equation again so that it has been taken some times.

### BRIEF SUMMARY OF THE INVENTION

It is an object of the present invention to provide a graphic display control device capable of easily changing a display of a graph or graphic by operating an area on which a typical graph or graphic is displayed, and a recording medium storing a computer program for performing the above graphic display control.

It is another abject of the present invention to provide a convenient graphic display control device capable of easily changing a display of a graph or graphic, and a recording medium storing a computer program for performing the above graphic display control.

It is another object of the present invention to provide a graphic display control device capable of easily displaying a graph for part of a function equation, and a recording medium storing a computer program for performing the above graphic display control.

In order to achieve the above objects, a graphic display control device according to one aspect of the present invention capable of displaying a graph and coordinate axes on a display screen integrally formed with a touch panel while detecting a touch operation for a predetermined portion of the coordinate axes, and performing a display change process of the display screen when a touch operation is detected.

According to this aspect, a touch operation is performed on a predetermined portion of the coordinate axes so that various display change processes can be performed for the display screen.

A graphic display control device according to another aspect of the present invention comprises an equation display device which displays an equation and a graph display device which displays a graph based on the equation and coordinate axes, wherein, when a first operation of designating or selecting a coefficient of an equation displayed on the equation display device is performed, and then a second operation for a predetermined portion of the coordinate axes displayed on the graph display device is performed, the coefficient designated or selected by the first operation is registered in the predetermined portion of the coordinate axes; and when a third operation for the predetermined portion of the coordinate axes is performed after this coefficient is registered, a value of the registered coefficient is changed to redisplay the graph displayed on the graph display device along with the change in the coefficient.

According to this aspect, a value of the registered coefficient can be changed and the graph displayed on the graph display device can be redisplayed along with the change in the coefficient by a simple operation of, when the first operation of designating or selecting a coefficient of an equation displayed on the equation display device and the second operation for the predetermined portion of the coordinate axes displayed on the graph display device after the first operation are performed, registering a coefficient of the function equation displayed on the equation display device in the predetermined portion of the coordinate axes, and then performing the second operation for the predetermined portion of the coordinate axes. Therefore, a user can easily confirm a change in the shape of the graph along with the change in the registered coefficient.

A graphic display control device according to another aspect comprises a function equation display device which displays a function equation and a graph display device which displays a graph and coordinate axes, wherein after a first operation of designating or selecting a function equation displayed on the function equation display device is performed, and then a second operation of moving the function equation designated or selected by the first operation into the graph display device is performed after the first operation, a graph based on the designated or selected function equation is displayed and controlled on the graph display device; when a third operation for a predetermined portion of the coordinate axes displayed on the graph display device is performed after the first operation for the function equation displayed on the function equation display device, the function equation designated or selected by the first operation is registered in the predetermined portion of the coordinate axes; and when the third operation is performed after the function equation designated or selected by this first operation is registered in the predetermined portion of the coordinate axes, a graph based on the registered function equation is displayed and controlled on the graph display device.

According to another aspect of the present invention, when the third operation for a predetermined potion of the coordinate axes displayed on the graph display device is performed after the first operation for a function equation displayed on the function equation display device, the function equation designated or the selected by the first operation is registered in the predetermined portion of the coordinate axes, and then the third operation for the predetermined portion of the coordinate axes is performed so that a graph based on this registered function equation can be displayed and controlled on the graph display device. Therefore, the user can rapidly and easily display the graph corresponding to the registered function equation by performing the third operation for the predetermined portion of the coordinate axes at an arbitrary timing.

A graphic display control device according to another aspect of the present invention comprises a function equation display device which displays a function equation and a graph display device which displays a graph and coordinate axes, wherein, when a first operation of designating or selecting a function equation displayed on the function equation display device and a second operation of moving the function equation designated or selected by the first operation into the graph display device are performed, a graph based on the function equation designated or selected by the first operation is displayed and controlled on the graph display device; a predetermined calculation process is registered by a third operation for a predetermined portion of the coordinate axes; and when the first operation for the function equation displayed on the function equation display device and a fourth operation for the predetermined portion of the coordinate axes are performed, a graph as a result of execution of the calculation process to the graph based on the function equation designated or selected by the first operation is displayed and controlled on the graph display device.

According to another aspect, the calculation process corresponded to the predetermined portion is performed so that the graph as a result of this execution can be displayed and controlled on the graph display device by a simple operation of registering the calculation process in the predetermined portion on the coordinate axes, and then moving the designated or selected function equation to the predetermined portion on the coordinate axes. Therefore, the user can easily perform the calculation process for the graph.

A graphic display control device according to another aspect of the present invention comprises a first display device which displays a function equation and a second display device which displays a graph and is directed for displaying and controlling a graph based on the function equation displayed on the first display device, wherein, when a predetermined copy operation for part of the function equation displayed on the first display device is performed, the part is assumed to be a function equation, and a graph based on the assumed function equation is displayed and controlled on the second display device.

According to another aspect, a graph corresponding to part of the function equation displayed on the first display device can be easily displayed. Specifically, for example, when the function equation is polynomial and a graph corresponding to the partial term is desired to display, the graph can be easily displayed by performing the predetermined copy operation without the need to input the partial term as a new function equation again. Therefore, it can be easily confirmed how the part of the function equation is concerned with the entire function equation or the graph.

### BRIEF DESCRIPTION OF THE SEVERAL VIEWS OF THE DRAWING

FIG. 1 is a view showing one example of an appearance of a function electronic calculator;

FIG. 2 is a diagram for explaining a display configuration of a display screen;

FIG. 3 is a block diagram showing a configuration of the function electronic calculator;

FIG. 4 is a flow chart for explaining an operation of a trace pointer movement control process according to a first embodiment of the invention;

FIGS. 5A, 5B, 5C, and 5D are diagrams showing transition examples of a screen displayed on a display device according to the first embodiment;

FIGS. 6A and 6B are diagrams showing data structures of a ROM and a RAM according to a second embodiment of the invention;

FIG. 7 is a flow chart for explaining an operation of a graph scroll control process according to the second embodiment;

FIGS. 8A, 8B, and 8C are diagrams showing transition examples of a screen displayed on a display device according to the second embodiment;

FIGS. 9A and 9B are diagrams showing data structures of a ROM and a RAM according to a third embodiment of the invention;

FIG. 10 is a flow chart for explaining an operation of a trace pointer movement & graph scroll control process according to the third embodiment;

FIGS. 11A, 11B, 11C, 11D, and 11E are diagrams showing transition examples of a screen displayed on a display device according to the third embodiment;

FIGS. 12A and 12B are diagrams showing data structures of a ROM and a RAM according to a fourth embodiment of the invention;

FIG. 13 is a flow chart showing an operation of a graph switch control process according to the fourth embodiment;

FIGS. 14A, 14B, 14C, and 14D are diagrams showing transition examples of a screen displayed on a display device according to the fourth embodiment;

FIGS. 15A and 15B are diagrams showing data structures of a ROM and a RAM according to a fifth embodiment of the invention;

FIG. 16 is a flow chart for explaining an operation of a variable change control process according to the fifth embodiment;

FIGS. 17A, 17B, 17C, 17D, 17E, and 17F are diagrams showing transition examples of a screen displayed on a display device according to the fifth embodiment;

FIGS. 18A and 18B are diagrams showing data structures of a ROM and a RAM according to a sixth embodiment of the invention;

FIG. 19 is a flow chart for explaining an operation of a graph transformation control process according to the sixth embodiment;

FIG. 20 is a flow chart for explaining an operation of the graph transformation control process according to the sixth embodiment subsequent to FIG. 19;

FIGS. 21A, 21B, 21C, 21D, and 21E are diagrams showing transition examples of a screen displayed on a display device according to the sixth embodiment;

FIGS. 22A and 22B are diagrams showing data structures of a ROM and a RAM according to a seventh embodiment of the invention;

FIG. 23 is a flow chart for explaining an operation of a pointer position movement control process according to the seventh embodiment;

FIGS. 24A, 24B, 24C, and 24D are diagrams showing transition examples of a screen displayed on a display device according to the seventh embodiment;

FIGS. 25A and 25B are diagrams showing data structures of a ROM and a RAM according to an eighth embodiment of the invention;

FIG. 26 is a flow chart for explaining an operation of a page switch control process according to the eighth embodiment;

FIGS. 27A, 27B, and 27C are diagrams showing transition examples of a screen displayed on a display device according to the eighth embodiment;

FIGS. 28A and 28B are diagrams showing data structures of a ROM and a RAM according to a ninth embodiment of the invention;

FIG. 29 is a flow chart for explaining an operation of a graph enlarged/reduced display control process according to the ninth embodiment;

FIGS. 30A, 30B, 30C, 30D, and 30E are diagrams showing transition examples of a screen displayed on a display device according to the ninth embodiment;

FIGS. 31A and 31B are diagrams showing data structures of a ROM and a RAM according to a tenth embodiment of the invention;

FIG. 32 is a flow chart for explaining an operation of a 3D graphic rotation control process according to the tenth embodiment;

FIGS. 33A, 33B, and 33C are diagrams snowing transition examples of a screen displayed on a display device according to the tenth embodiment;

FIGS. 34A and 34B are diagrams showing data structures of a ROM and a RAM according to an eleventh embodiment of the invention;

FIG. 35 is a flow chart for explaining an operation of a 3D graphic display control process according to the eleventh embodiment;

FIGS. 36A, 36B, 36C, and 36D are diagrams showing transition examples of a screen displayed on a display device according to the eleventh embodiment;

FIG. 37 is a view showing one example of an appearance of a function electronic calculator according to a twelfth embodiment of the invention;

FIG. 38 is a diagram for explaining a display configuration of a display screen of the twelfth embodiment;

FIG. 39 is a block diagram showing a configuration of the function electronic calculator of the twelfth embodiment;

FIG. 40 is a flow chart for explaining an operation of a function equation display control process according to the twelfth embodiment;

FIGS. 41A and 41B are diagrams showing transition examples of a screen displayed on a display device according to the twelfth embodiment;

FIGS. 42A and 42B are diagrams showing data structures of a ROM and a RAM according to a thirteenth embodiment of the invention;

FIG. 43 is a flow chart for explaining an operation of a graph display control process according to the thirteenth embodiment;

FIGS. 44A, 44B, and 44C are diagrams showing transition examples of a screen displayed on a display device according to the thirteenth embodiment;

FIGS. 45A and 45B are diagrams showing data structures of a ROM and a RAM according to a fourteenth embodiment of the invention;

FIG. 46 is a flow chart for explaining an operation of a process command control process according to the fourteenth embodiment;

FIGS. 47A, 47B, 47C, and 47D are diagrams showing transition examples of a screen displayed on a display device according to the fourteenth embodiment;

FIGS. 48A and 48B are diagrams showing data structures of a ROM and a RAM according to a fifteenth embodiment of the invention;

FIG. 49 is a flow chart for explaining an operation of a variable change control process according to the fifteenth embodiment;

FIGS. 50A, 50B, and 50C are diagrams showing transition examples of a screen displayed on a display device according to the fifteenth embodiment;

FIGS. 51A, 51B, and 51C are diagrams showing other transition examples of the screen displayed on the display device according to the fifteenth embodiment;

FIGS. 52A and 52B are diagrams showing data structures of a ROM and a RAM according to a sixteenth embodiment of the invention;

FIG. 53 is a flow chart for explaining an operation of a function equation registration control process according to the sixteenth embodiment;

FIGS. 54A, 54B, 54C, and 54D are diagrams showing transition examples of a screen displayed on a display device according to the sixteenth embodiment;

FIG. 55 is a diagram showing a data structure of a ROM according to a seventeenth embodiment of the invention;

FIG. 56 is a diagram showing a data structure of a RAM according to the seventeenth embodiment;

FIG. 57 is a flow chart for explaining an operation of a graph process control process according to the seventeenth embodiment;

FIGS. 58A, 58B, and 58C are diagrams showing transition examples of a screen displayed on a display device according to the seventeenth embodiment;

FIG. 59 is a view showing one example of an appearance of a function electronic calculator according to an eighteenth embodiment of the invention;

FIG. 60 is a diagram for explaining a display configuration of a display screen;

FIG. 61 is a block diagram showing a configuration of the function electronic calculator of the eighteenth embodiment;

FIG. 62 is a flow chart for explaining an operation of a graph drawing process performed by the function electronic calculator of the eighteenth embodiment;

FIG. 63 is a flow chart for explaining an operation of an equation selection process performed by the function electronic calculator of the eighteenth embodiment; and

FIGS. 64A, 64B, 64C, 64D, and 64E are diagrams showing transition examples of a screen displayed on a display device of the eighteenth embodiment.

### DETAILED DESCRIPTION OF THE INVENTION

Hereinafter, embodiments of a graphic display control device according to the present invention will be described in detail with reference to the drawings. In the following, the present invention will be described by way of an example of a case where a function electronic calculator having a graph & graphic display function is applied, but the embodiments to which the present invention is applicable are not limited thereto.

### First Embodiment

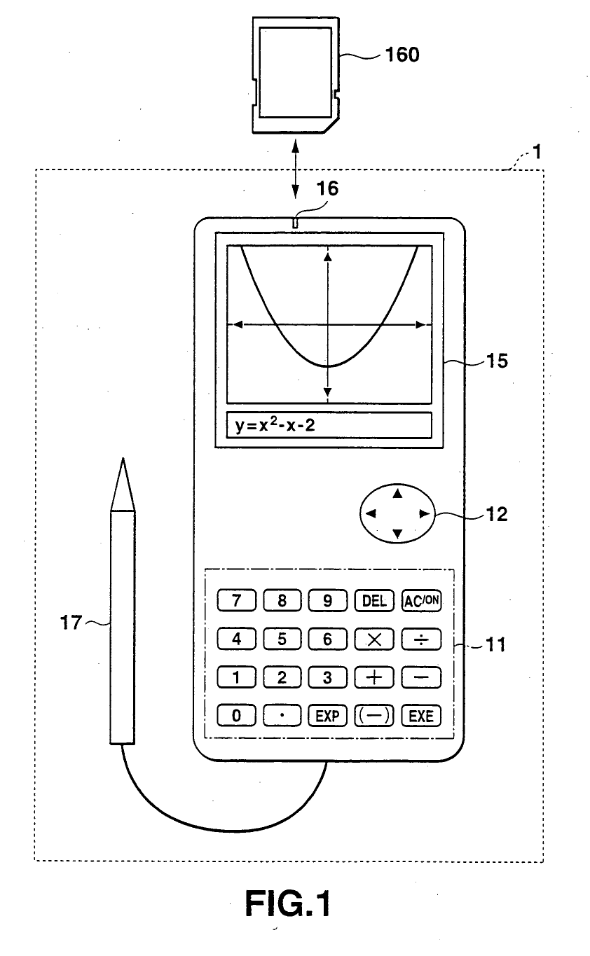

FIG. 1 is a view showing one example of an appearance of a function electronic calculator 1 according to the present embodiment. A case where a typical function electronic calculator is applied is exemplified as the function electronic calculator 1, but a calculation device (computer) comprising a calculating function may be employed and the function electronic calculator is not limited to the above.

The function electronic calculator 1 comprises a calculation unit (not shown) which performs a calculation process, operation input keys 11 which perform inputting of numeric/function/calculation operation, a direction key 12 which performs scrolling of a screen or selection operation, a display screen 15 which displays input numerals or graphs, an input pen 17, and a power supply (not shown) such as an incorporated battery or a solar battery. The function electronic calculator 1 is cased, for example, in a card shape by a metal or a resin.

The operation input keys 11 and the direction key 12 are operation inputting means similar to the conventional function electronic calculator 1, and can be realized by a key switch, a touch panel, or the like, for example.

The display screen 15 is a portion on which various data such as characters, codes, or graph displays in response to the pressing of the operation input keys 11, which are required for using the function electronic calculator 1, are displayed, and on which characters or graphics are displayed by dots. The display screen 15 is an element such as a LCD (Liquid Crystal Display) or an ELD (Electronic Luminescent Display), and can be realized by a single element or a combination of several elements.

The function electronic calculator 1 comprises a slot 16 for a storage medium 160. The storage medium 160 is a storage medium which stores function equation data and the like therein, such as, for example, a memory card, or a hard disk. The slot 16 is a device which detachably mounts the storage medium 160 and can read/write data from/into the storage medium 160, and is appropriately selected according to the type of the storage medium 160.

A tablet (touch panel) is integrally constituted on the display screen 15, where press-inputting by the input pen 17 can be sensed.

Various functions such as a calculating function, a graph function, a program function, and the like are mounted on the function electronic calculator 1, and each function described above can be executed by selecting an operation mode corresponding to the function to be utilized. For example, when the operation input keys 11 or the like are used to perform a selection operation of a graph mode, the operation mode is set to the graph mode so that a graphic such as a graph can be drawn in the coordinate system based on the set display range.

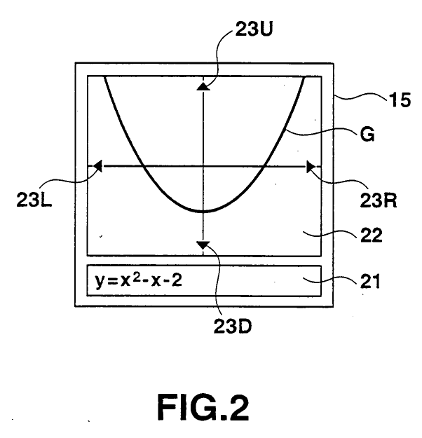

FIG. 2 is a diagram for explaining a display configuration of the display screen 15. A display area of the display screen 15 is divided into a function equation display area 21 and a graph display area 22. An equation or the like input by an operation of the operation input keys 11 or the like is displayed in the function equation display area 21.

A graph G indicating a function equation displayed in the function equation display area 21, a function equation stored in an internal memory of the function electronic calculator 1 or the storage medium 160, or the like is displayed in the graph display area 22 according to an instruction operation key (for example, execution (EXE) key) which instructs to display a graph. Assuming that a lateral direction in the graph display area 22 is an x coordinate and a longitudinal direction is a y coordinate, an x-axis 24 and a y-axis 25 are displayed in the graph display area 22. Graph controllers 23L and 23R and graph controllers 23U and 23D are displayed at both ends of the x-axis 24 and at both ends of the y-axis 25, respectively (hereinafter, the graph controllers 23L, 23R, 23U, and 23D are comprehensively referred to as the graph controller 23).

A description is given assuming that the display area of the display screen 15 is divided into the two areas (screens), i.e., the function equation display area 21 and the graph display area 22, but a function equation and a graph may be displayed on one area.

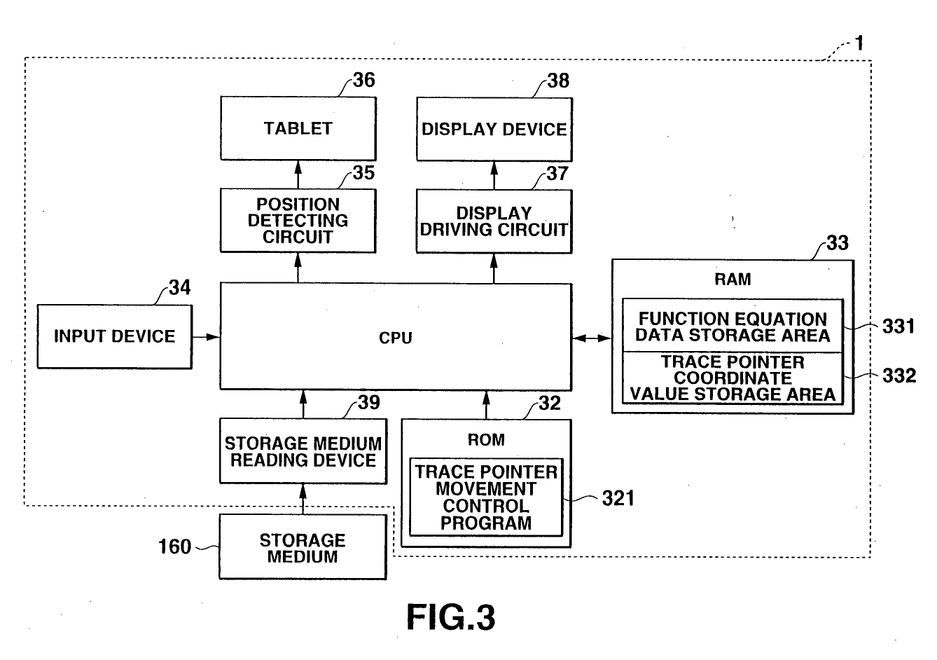

FIG. 3 is a block diagram showing an internal configuration of the function electronic calculator 1. The function electronic calculator 1 comprises a CPU (Central Processing Unit) 31, a ROM (Read Only Memory) 32, a RAM (Random Access Memory) 33, an input device 34, a position detecting circuit 35, a tablet 36, a display driving circuit 37, a display device 38, and a storage medium reading device 39.

The CPU 31 performs a process based on a predetermined program in response to an input instruction, and performs instructing to each section, transferring of data, and the like. Specifically, the CPU 31 reads out a program stored in the ROM 32 in response to an operation signal input from the input device 34 or the table 36, and performs a process according to the program. The CPU 31 stores a process result in the RAM 33 and appropriately outputs a display signal for displaying the process result to the display driving circuit 37 so as to display the display information corresponding to the display signal on the display device 38.

The ROM 32 stores various process programs relating to the operation of the function electronic calculator 1 such as various setting processes and various calculation processes, programs for realizing various functions which the function electronic calculator 1 comprises, and the like therein. Further, the ROM 32 stores a trace pointer movement control program 321 therein.

The trace pointer movement control program 321 is a program for causing the CPU 31 to perform a trace pointer movement control process of displaying a trace pointer on the graph displayed on the display device 38 and tracing the graph by the trace pointer.

The RAM 33 comprises a memory area which temporarily holds various programs executed by the CPU 31, data relating to execution of these programs, and the like, such as a function equation data storage area 331 and a trace pointer coordinate value storage area 332.

For example, function equations required when a graph such as linear function, quadratic function, trigonometric function, circle is created are stored in the function equation data storage area 331. A coordinate value indicated by the trace pointer on the graph displayed on the display device 38 is stored in the trace pointer coordinate value storage area 332.

The input device 34 is means by which a user inputs numerals, execution instruction of the calculation process, and the like, and corresponds to the operation input keys 11 and the direction key 12 in the example in FIG. 1. A signal corresponding to the key pressed by the user is output to the CPU 31. The input device 34 may include a pointing device such as a mouse, or the like.

The function electronic calculator 1 comprises the tablet (touch panel) 36 as an input device. The tablet 36 senses a position on the display device 38 indicated (touched) by an input pen (corresponding to the input pen 17 in FIG. 1), and outputs a signal according to the indicated (touched) position. The position detecting circuit 35 connected to the tablet 36 detects a position coordinate indicated on the display device 38 on the basis of the signal input from the tablet 36. When the tablet 36 is used, the position in the display area of the display device 38 can be directly designated. The input pen 17 is touched on the tablet 36 so that operations such as tap-in, drag, tap-out, and drop can be realized.

Tap-in means an operation of contacting the input pen 17 on the display screen 15, and tap-out means an operation of releasing the input pen 17 from the display screen 15 after contacted. Drag means an operation of sliding the input pen 17 onto the display screen 15 from tap-in to tap-out, and drop means an operation of tap-out after drag is performed.

The display driving circuit 37 controls the display device 38 on the basis of the display signal input from the CPU 31 and causes it to display various screens. The display device 38 is constituted by an LCD, an ELD, or the like. The display device 38 corresponds to the display screen 15 shown in FIG. 1, and is integrally formed with the tablet 36.

The storage medium reading device 39 is a function section for performing reading/writing of data from/into the storage medium 160 such as, for example, a memory card, or a hard disk. It corresponds to the slot 16 in FIG. 1.

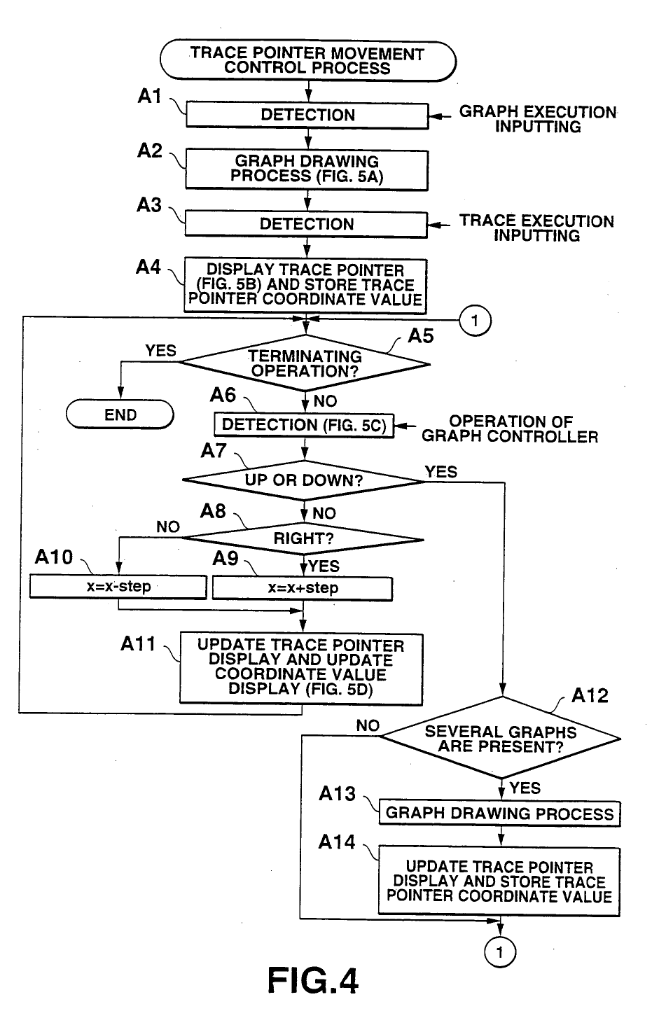

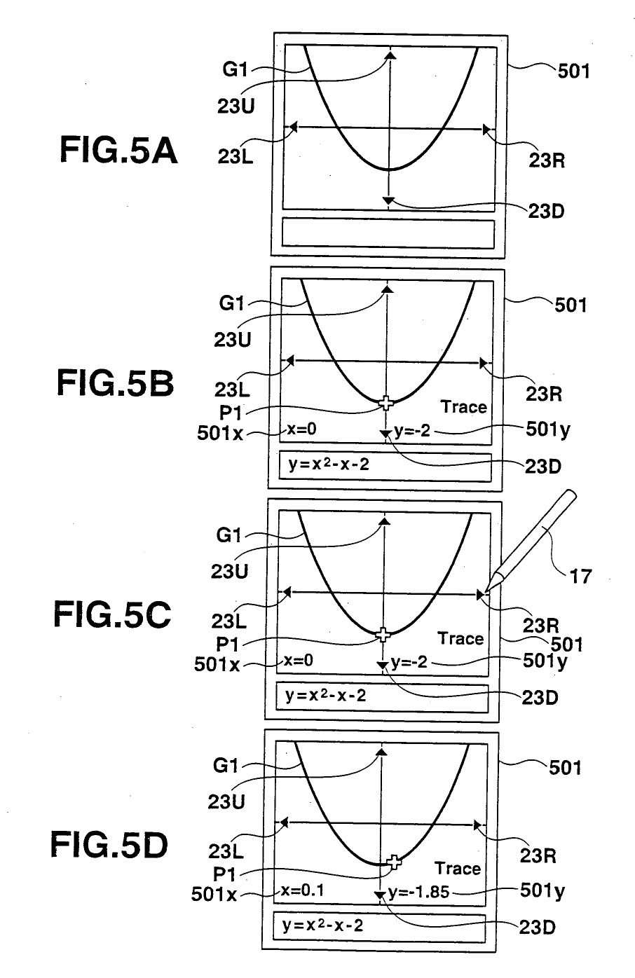

FIG. 4 is a flow chart for explaining an operation of the trace pointer movement control process performed by the function electronic calculator 1. FIGS. 5A, 5B, 5C, and 5D show transition examples of a screen displayed on the display device 38. A flow of the trace pointer movement control process will be described using FIGS. 4 and 5A to 5D.

When the graph mode is instructed by a mode switch operation, the CPU 31 starts execution of a predetermined program relating to the graph mode to set the graph mode, and waits for inputting of the setting items relating to the drawing of the graph such as inputting of an equation or a display range of the graph to be drawn. As shown in FIG. 4, when the CPU 31 detects graph execution inputting (step A1), the CPU 31 performs a graph drawing process according to the function equation stored in the function equation data storage area 331 and the input setting items (step A2; refer to FIG. 5A).

One example of a graph display screen 501 displayed at this stage is shown in FIG. 5A. As illustrated, a graph G1 based on the set display range is drawn on the graph display screen 501.

When the CPU 31 detects trace execution inputting (step A3), the CPU 31 displays a trace pointer P1 at a predetermined position of the graph G1, and displays coordinate values 501x and 501y indicating the position of the trace pointer P1. The coordinate values are stored in the trace pointer coordinate value storage area 332 (step A4; refer to FIG. 5B).

The CPU 31 monitors a terminating operation, and determines whether or not the graph controller 23 has been operated (tapped in/tapped out) by the input pen 17 (step A5). When it is determined that the terminating operation has been detected (step A5: Yes), the present process is terminated.

When the CPU 31 detects an operation of the graph controller 23 by the input pen 17 (step A5: No, step A6; refer to FIG. 5C), the CPU 31 determines whether or not the up or down graph controller 23U or 23D has been operated (step A7). When the operated graph controller is neither the graph controller 23U nor 23D (step A7: No), the CPU 31 determines whether or not the right graph controller 23R has been operated (step A8). When the right graph controller 23R has been operated (step A8: Yes), the CPU 31 adds a value of a variable “step” to the x coordinate value stored in the trace pointer coordinate value storage area 332 (step A9).

The variable “step” is the amount of increase per one dot in the x-axis of the coordinate displayed on the display device 38, and is previously set such as before the present process is performed. FIG. 5C is a diagram showing the operation of the graph controller 23R by the input pen 17.

When the left graph controller 23L, not the right one, has been operated (step A8: No), the CPU 31 subtracts the value of the variable “step” from the x coordinate value stored in the trace pointer coordinate value storage area 332 (step A1).

The CPU 31 updates the display of the trace pointer P1 and the display of the coordinate values 501x and 501y on the basis of the x coordinate value calculated in step A9 or A10 (step A11; refer to FIG. 5D).

When the CPU 31 determines that the graph controller 23U or 23D has been operated in step A7 (step A7: Yes), the CPU 31 determines whether or not a plurality of function equations are stored in the function equation data storage area 331 (step A12). When a plurality of function equations are not stored (step A12: No), the CPU 31 proceeds the process to step A5. When a plurality of function equations are stored (step A12: Yes), the CPU 31 switches to other function equation, and performs the graph drawing process (step A13).

The CPU 31 displays the trace pointer at a predetermined position on the graph drawn by the process in step A13, and displays the coordinate value indicated by the trace pointer. Further, the coordinate value is stored in the trace pointer coordinate value storage area 332 (step A14), and the process returns to the process in step A5.

As described above, according to the first embodiment, the trace pointer is displayed on the graph displayed on the display device 38 and the input pen 17 is used to operate the graph controller 23 so that tracing of the graph can be performed. Therefore, the user can easily perform the tracing of the graph.

Other embodiments of the graphic display control device according to the present invention will be described. The same portions as those of the first embodiment will be indicated in the same reference numerals and their detailed description will be omitted.

### Second Embodiment

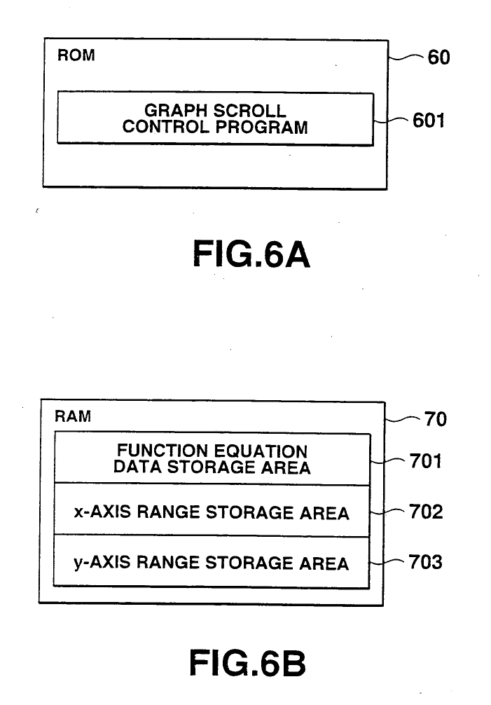

A second embodiment according to the present invention will be described. Since a configuration of a function electronic calculator according to the present embodiment is similar to that according to the first embodiment except that the ROM 32 and the RAM 33 are replaced with a ROM 60 shown in FIG. 6A and a RAM 70 shown in FIG. 6B, respectively, in the configuration of the function electronic calculator 1 described in FIG. 3 according to the first embodiment, like numerals are denoted to like constituents and a description thereof will be omitted below.

As shown in FIG. 6A, the ROM 60 comprises a graph scroll control program 601. The graph scroll control program 601 is a program for causing the CPU 31 to perform a graph scroll control process of vertically and horizontally moving and displaying the graph displayed on the display device 38.

As shown in FIG. 6B, the RAM 70 comprises a function equation data storage area 701, an x-axis range storage area 702, and a y-axis range storage area 703. A function equation corresponding to the graph displayed on the display device 38 is stored in the function equation data storage area 701. A maximum value and a minimum value of the x-axis displayed on the display device 38 are stored in the x-axis range storage area 702. A maximum value and a minimum value of the y-axis displayed on the display device 38 are stored in the y-axis range storage area 703.

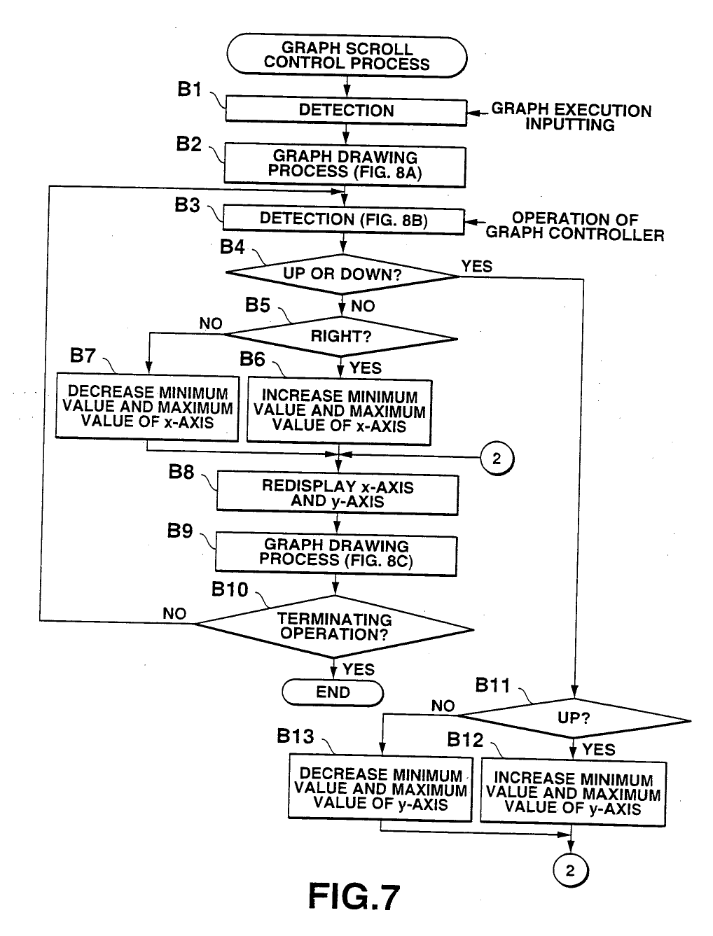

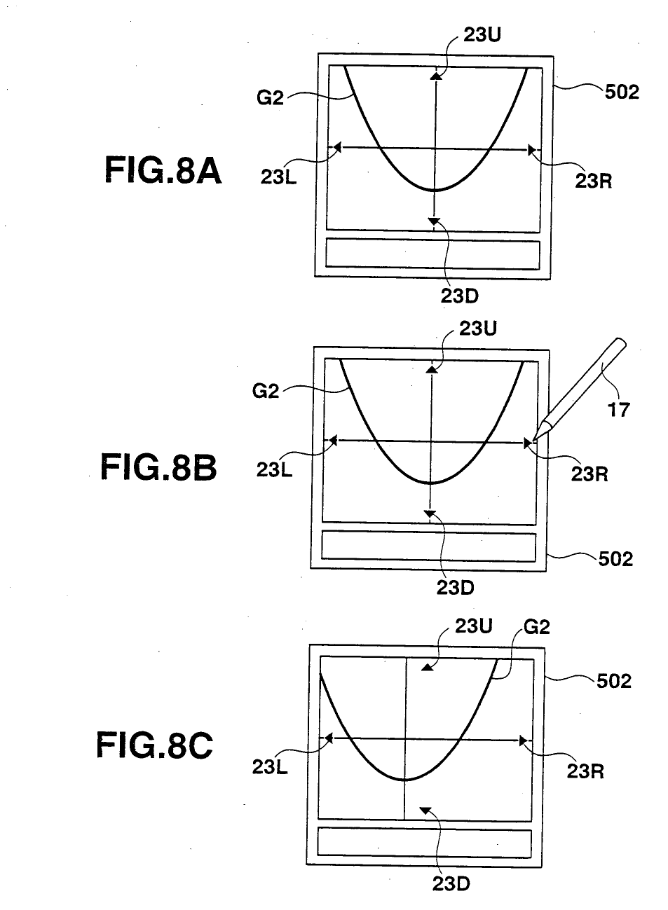

The graph scroll control process according to the second embodiment will be described with reference to FIGS. 7 and 8A to 8C. FIG. 7 shows a graph scroll operation flow of the function electronic calculator 1, and FIGS. 8A, 8B, and 8C are diagrams showing transition examples of a screen displayed on the display device 38.

When the graph mode is instructed by the mode switch operation, the CPU 31 starts execution of a predetermined program relating to the graph mode to set the graph mode, and waits for inputting of the setting items relating to the drawing of the graph such as inputting of an equation or a display range of the graph to be drawn. As shown in FIG. 7, when the CPU 31 detects graph execution inputting (step B1), the CPU 31 performs the graph drawing process according to the function equation stored in the function equation data storage area 701 and the input setting items (step B2, refer to FIG. 8A).

One example of a graph display screen 502 displayed at this stage is shown in FIG. 8A. As illustrated, a graph G2 based on the set display range is drawn on the graph display screen 502.

When the CPU 31 detects an operation of the graph controller 23 by the input pen 17 (step B3; refer to FIG. 8B), the CPU 31 determines whether or not the graph controller 23U or 23D has been operated (step B4). When the operated graph controller is neither the up graph controller 23U nor down graph controller 23D (step B4: No), the CPU 31 determines whether or not the right graph controller 23R has been operated (step B5). When the right graph controller 23R has been operated (step B5: Yes), the CPU 31 adds a predetermined value to the minimum value and the maximum value of the x-axis stored in the x-axis range storage area 702 (step B6). FIG. 8B is a diagram showing the operation of the graph controller 23R by the input pen 17.

The predetermined value means the amount of movement by which the graph G2 moves by one operation (tap operation) for the graph controller 23, and is previously set such as before the graph scroll control process is performed.

When the left graph controller 23 L has been operated (step B5: No), the CPU 31 subtracts the predetermined value from the minimum value and the maximum value of the x-axis stored in the x-axis range storage area 702 (step B7). The CPU 31 redisplays the x-axis and the y-axis according to the minimum values and the maximum values of the x-axis and the y-axis updated in steps B6 and B7 (step B8). Further, the CPU 31 performs the graph drawing process, and redisplays the scrolled graph (step B9; refer to FIG. 8C).

The CPU 31 monitors the terminating operation, and determines whether or not the graph controller 23 has been operated by the input pen 17 (step B10). When it is determined that the terminating operation has been detected (step B10: Yes), the present process is terminated. When it is determined that the graph controller 23 has been operated by the input pen 17, the process returns to step B3.

When the graph controller 23U or 23D has been operated in step B4 (step B4: Yes), the CPU 31 determines whether or not the up graph controller 23U has been operated (step B11). When the up graph controller 23U has been operated (step B11: Yes), the CPU 31 adds a predetermined value to the minimum value and the maximum value of the y-axis stored in the y-axis range storage area 702 (step B11). When the down graph controller 23D has been operated (step B11: No), the CPU 31 subtracts the predetermined value from the minimum value and the maximum value of the y-axis stored in the y-axis range storage area 702 (step B13). The CPU 31 redisplays the x-axis and the y-axis according to the minimum values and the maximum values of the x-axis and the y-axis updated in steps B12 and B13 (step B8), performs the graph drawing process, and redisplays the scrolled graph (step B9).

As described above, according to the second embodiment, the input pen 17 is used to operate the graph controller 23 so that scrolling of the graph can be performed. Therefore, the user can easily perform the scrolling of the graph.

### Third Embodiment

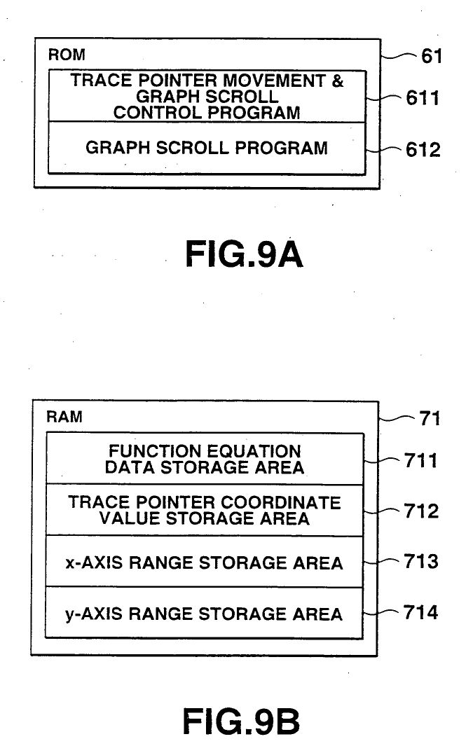

A third embodiment according to the present invention will be described. Since a configuration of a function electronic calculator according to the present embodiment is similar to a configuration where the ROM 32 and the RAM 33 are replaced with a ROM 61 shown in FIG. 9A and a RAM 71 shown in FIG. 9B, respectively, in the configuration of the function electronic calculator 1 described in FIG. 3 according to the first embodiment, like numerals are denoted to like constituents and a description thereof will be omitted below.

As shown in FIG. 9A, the ROM 61 comprises a trace pointer movement & graph scroll control program 611. The trace pointer movement & graph scroll control program 611 is a program for causing the CPU 31 to perform a trace pointer movement & graph scroll control process of displaying the trace pointer on the graph displayed on the display device 38, tracing the graph by the trace pointer, and further, when the trace pointer is moved out of the display area of the displayed display device 38, moving and displaying the graph so that the trace pointer is displayed. A graph scroll program 612 is a program which is similar to the graph scroll program 601 shown in FIG. 6A.

As shown in FIG. 9B, the RAM 71 comprises a function equation storage area 711, a trace pointer coordinate value storage area 712, an x-axis range storage area 713, and a y-axis range storage area 714. A function equation corresponding to the graph displayed on the display device 38 is stored in the function equation data storage area 711. A coordinate value indicated by the trace pointer on the graph displayed on the display device 38 is stored in the trace pointer coordinate value storage area 712. A maximum value and a minimum value of the x-axis displayed on the displays section 38 are stored in the x-axis range storage area 713, and a maximum value and a minimum value of the y-axis displayed on the display device 38 are stored in the y-axis range storage area 714.

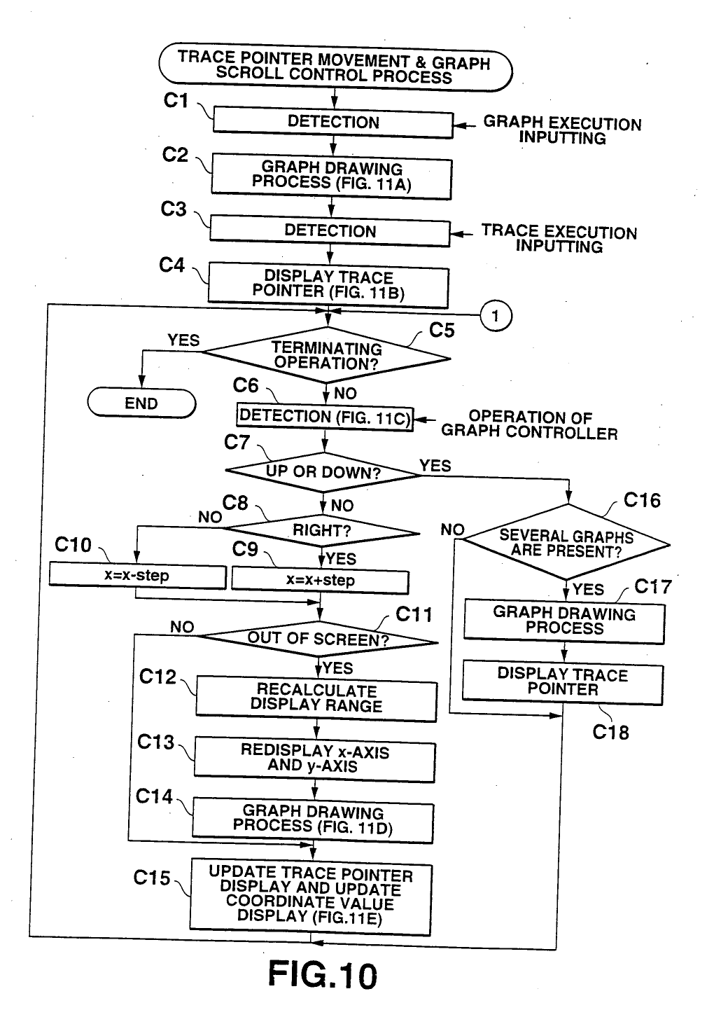

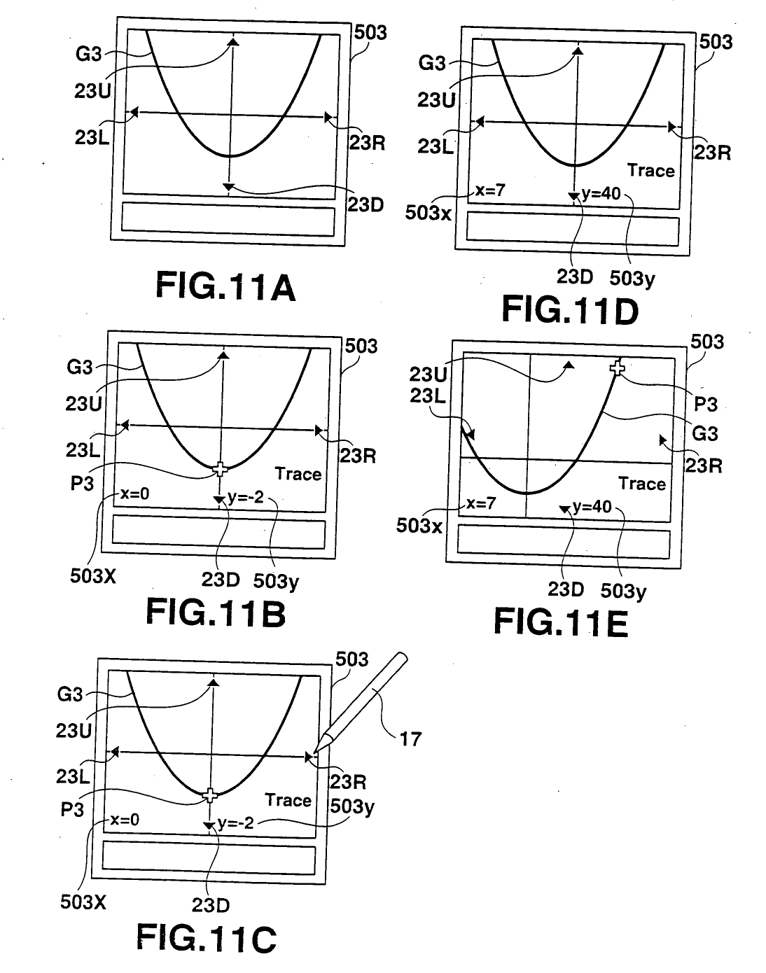

The trace pointer movement & graph scroll control process according to the third embodiment of the present invention will be described with reference to FIGS. 10 and 11A to 11E. FIG. 10 shows an operation flow of the function electronic calculator 1, and FIGS. 11A, 11B, 11C, 11D, and 11E are diagrams showing transition examples of a screen displayed on the display device 38.

When the graph mode is instructed by the mode switch operation, the CPU 31 starts execution of a predetermined program relating to the graph mode to set the graph mode, and waits for inputting of the setting items relating to the drawing of the graph such as inputting of an equation or a display range of the graph to be drawn. As shown in FIG. 10, when the CPU 31 detects graph execution inputting (step C1), the CPU 31 performs the graph drawing process according to the function equation stored in the function equation data storage area 711 and the input setting items (step C2; refer to FIG. 11A).

One example of a graph display screen 503 displayed at this stage is shown in FIG. 11A. As illustrated, a graph G3 based on the set display range is drawn on the graph display screen 503.

When the CPU 31 detects trace execution inputting (step C3), the CPU 31 displays a trace pointer P3 at a predetermined position of the graph G3, and further displays coordinate values 503x and 503y indicating the position of the trace pointer P3 (step C4; refer to FIG. 11B).

The CPU 31 monitors the terminating operation, and determines whether or not the graph controller 23 has been operated by the input pen 17 (step C5). When it is determined that the terminating operation has been detected (step C5: Yes), the present process is terminated.

When the CPU 31 detects an operation of the graph controller 23 by the input pen 17 (step C6; refer to FIG. 1C), the CPU 31 determines whether or not the up or down graph controller 23U or 23D has been operated (step C7). When the operated graph controller is neither the graph controller 23U nor 23D (step C7: No), the CPU 31 determines whether or not the right graph controller 23R has been operated (step C8). When the right graph controller 23R has been operated (step C8: Yes), the CPU 31 adds a value of a variable “step” to the x coordinate value stored in the trace pointer coordinate value storage area 712 (step C9). FIG. 11C is a diagram showing the operation of the graph controller 23R by the input pen 17.

The variable “step” is the amount of increase per one dot in the x-axis of the coordinate displayed on the display device 38, and is previously set such as before the trace pointer movement control process is performed.

When the left graph controller 23L has been operated (step C8: No), the CPU 31 subtracts the value of the variable “step” from the x coordinate value stored in the trace pointer coordinate value storage area 712 (step C10).

The CPU 31 determines whether or not the coordinate value of the trace pointer P3 is out of the screen of the graph display screen 503 (step C11). When it is within the screen (step C11: No), the CPU 31 proceeds the process to step C15.

When it is out of the screen (step C11: Yes; FIG. 11D), the CPU 31 recalculates the display range of the x-y axes in the graph display screen 503 such that the trace pointer P3 is displayed within the screen (step C12), and redisplays the x-axis and the y-axis on the basis of the calculation result (step C13). Further, the CPU 31 performs the graph drawing process to redisplay the graph (step C14, refer to FIG. 11D). The CPU 31 updates the display of the trace pointer P3 and the coordinate values 503x and 503y (step C151; refer to FIG. 11E), and proceeds the process to step C5.

When it is determined that the up or down graph controller 23U or 23D has been operated in step C7 (step C7: Yes), the CPU 31 determines whether or not a plurality of function equations are stored in the function equation data storage area 711 (step C16). When a plurality of function equations are not stored (step C16: No), the CPU 31 returns to the process in step C5. When a plurality of function equations are stored (step C16: Yes), the CPU 31 switches to other function equation data, and performs the graph drawing process (step C17). FIG. 11E shows the graph display screen 503 when the trace pointer P3 is redisplayed after the graph G3, the x-axis, and the y-axis are moved and displayed on the basis of the coordinate of the trace pointer P3.

The CPU 31 displays the trace pointer at a predetermined position on the graph, and further displays the coordinate value indicating the position of the trace pointer (step C18). The process proceeds to step C5.

As described above, according to the third embodiment, the input pen 17 is used to operate the graph controller 23 so that tracing of the graph can be performed. Further, when the position of the trace pointer is out of the screen, the graph is automatically scrolled and redisplayed so that the position of the trace pointer is within the screen. Therefore, the user can easily perform the tracing of the graph so that he/she can always confirm the trace pointer on the screen.

### Fourth Embodiment

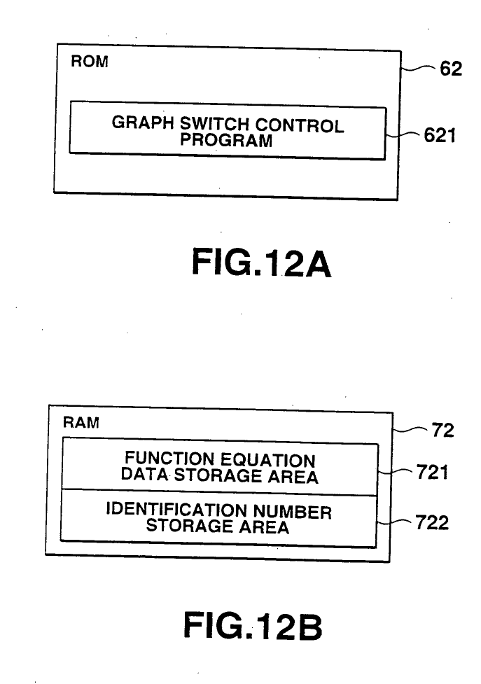

A fourth embodiment according to the present invention will be described. Since a configuration of a function electronic calculator according to the present embodiment is similar to a configuration where the ROM 32 and the RAM 33 are replaced with a ROM 62 shown in FIG. 12A and a RAM 72 shown in FIG. 12B, respectively, in the configuration of the function electronic calculator 1 described in FIG. 3 according to the first embodiment, like numerals are denoted to like constituents and a description thereof will be omitted below.

As shown in FIG. 12A, the ROM 62 comprises a graph switch control program 621. The graph switch control program 621 is a program for causing the CPU 31 to perform a graph switch control process of switching and selecting a specific graph among the graphs displayed on the display device 38.

As shown in FIG. 12B, the RAM 72 comprises a function equation data storage area 721 and an identification number storage area 722. An equation and an identification number for identifying the function equation are stored in the function equation data storage area 721 in a corresponding manner. In order to identify a graph selected by the CPU 31, an identification number of the function equation corresponding to the graph is stored in the identification number storage area 722.

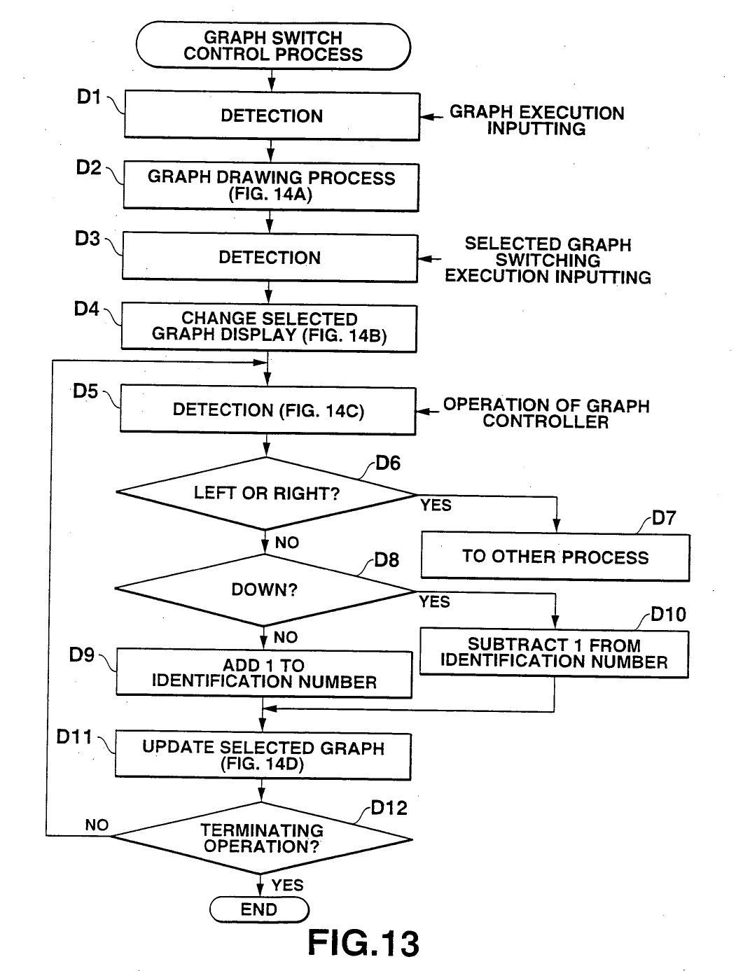

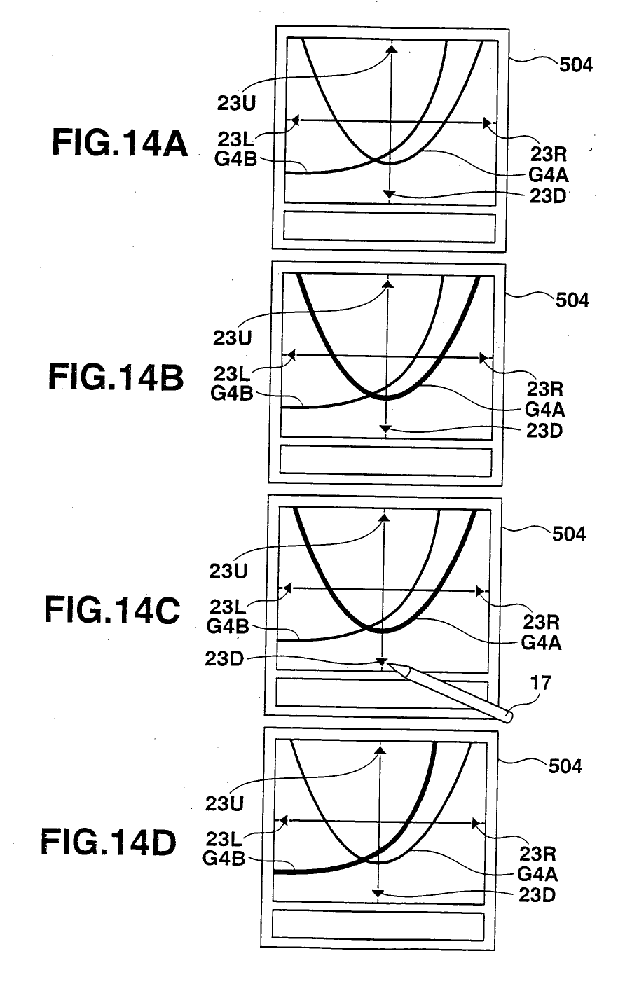

The graph switch control process according to the fourth embodiment of the present invention will be described with reference to FIGS. 13 and 14A to 14D. FIG. 13 shows an operation flow of the function electronic calculator 1, and FIGS. 14A to 14D are diagrams showing transition examples of a screen displayed on the display device 38.

When the graph mode is instructed by the mode switch operation, the CPU 31 starts execution of a predetermined program relating to the graph mode to set the graph mode, and waits for inputting of the setting items relating to the drawing of the graph such as inputting of a function equation or a display range of the graph to be drawn. As shown in FIG. 13, when the CPU 31 detects graph execution inputting (step D1), the CPU 31 performs the graph drawing process according to the function equation stored in the function equation data storage area 721 and the input setting items (step D2; refer to FIG. 14A).

One example of a graph display screen 504 displayed at this stage is shown in FIG. 14A. As illustrated, graphs G4A and G4B based on the set display ranges are drawn on the graph display screen 504.

When the CPU 31 detects selected graph switch execution inputting (step D3), the CPU 31 selects a specific graph among the displayed graphs (for example, a graph corresponding to an equation having a smallest identification number), and displays the same by changing a line width, a color, and the like of the graph (step D4; refer to FIG. 14B).

When the CPU 31 detects an operation of the graph controller 23 by the input pen 17 (step D5; refer to FIG. 14C), the CPU 31 determines whether or not the left or right graph controller 23L or 23R has been operated (step D6). When the operated graph controller is the graph controller 23L or 23R (step D6: Yes), the CPU 31 performs other process.

When the operated graph controller is neither the left graph controller 23L nor right graph controller 23R (step D6: No), the CPU 31 determines whether or not the down graph controller 23D has been operated (step D8). When the down graph controller 23U has been operated (step D8: No), the CPU 31 adds 1 to the data stored in the identification number storage area 722 (step D9), and proceeds the process to step D11. When the down graph controller 23D has been operated (step D8: Yes), the CPU 31 subtracts 1 from the data stored in the identification number storage area 722 (step D10). FIG. 14C is a diagram showing the operation of the graph controller 23D by the input pen 17.

The CPU 31 switches a selected graph according to the identification number storage area 722, and changes a line width, a color, and the like of the graph to display the same (step D11; refer to FIG. 14D).

The CPU 31 monitors the terminating operation, and determines whether or not the graph controller 23 has been operated by the input pen 17 (step D12). When it is determined that the terminating operation has been detected (step D12: Yes), the present process is terminated. When it is determined that the graph controller 23 has been operated by the input pen 17, the process returns to step D5.

As described above, according to the fourth embodiment, the input pen 17 is used to operate the graph controller 23 so that a selected graph can be switched. Therefore, the user can easily perform the switching of the selected graph.

### Fifth Embodiment

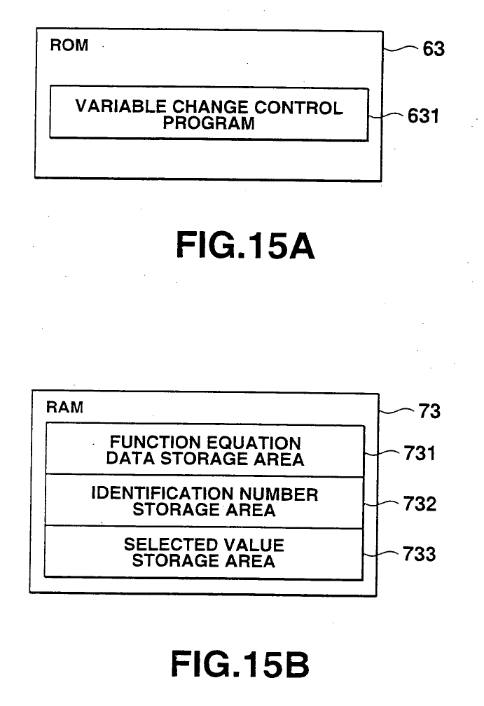

A fifth embodiment according to the present invention will be described. Since a configuration of a function electronic calculator according to the present embodiment is similar to a configuration where the ROM 32 and the RAM 33 are replaced with a ROM 63 shown in FIG. 15A and a RAM 73 shown in FIG. 15B, respectively, in the configuration of the function electronic calculator 1 described in FIG. 3 according to the first embodiment, like numerals are denoted to like constituents and a description thereof will be omitted below.

As shown in FIG. 15A, the ROM 63 comprises a variable change control program 631. The variable change control program 631 is a program for causing the CPU 31 to perform a variable change control process of changing a selected coefficient in a function equation displayed in the function equation display area 21.

As shown in FIG. 15B, the RAM 73 comprises a function equation data storage area 731, an identification number storage area 732, and a selected value storage area 733. A function equation and an identification number for identifying the function equation are stored in the function equation data storage area 731 in a corresponding manner. In order to identify a graph selected by the CPU 31, an identification number of the function equation corresponding to the graph is stored in the identification number storage area 732. A value of a coefficient selected in the function equation displayed in the function equation display area 21 is stored in the selected value storage area 733.

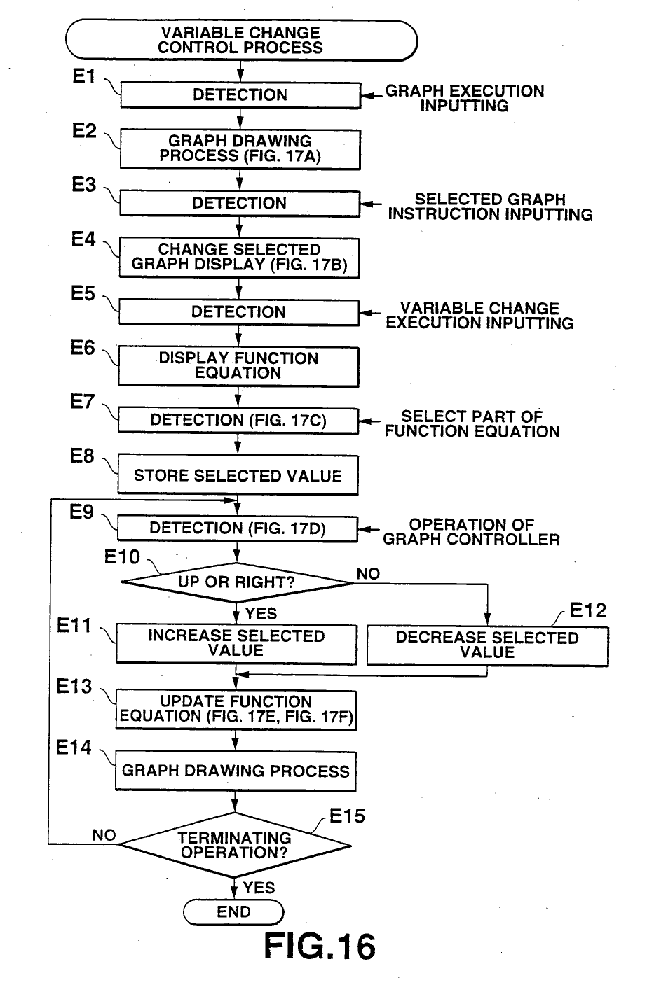

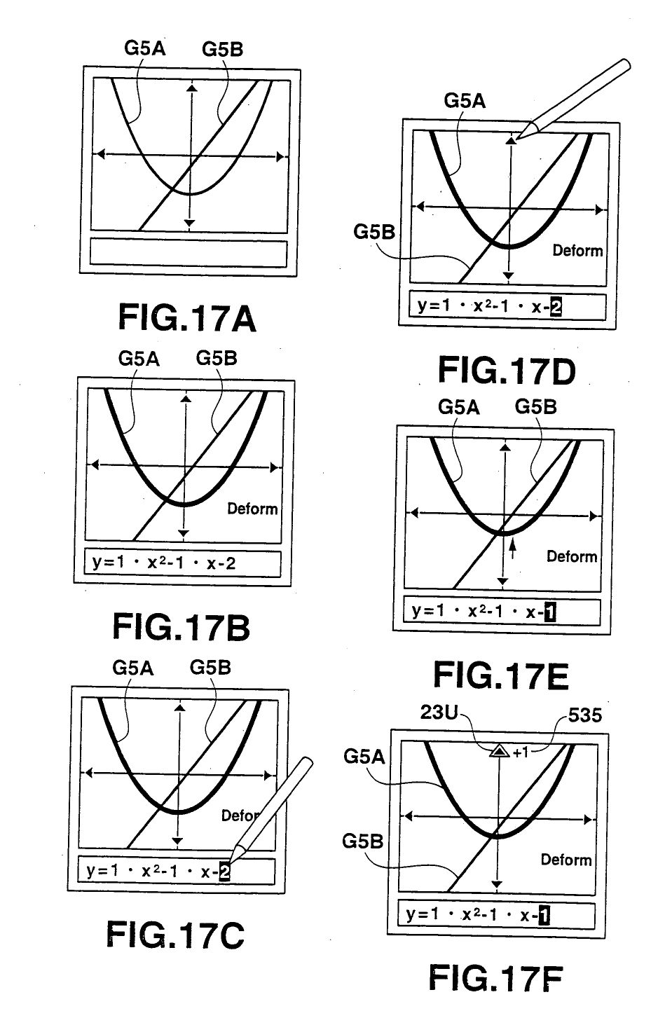

The variable change control process according to the fifth embodiment of the present invention will be described with reference to FIGS. 16 and 17A to 17F. FIG. 16 shows an operation flow of the function electronic calculator 1, and FIGS. 17A, 17B, 17C, 17D, 17E, and 17F are diagrams showing transition examples of a screen displayed on the display device 38.

When the graph mode is instructed by the mode switch operation, the CPU 31 starts execution of a predetermined program relating to the graph mode to set the graph mode, and waits for inputting of the setting items relating to the drawing of the graph such as inputting of a function equation or a display range of the graph to be drawn. As shown in FIG. 16, when the CPU 31 detects graph execution inputting (step E1), the CPU 31 performs the graph drawing process according to the function equation stored in the function equation data storage area 731 and the input setting items (step E2; refer to FIG. 17A).

One example of a graph display screen 505 displayed at this stage is shown in FIG. 17A. As illustrated, graphs G5A and G5B based on the set display ranges are drawn on the graph display screen 505.

When the CPU 31 detects selected graph instruction inputting (step E3), the CPU 31 selects a specific graph among the displayed graphs (for example, a graph corresponding to a function equation having a smallest identification number), and displays the same by changing a line width, a color, and the like of the graph (step E4; refer to FIG. 17B).

When the CPU 31 detects variable change execution inputting (step E5), the CPU 31 displays a function equation 515 corresponding to the selected graph in the function equation display area 21 (step E6; refer to FIG. 17B). When the CPU 31 detects a selection of a coefficient of the function equation 515 by the input pen 17 (step E7; refer to FIG. 17C), the CPU 31 stores the selected coefficient in the selected value storage area 733 (step E8).

When the CPU 31 detects an operation of the graph controller 23 by the input pen 17 (step E9; refer to FIG. 17D), the CPU 31 determines whether or not the up or right graph controller 23U or 23R has been operated (step E10). When the operated graph controller is the up or right graph controller 23U or 23R (step E10: Yes), the CPU 31 adds a predetermined value to the data stored in the selected value storage area 733 (step E11). When the down or left graph controller 23D or 23L has been operated (step E10: No), the CPU 31 subtracts the predetermined value from the data stored in the selected value storage area 733 (step E12).

The predetermined value means the amount of change of the selected coefficient by one operation of the graph controller 23, and is previously set such as before the variable change control process is performed. FIG. 17D is a diagram showing the operation of the up graph controller 23U by the input pen 17.

The CPU 31 updates a function equation corresponding to the selected graph on the basis of the data stored in the selected value storage area 733, and stores it in the function equation data storage area 731 (step E13; refer to FIGS. 17E and 17F). At this time, an updated function equation 525 is displayed in the function equation display area 23. The CPU 31 performs the graph drawing process on the basis of the updated function equation (step E14). FIG. 17E shows a case where the selected coefficient is incremented by 1 (−2 to −1).

The CPU 31 monitors the terminating operation, and determines whether or not the graph controller 23 has been operated by the input pen 17 (step E15). When it is determined that the terminating operation has been detected (step E15: Yes), the present process is terminated. When it is determined that the graph controller 23 has been operated by the input pen 17, the process returns to step E9.

As described above, according to the fifth embodiment, the input pen 17 is used to select a coefficient of the function equation displayed in the function equation display area 21 and to operate the graph controller 23 so that a value of the coefficient can be changed. Therefore, the user can easily confirm the change in the shape of the graph along with the change in the coefficient.

When a coefficient of the function equation corresponding to the graph G5A is changed by the execution of the variable (coefficient) change control process and the graph G5A is redisplayed, the moving direction, the amount of movement, and the like of the graph G5A may be displayed on the graph display screen 505. For example, when the graph G5A moves in the y-axis direction by +1, the display of the graph controller 23U is changed as shown in FIG. 17F so that the amount (+1) of movement 535 is displayed. Thereby, the user can easily grasp the moving direction and the amount of movement of the graph.

### Sixth Embodiment

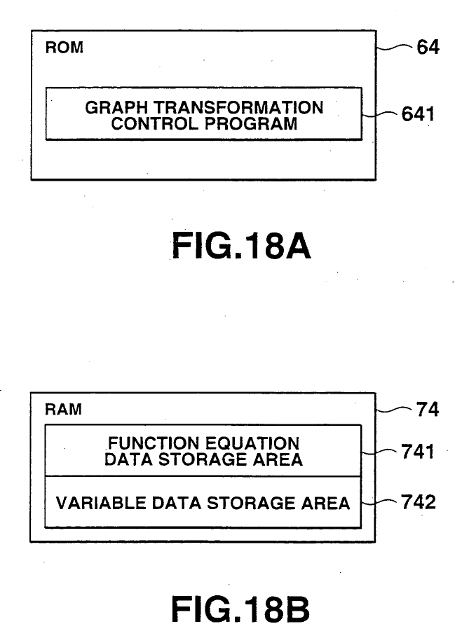

A sixth embodiment according to the present invention will be described. Since a configuration of a function electronic calculator according to the present embodiment is similar to a configuration where the ROM 32 and the RAM 33 are replaced with a ROM 64 shown in FIG. 18A and a RAM 74 shown in FIG. 18B, respectively, in the configuration of the function electronic calculator 1 described in FIG. 3 according to the first embodiment, like numerals are denoted to like constituents and a description thereof will be omitted below.

As shown in FIG. 18A, the ROM 64 comprises a graph transformation control program 641. The graph transformation control program 641 is a program for causing the CPU 31 to perform a graph transformation control process of changing a coefficient of a function equation.

As shown in FIG. 18B, the RAM 74 comprises a function equation data storage area 741 and a variable data storage area 742. A function equation corresponding to the graph displayed in the display device 38 is stored in the function equation data storage area 741. A value of a variable of a coefficient in the function equation stored in the function equation data storage area 741, a varying range (upper limit value and lower limit value), the amount of change, and an identification number are stored in the variable data storage area 742. Specifically, for example, when a function equation of “y1=x²−x−a” is stored in the function equation data storage area 741, the value, the varying range, and the amount of change of the variable “a” are stored. The identification number is directed for identifying to which of the graph controllers 23U, 23D, 23R, and 23L the variable is corresponded.

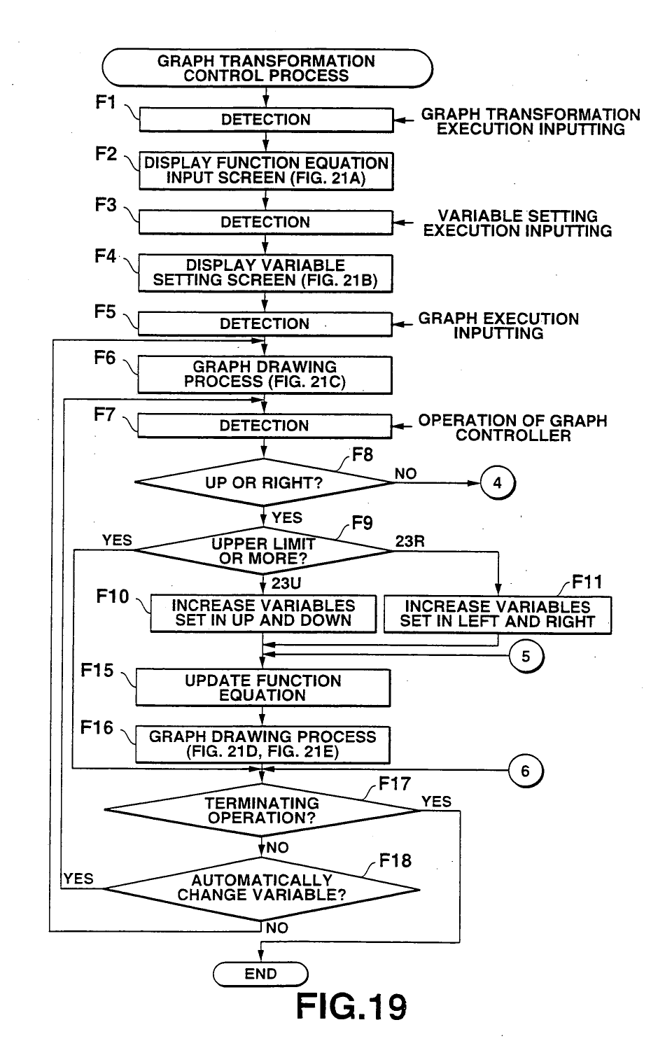

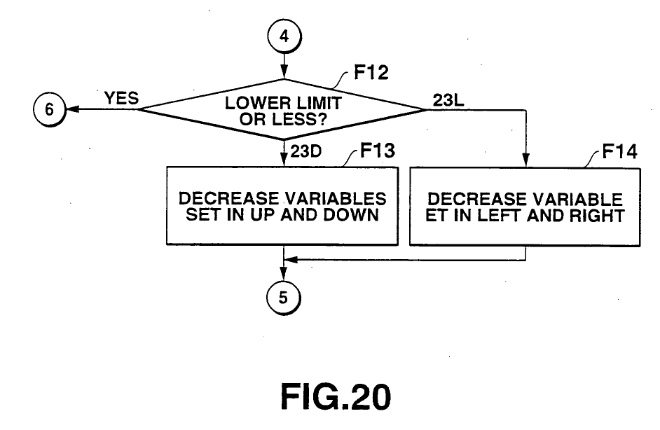

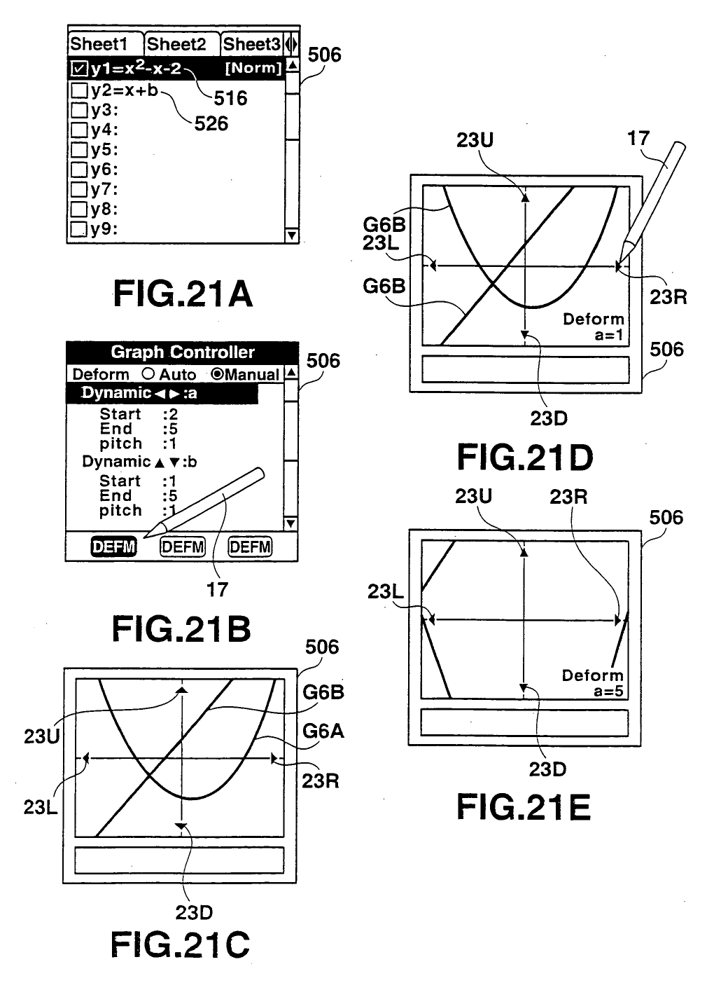

The variable change control process according to the sixth embodiment of the present invention will be described with reference to FIGS. 19 to 21A to 21E. FIGS. 19 and 20 are diagrams showing an operation flow of the function electronic calculator 1, and FIGS. 21A, 21B, 21C, 21D, and 21E are diagrams showing transition examples of a screen displayed on the display device 38.

When the graph mode is instructed by the mode switch operation, the CPU 31 starts execution of a predetermined program relating to the graph mode to set the graph mode, and waits for inputting of the setting items relating to the drawing of the graph such as inputting of a function equation or a display range of the graph to be drawn. As shown in FIG. 19, when the CPU 31 detects the graph transformation execution process (step F1), the CPU 31 displays an input screen for inputting a function equation (step F2; refer to FIG. 21A). The CPU 31 stores the input function equation in the function equation data storage area 741.

One example of a graph display screen 506 displayed in step F2 is shown in FIG. 21A. As illustrated, function equations 516 and 526 which the user inputs by using the operation input keys 11 or the like are displayed on the graph display screen 506.

When the CPU 31 detects variable setting execution inputting (step F3), the CPU 31 displays a setting screen for setting the varying ranges and the amounts of change of the variables “a” and “b” of the coefficients of the function equation input in step F2 (step F4; refer to FIG. 21B). Further, the input varying ranges and the amounts of change are stored in the variable data storage area 742.

One example of the graph display screen 506 displayed in step F4 is shown in FIG. 21B. For example, when “y1=x²−x−a” as the function equation 516 and “y²=x+b” as the function equation 526 are input in step F2 (FIG. 21A), setting columns for setting the varying ranges and the amounts of change for the variables “a” and “b” are displayed. Any one of the graph controllers 23U, 23D, 23L, and 23R is automatically corresponded to each variable by the CPU 31. Alternatively, the user may designate any one graph controller and correspond it thereto. Specifically, for example, as shown in FIG. 21B, the graph controllers 23L and 23R are corresponded to the variable “a,” and the graph controllers 23U and 23D are corresponded to the variable “b.”

When the CPU 31 detects graph execution inputting (step F5), the PUC 31 performs the graph drawing process according to the function equation stored in the function equation data storage area 741 and the setting value of the variable stored in the variable data storage area 742 (step F6; refer to FIG. 21C). At this time, for example, the lower limit value is substituted to the variable in the function equation so that the graph drawing process is performed.

One example of the graph display screen 506 displayed in step F6 is shown in FIG. 21C. As illustrated, graphs G6A and G6B based on the set display ranges are drawn on the graph display screen 506.

When the CPU 31 detects an operation of the graph controller 23 by the input pen 17 (step F7), the CPU 31 determines whether or not the graph controller 23U or 23R has been operated (step F8). When the operated graph controller is the graph controller 23U or 23R (step F8: Yes), the CPU 31 determines which of the graph controllers 23U and 23R has been operated, and further determines whether or not a value of the variable corresponded to the operated graph controller 23 is the upper limit value or more (step F9). In the case of the upper limit value or more (step F9: Yes), the CPU 31 proceeds the process to step F17.

When the graph controller 23U has been operated and the value of the corresponding variable is less than the upper limit value (step F9: 23U), the CPU 31 adds the amount of change to the value of the variable (here, variable “b”) corresponded to the graph controllers 23U and 23D stored in the variable data storage area 742 (step F10). When the graph controller 23R has been operated and the value of the corresponding variable is less than the upper limit value (step F9: 23R), the CPU 31 adds the amount of change to the value of the variable (here, variable “a”) corresponding to the controllers 23R and 23L stored in the variable data storage area 742 (step F11). FIG. 21D is a diagram showing the operation of the graph controller 23R by the input pen 17.

When it is determined that the graph controller 23D or 23L has been operated in step F8 (step F8: No), the CPU 31 determines which of the graph controllers 23D and 23L has been operated, and further determines whether or not the value of the variable corresponded to the operated graph controller 23 is the lower limit value or less (step F12). In the case of the lower limit value or less (step F12: Yes), the CPU 31 proceeds the process to step F17.

When the graph controller 23D has been operated and the value of the corresponding variable is more than the lower limit value (step F12: 23D), the CPU 31 subtracts the amount of change from the value of the variable (here variable “b”) corresponding to the graph controllers 23U and 23D stored in the variable data storage area 742 (step F13). When the graph controller 23L has been operated and the value of the corresponding variable is more than the lower limit value (step F12: 23L), the CPU 31 subtracts the amount of change from the value of the variable (here, variable “a”) corresponding to the graph controllers 23R and 23L stored in the variable data storage area 742 (step F14).

The CPU 31 updates and stores the function equation stored in the function equation data storage area 741 on the basis of the variables of the updated variable data storage area 742 (step F15). Further, the CPU 31 performs the graph drawing process on the basis of the updated function equation (step F16; refer to FIGS. 21D and 21E).

The CPU 31 monitors the terminating operation, and determines whether or not the graph controller 23 has been operated by the input pen 17 (step F17). When it is determined that the terminating operation has been detected (step F17: Yes), the present process is terminated. When it is determined that the graph controller 23 has been operated by the input pen 17, the presence of variable automatic change execution inputting is detected in step F18.

When the variable automatic change execution inputting is detected (step F18: Yes), the CPU 31 proceeds the process to step F18, where the process according to the previously operated graph controller 23 is repeated. When the variable automatic change execution inputting is not detected (step F18: No), the CPU 31 proceeds the process to step F7.

When the variable automatic change execution inputting is detected (step F18: Yes), the present process is terminated.

As described above, according to the sixth embodiment, the varying range and the amount of change of the variable in the function equation including the variable such as a coefficient are set and the graph controller 23 is operated so that the value of the variable can be changed. Therefore, the user can easily confirm the change in the shape of the graph along with the change in the variable.

### Seventh Embodiment

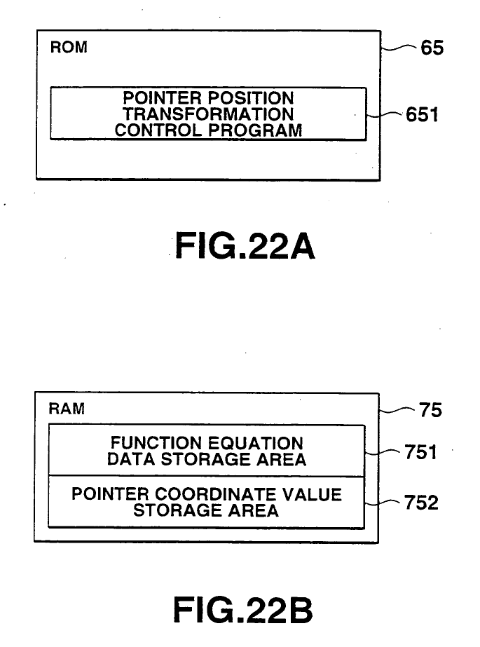

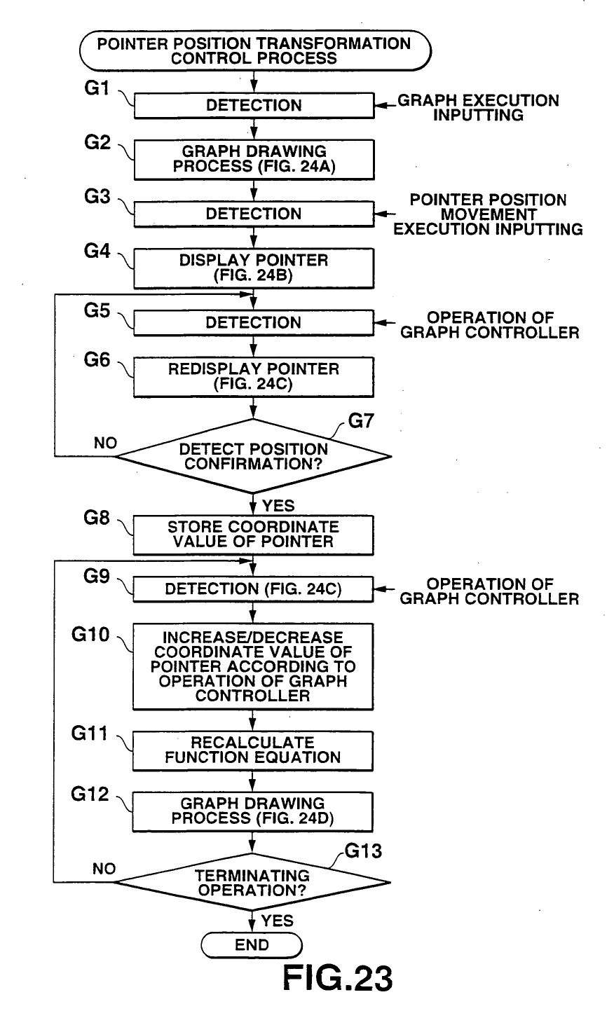

A seventh embodiment according to the present invention will be described. Since a configuration of a function electronic calculator according to the present embodiment is similar to a configuration where the ROM 32 and the RAM 33 are replaced with a ROM 65 shown in FIG. 22A and a RAM 75 shown in FIG. 22B, respectively, in the configuration of the function electronic calculator 1 described in FIG. 3 according to the first embodiment, like numerals are denoted to like constituents and a description thereof will be omitted below.

As shown in FIG. 22A, the ROM 65 comprises a pointer position transformation control program 651.

The pointer position transformation control program 651 is a program for causing the CPU 31 to perform a pointer position transformation control process of transforming a graph along with the movement of the pointer positioned on the graph displayed on the display device 38.

As shown in FIG. 22B, the RAM 75 comprises a function equation data storage area 751 and a pointer coordinate value storage area 752. A function equation corresponding to the graph displayed on the display device 38 is stored in the function equation data storage area 751. A coordinate value indicating the position of the pointer displayed on the display device 38 is stored in the pointer coordinate value storage area 752.

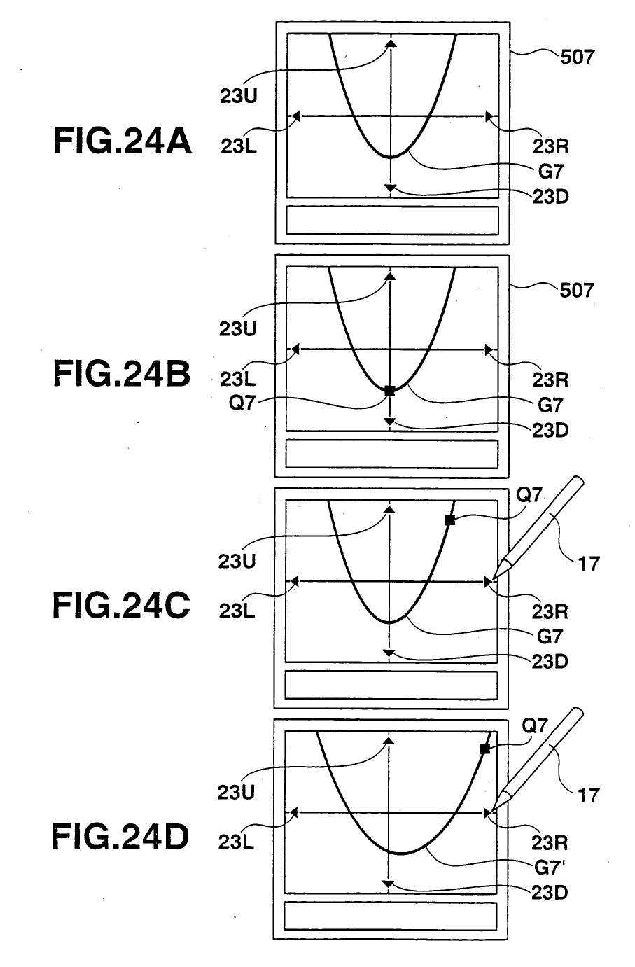

The pointer position transformation control process according to the seventh embodiment of the present invention will be described with reference to FIGS. 23 and 24A to 24D. FIG. 23 shows an operation flow of the function electronic calculator 1, and FIGS. 24A, 24B, 24C, and 24D are diagrams showing transition examples of a screen displayed on the display device 38.

When the graph mode is instructed by the mode switch operation, the CPU 31 starts execution of a predetermined program relating to the graph mode to set the graph mode, and waits for inputting of the setting items relating to the drawing of the graph such as inputting of a function equation or a display range of the graph to be drawn. As shown in FIG. 23, when the CPU 31 detects graph execution inputting (step G1), the CPU 31 performs the graph drawing process according to the function equation stored in the function equation data storage area 751 and the input setting items (step G2; refer to FIG. 24A).

One example of a graph display screen 507 displayed in step G2 is shown in FIG. 24A. As illustrated, a graph G7 based on the set display range is drawn on the graph display screen 507.

When the CPU 31 detects pointer position movement execution inputting (step G3), the CPU 31 displays a pointer Q7 at a predetermined position on the graph G7 displayed on the display device 38. Further, the CPU 31 stores a coordinate value indicated by the pointer Q7 in the pointer coordinate value storage area 752 (step G4; refer to FIG. 24B).

When the CPU 31 detects an operation of the graph controller 23 by the input pen 17 (step G5), the CPU 31 traces the graph G7 on the basis of the operated graph controller 23, and redisplays the pointer Q7 according to the traced result (step G6; refer to FIG. 24C). Specifically, for example, when the graph controller 23 has been operated, the CPU 31 traces the graph G7 in a positive direction of the x-axis, and moves and displays the pointer Q7 on the basis of the trace result. When the graph controller 23L has been operated, the CPU 31 traces the graph G7 in a negative direction of the x-axis, and moves and displays the pointer Q7 on the basis of the trace result.

When the CPU 31 detects a position confirmation of the pointer Q7 (step G7: Yes), the CPU 31 stores the coordinate value of the pointer Q7 in the pointer coordinate value storage area 752 (step G8). When the position confirmation of the pointer Q7 is not detected (step G7: No), the CPU 31 proceeds the process to step G5, and repeats the movement process of the pointer Q7.

When the CPU 31 detects an operation of the graph controller 23 (step G9; refer to FIG. 24C), the CPU 31 calculates the coordinate value of the pointer Q7 on the basis of the operation of the graph controller 23 (step G10). Specifically, for example, the CPU 31 adds a predetermined value to a y-coordinate value of the pointer Q7 when the graph controller 23U has been operated, and the CPU 31 subtracts the predetermined value from the y-coordinate value of the pointer Q7 when the graph controller 23D has been operated. The CPU 31 adds the predetermined value to an x-coordinate value of the pointer Q7 when the graph controller 23R has been operated, and the CPU 31 subtracts the predetermined value from the x-coordinate value of the pointer Q7 when the graph controller 23L has been operated.

The predetermined value means the amount of change of the coordinate value of the pointer Q7 by one operation of the graph controller 23, and is a value which is previously set such as before the pointer position transformation control process is performed.

The CPU 31 recalculates the function equation corresponding to the graph G7 such that the graph G7 satisfies the coordinate value stored in the pointer coordinate value storage area 752, that is the graph G7 passes through the coordinate of the pointer Q7 after the movement (step G11), and performs the graph drawing process on the basis of the function equation (step G12; refer to FIG. 23D).

The CPU 31 monitors the terminating operation, and determines whether or not the graph controller 23 has been operated by the input pen 17 (step G13). When it is determined that the terminating operation has been detected (step G13: Yes), the present process is terminated. When it is determined that the graph controller 23 has been operated by the input pen 17, the process returns to step G9.

As described above, according to the seventh embodiment, the input pen 17 is used to operate the graph controller 23 so that the pointer displayed on the graph is moved and the graph can be transformed along with the movement. Therefore, the user can easily transform the graph.

### Eighth Embodiment

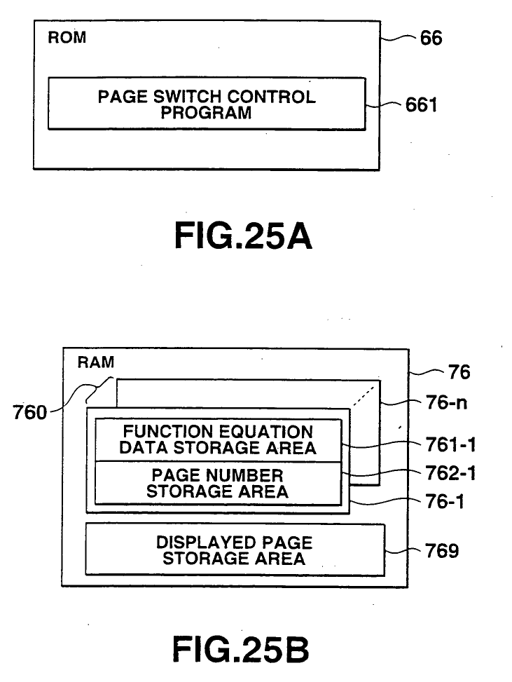

An eighth embodiment according to the present invention will be described. Since a configuration of a function electronic calculator according to the present embodiment is similar to a configuration where the ROM 32 and the RAM 33 are replaced with a ROM 66 shown in FIG. 25A and a RAM 76 shown in FIG. 25B, respectively, in the configuration of the function electronic calculator 1 described in FIG. 3 according to the first embodiment, like numerals are denoted to like constituents and a description thereof will be omitted below.

As shown in FIG. 25A, the ROM 66 comprises a page switch control program 661. The page switch control program 661 is a program for causing the CPU 31 to perform a page switch control process of switching a page displayed on the display device 38.

As shown in FIG. 25B, the RAM 76 comprises page files 76-1, 76-2, . . . 76-n (hereinafter, comprehensively referred to as “page files 760”) and a displayed page number storage area 769. Each page file 760 includes a function equation data storage area 761 (function equation data storage areas 761-1, . . . 761-n), a page number storage area 762 (page number storage areas 762-1, . . . 762-n), and the like. A function equation corresponding to the graph displayed on the display device 38 is stored in the function equation data storage area 761. A page number (identification number) corresponding to the page file is stored in the page number storage area 762. A page number of the page file 760 displayed on the display device 38 is stored in the displayed page number storage area 769.

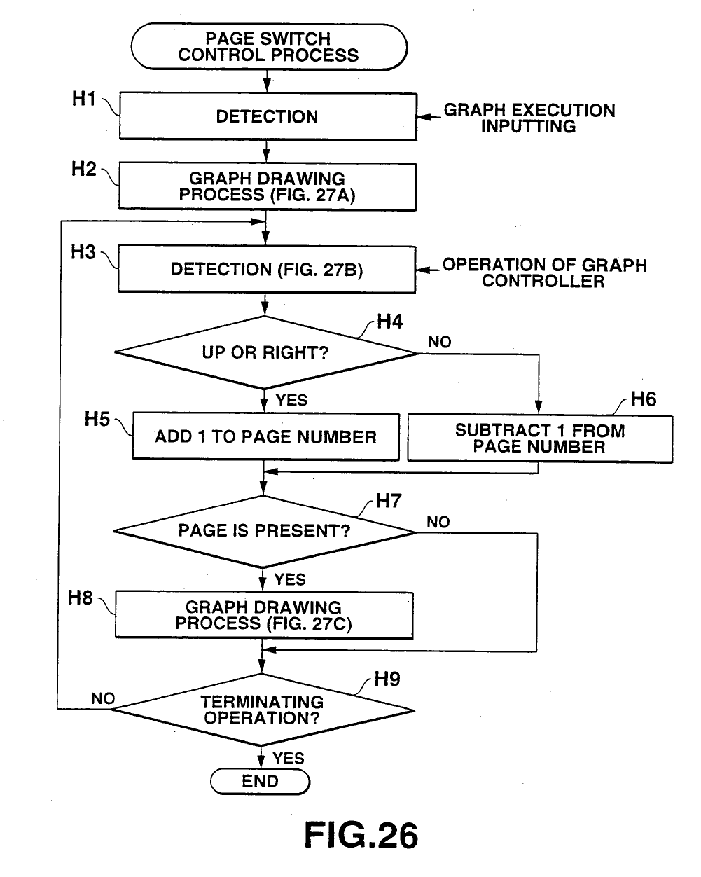

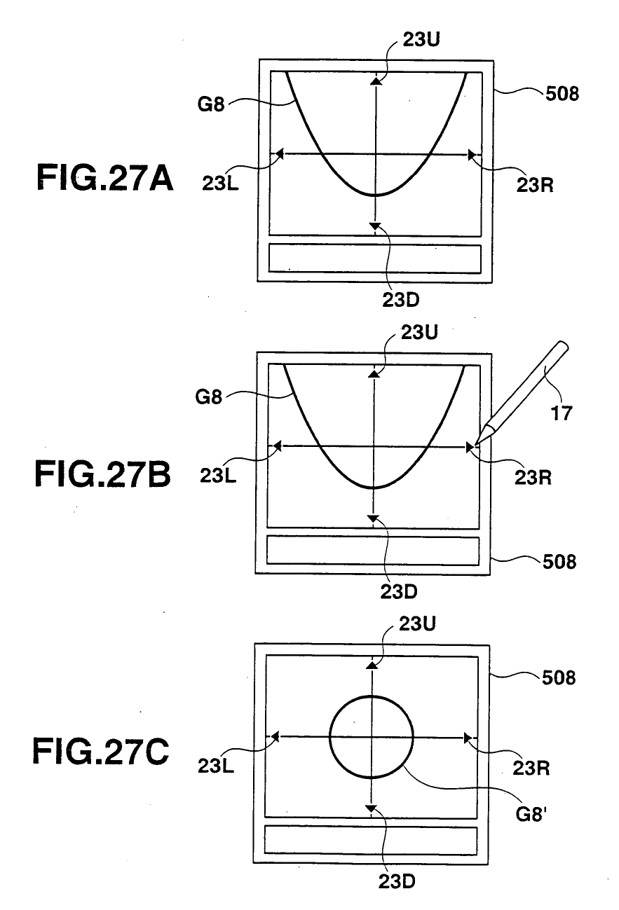

The page switch control process according to the eighth embodiment of the present invention will be described with reference to FIGS. 26 and 27A to 27C. FIG. 26 shows an operation flow of the function electronic calculator 1, and FIGS. 27A, 27B, and 27C are diagrams showing transition examples of a screen displayed on the display device 38.

When the graph mode is instructed by the mode switch operation, the CPU 31 starts execution of a predetermined program relating to the graph mode to set the graph mode, and waits for inputting of the setting items relating to the drawing of the graph such as inputting of a function equation or a display range of the graph to be drawn. As shown in FIG. 26, when the CPU 31 detects graph execution inputting (step H1), the CPU 31 selects the first page of the page files 760, that is, the page file 76-1, and performs the graph drawing process according to the function equation stored in the function equation data storage area 761-1 and the input setting items (step H2; refer to FIG. 27A). Data stored in the page number storage area 762-1 is stored in the displayed page number storage area 769.

One example of a graph display screen 508 displayed in step H2 is shown in FIG. 27A. As illustrated, a graph G8 based on the function equation stored in the page file 76-1 and the set display range is drawn on the graph display screen 508.

When the CPU 31 detects an operation of the graph controller 23 by the input pen 17 (step H3; refer to FIG. 27B), the CPU 31 determines whether or not the operated graph controller is the graph controller 23U or 23R (step H4). When the graph controller 23U or 23R has been operated (step H4: Yes), the CPU 31 adds 1 to the data stored in the displayed page number storage area 769 (step H5). When the graph controller 23D or 23L has been operated (step H4: No), the CPU 31 subtracts 1 from the data stored in the displayed page number storage area 769 (step H6). FIG. 27B is a diagram showing the operation of the graph controller 23R by the input pen 17 in step H3.

The CPU 31 determines whether or not there is a page file which assumes the data stored in the displayed page number storage area 769 to be the number of pages (step H7). When the page file is not present (step H7: No), the CPU 31 proceeds the process to step H9. When the page file is present (step H7: Yes), the CPU 31 performs the graph drawing process on the basis of the function equation stored in the page file (step H8; refer to FIG. 27C).

The CPU 31 monitors the terminating operation, and determines whether or not the graph controller 23 has been operated by the input pen 17 (step H9). When it is determined that the terminating operation has been detected (step H9: Yes), the present process is terminated. When it is determined that the graph controller 23 has been operated by the input pen 17, the process returns to step H3.

As described above, according to the eighth embodiment, the input pen 17 is used to operate the graph controller 23 so that the page file displayed on the graph can be switched. Therefore, the user can easily switch a plurality of page files.

### Ninth Embodiment

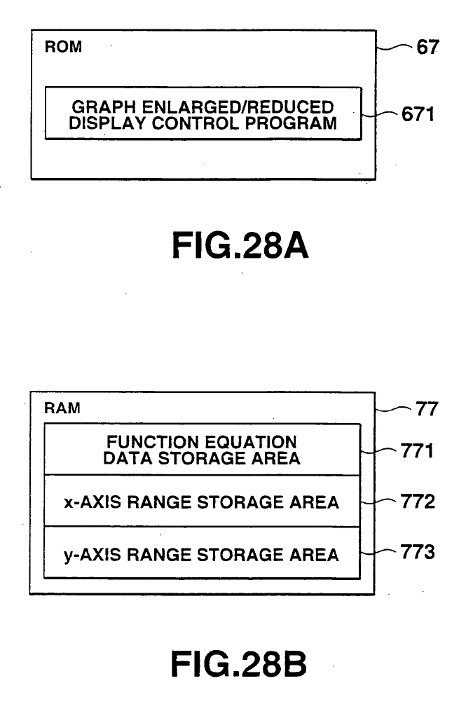

A ninth embodiment according to the present invention will be described. Since a configuration of a function electronic calculator according to the present embodiment is similar to a configuration where the ROM 32 and the RAM 33 are replaced with a ROM 67 shown in FIG. 28A and a RAM 77 shown in FIG. 28B, respectively, in the configuration of the function electronic calculator 1 described in FIG. 3 according to the first embodiment, like numerals are denoted to like-constituents and a description thereof will be omitted below.

As shown in FIG. 28A, the ROM 67 comprises a graph enlarged/reduced display control program 671. The graph enlarged/reduced display control program 671 is a program for causing the CPU 31 to perform a graph enlarged/reduced display control process of displaying the graph displayed on the display device 38 in an enlarged manner and a reduced manner.

As shown in FIG. 28B, the RAM 77 comprises a function equation data storage area 771, an x-axis range storage area 772, and a y-axis range storage area 773. A function equation corresponding to the graph displayed on the display device 38 is stored in the function equation data storage area 771. A maximum value and a minimum value of the x-axis displayed on the display device 38 are stored in the x-axis range storage area 772, and a maximum value and a minimum value of the y-axis displayed on the display device 38 are stored in the y-axis range storage area 773.

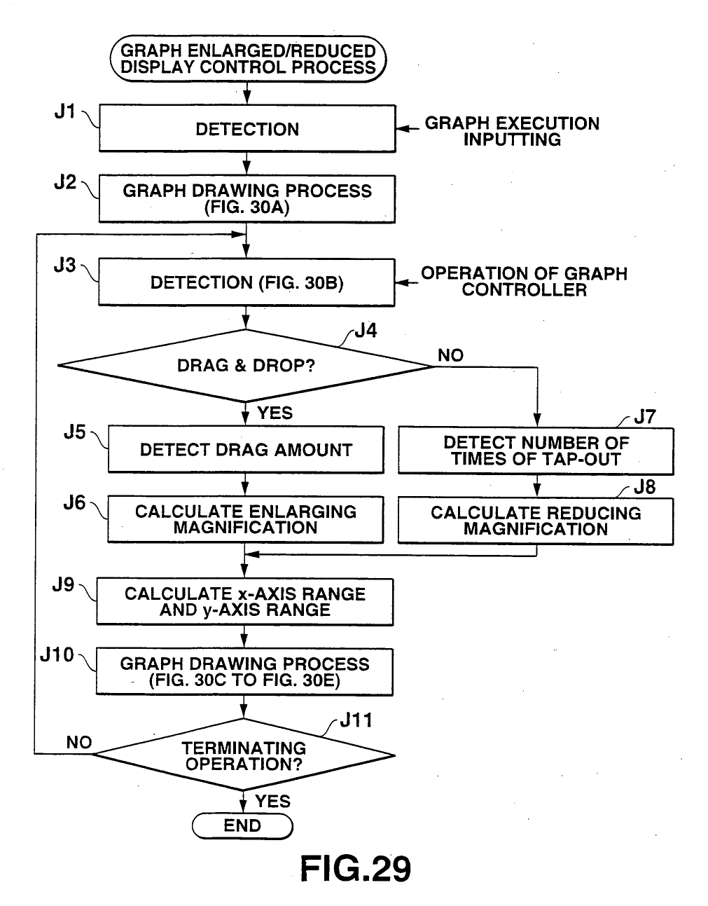

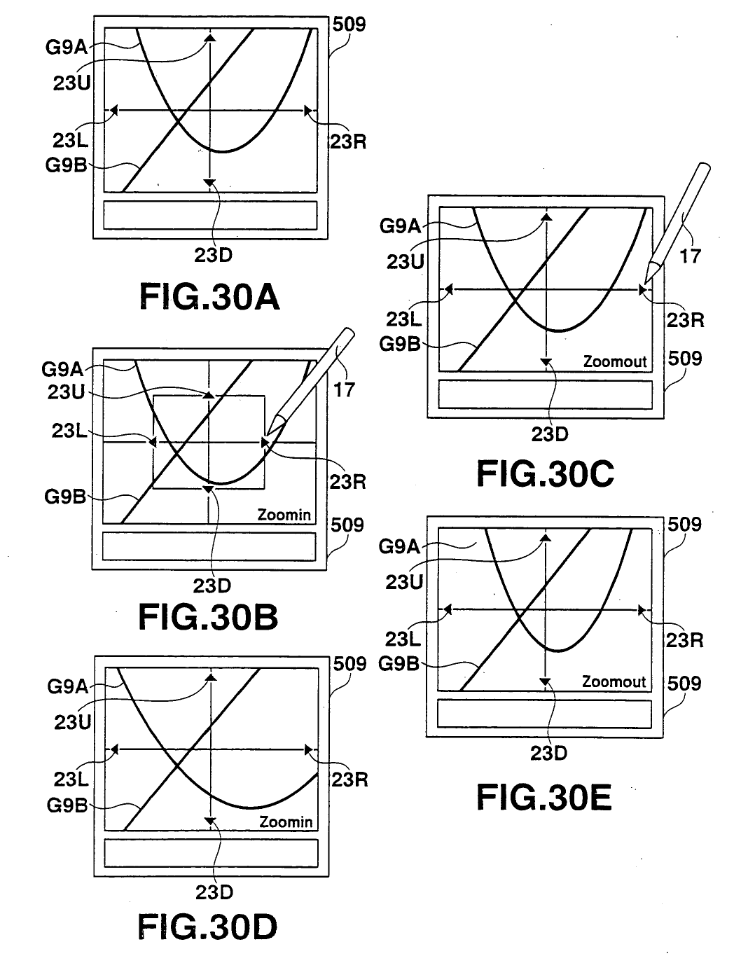

The pointer position transformation control process according to the ninth embodiment of the present invention will be described with reference to FIGS. 29 and 30A to 30E. FIG. 29 shows an operation flow of the function electronic calculator 1, and FIGS. 30A, 30B, 30C, 30D, and 30E are diagrams showing transition examples of a screen displayed on the display device 38.

When the graph mode is instructed by the mode switch operation, the CPU 31 starts execution of a predetermined program relating to the graph mode to set the graph mode, and waits for inputting of the setting items relating to the drawing of the graph such as inputting of a function equation or a display range of the graph to be drawn. As shown in FIG. 29, when the CPU 31 detects graph execution inputting (step J1), the CPU 31 performs the graph drawing process according to the function equation stored in the function equation data storage area 771 and the input setting items (step J2; refer to FIG. 30A).

One example of a graph display screen 509 displayed in step J2 is shown in FIG. 30A. As illustrated, graphs G9A and G9B based on the set display ranges are drawn on the graph display screen 509.

When the CPU 31 detects an operation of the graph controller 23 by the input pen 17 (step J3; refer to FIG. 30B), the CPU 31 determines whether or not the operation is a drag/drop operation (step J4). When the drag/drop operation of the graph controller 23 has been performed (step J4: Yes; refer to FIG. 30B), the CPU 31 detects the amount of drag of the graph controller 23 (step J5), and converts the amount of drag into an enlarging magnification (step J6).

When an operation other than the drag/drop operation of the graph controller 23 has been performed, for example, when tap-out or the like of the graph controller 23 has been performed (step J4: No; refer to FIG. 30C), the CPU 31 detects the number of times of tap-out (step J7), and converts the number of times into a reducing magnification (step J8).

The CPU 31 calculates the ranges of the x-axis and the y-axis stored in the x-axis range storage area 722 and the y-axis range storage area 773 on the basis of the obtained magnifications (step J9), and performs the graph drawing process on the basis of the calculated ranges of the x-axis and the y-axis (step J10). FIG. 30D shows a state where the graphs G9A and G9B are displayed in an enlarged manner by the drag/drop operation of the graph controller 23, and FIG. 30E shows a state where the graphs G9A and G9B are displayed in a reduced manner by the tap-out of the graph controller 23.

The CPU 31 monitors the terminating operation, and determines whether or not the graph controller 23 has been operated by the input pen 17 (step J11). When it is determined that the terminating operation has been detected (step J11: Yes), the present process is terminated. When it is determined that the graph controller 23 has been operated by the input pen 17, the process returns to step J3.

As described above, according to the ninth embodiment, the input pen 17 is used to operate the graph controller 23 so that the graph can be displayed in an enlarged manner and a reduced manner. Therefore, the user can easily display the graph in an enlarged manner and a reduced manner.

### Tenth Embodiment

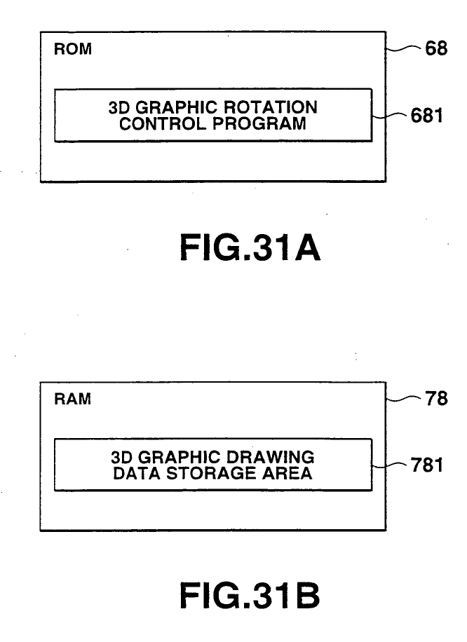

A tenth embodiment according to the present invention will be described. Since a configuration of a function electronic calculator according to the present embodiment is similar to a configuration where the ROM 32 and the RAM 33 are replaced with a ROM 68 shown in FIG. 31A and a RAM 78 shown in FIG. 31B, respectively, in the configuration of the function electronic calculator 1 described in FIG. 3 according to the first embodiment, like numerals are denoted to like constituents and a description thereof will be omitted below.

As shown in FIG. 31A, the ROM 68 comprises a 3D (three-dimensional) graphic rotation control program 681. The 3D graphic rotation control program 681 is a program for causing the CPU 31 to perform a 3D graphic rotation control process of performing rotation display of a 3D graphic displayed on the display device 38.

As shown in FIG. 31B, the RAM 78 comprises a 3D graphic drawing data storage area 781. Drawing data corresponding to a 3D graphic displayed on the display device 38 is stored in the 3D graphic drawing data storage area 781.

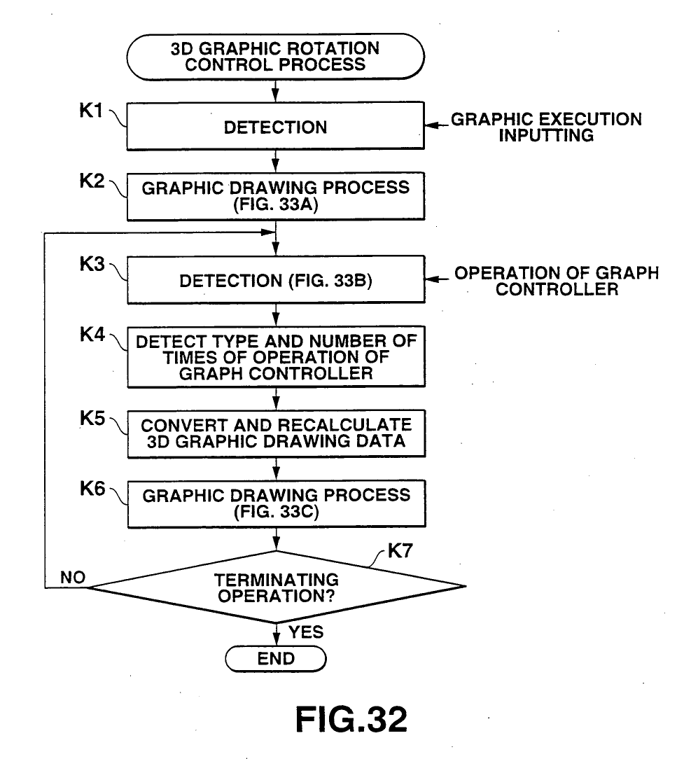

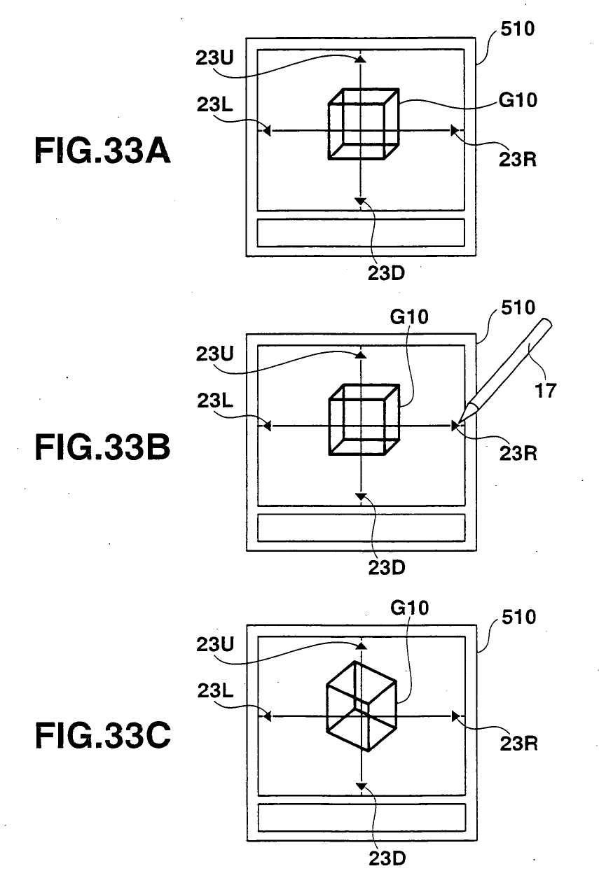

The pointer position transformation control process according to the tenth embodiment of the present invention will be described with reference to FIGS. 32 and 33A to 33C. FIG. 32 shows an operation flow of the function electronic calculator 1, and FIGS. 33A, 33B, and 33C are diagrams showing transition examples of a screen displayed on the display device 38.

When the graph mode is instructed by the mode switch operation, the CPU 31 starts execution of a predetermined program relating to the graph mode to set the graph mode, and waits for inputting of the setting items relating to the drawing of the graph such as inputting of a function equation or a display range of the graph to be drawn. At this time, when the CPU 31 detects graphic execution inputting (step K1), the CPU 31 performs a graphic drawing process on the basis of the drawing data stored in the 3D graphic drawing data storage area 781 (step K2; refer to FIG. 33A).

One example of a graph display screen 510 displayed in step K2 is shown in FIG. 33A. As illustrated, a graphic G10 based on the set display range is drawn on the graph display screen 510.

When the CPU 31 detects an operation of the graph controller 23 by the input pen 17 (step K3; refer to FIG. 33B), the CPU 31 detects the type and the number of times of the operation of the operated graph controller 23 (step K4). Which of the graph controllers 23U, 23D, 23L, and 23R has been operated is determined according to the detection of the type of the graph controller 23. The number of times of the operation of the graph controller 23 means, for example, the number of times of tap-out of the graph controller 23 by the input pen 17, or the like. FIG. 33B is a diagram showing a state where the graph controller 23R is operated by the input pen 17 (step K3).

The CPU 31 calculates a rotation direction (any of up, down, left, and right) and a rotation angle of the graphic G10 on the basis of the type and the number of times of the operation of the operated graph controller 23 so as to recalculate the drawing data (step K5), and performs the graphic drawing process (step K6; refer to FIG. 33C).

The CPU 31 monitors the terminating operation, and determines whether or not the graph controller 23 has been operated by the input pen 17 (step K7). When it is determined that the terminating operation has been detected (step K7: Yes), the present process is terminated. When it is determined that the graph controller 23 has been operated by the input pen 17, the process returns to step K3.

As described above, according to the tenth embodiment, the input pen 17 is used to operate the graph controller 23 so that the rotation display of the 3D graphic displayed on the display device 38 can be performed. Therefore, the user can easily grasp the shape and the like of the 3D graphic.

### Eleventh Embodiment

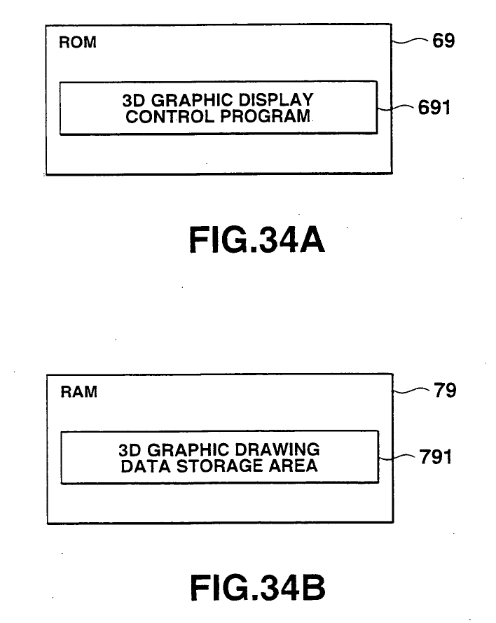

An eleventh embodiment according to the present invention will be described. Since a configuration of a function electronic calculator according to the present embodiment is similar to a configuration where the ROM 32 and the RAM 33 are replaced with a ROM 69 shown in FIG. 34A and a RAM 79 shown in FIG. 34B, respectively, in the configuration of the function electronic calculator 1 described in FIG. 3 according to the first embodiment, like numerals are denoted to like constituents and a description thereof will be omitted below.

As shown in FIG. 34A, the ROM 69 comprises a 3D graphic display control program 691. The 3D graphic display control program 691 is a program for causing the CPU 31 to perform a 3D graphic display control process of performing rotation display and movement display of a 3D graphic displayed on the display device 38.

As shown in FIG. 34B, the RAM 79 comprises a 3D graphic drawing data storage area 791. Drawing data corresponding to a 3D graphic displayed on the display device 38 is stored in the 3D graphic drawing data storage area 791.

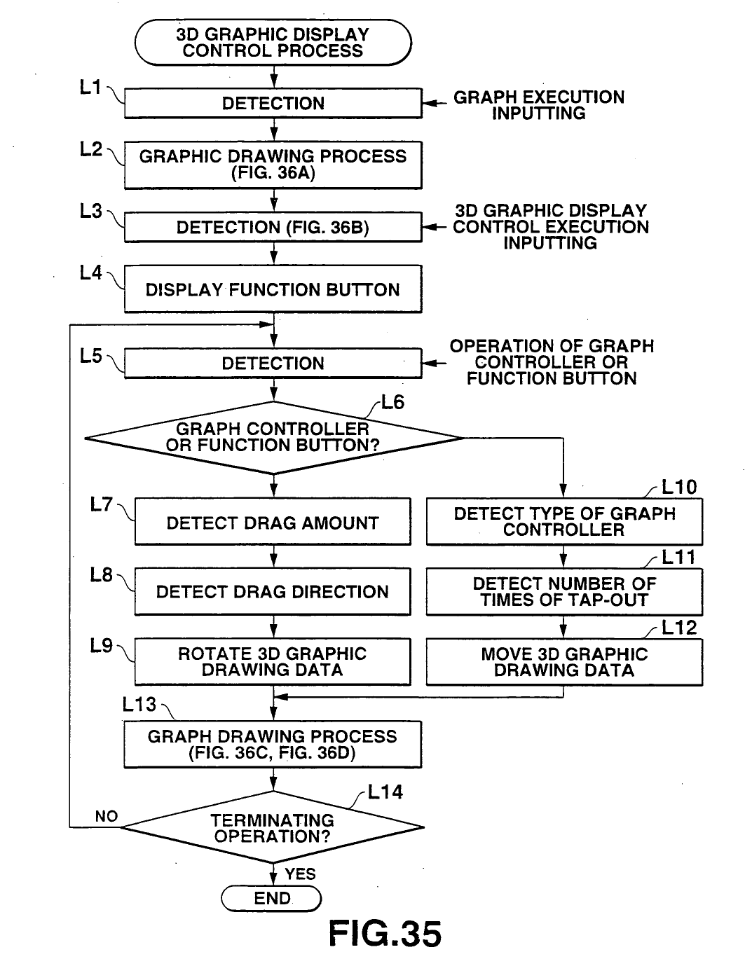

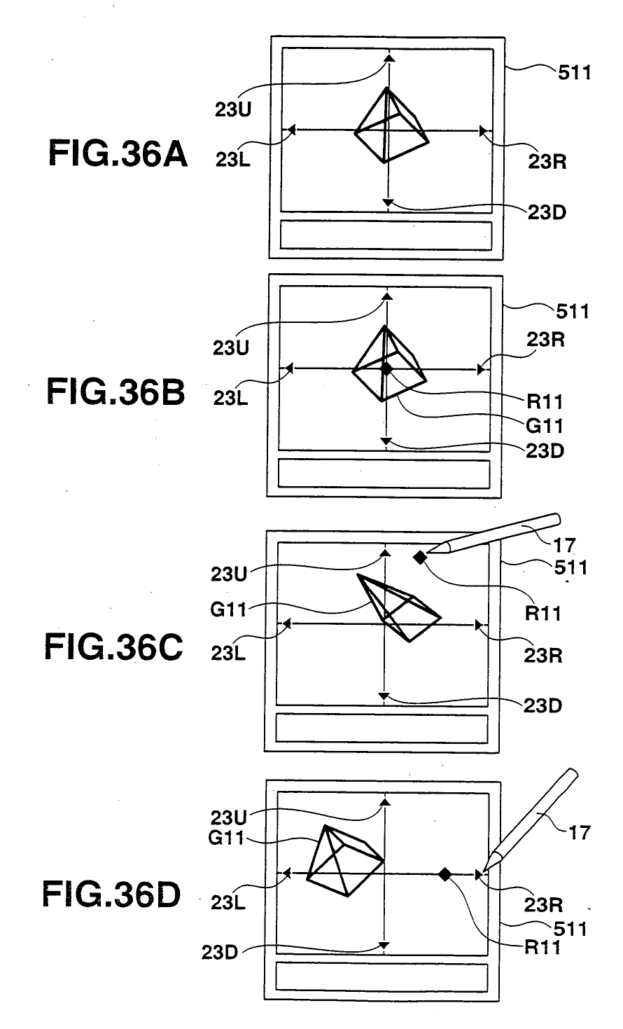

The pointer position transformation control process according to the eleventh embodiment of the present invention will be described with reference to FIGS. 35 and 36A to 36D. FIG. 35 shows an operation flow of the function electronic calculator 1, and FIGS. 36A, 36B, 36C, and 36D are diagrams showing transition examples of a screen displayed on the display device 38.

When the graph mode is instructed by the mode switch operation, the CPU 31 starts execution of a predetermined program relating to the graph mode to set the graph mode, and waits for inputting of the setting items relating to the drawing of the graph such as inputting of a function equation or a display range of the graph to be drawn. At this time, when the CPU 31 detects graphic execution inputting (step L1), the CPU 31 performs the graph drawing process on the basis of the drawing data stored in the 3D graphic drawing data storage area 791 (step L2; refer to FIG. 36A).

One example of a graph display screen 511 displayed in step L2 is shown in FIG. 36A. As illustrated, a graphic G11 based on the set display range is drawn on the graph display screen 511.

When the CPU 31 detects 3D graphic display control execution inputting (step L3; refer to FIG. 36B), the CPU 31 displays a function button R11 at an intersecting point of the x-axis and the y-axis displayed on the graph display screen 511 (step L4; refer to FIG. 36B).

When the CPU 31 detects an operation of the graph controller 23 or the function button R11 by the input pen 17 (step L5), the CPU 31 determines which of them has been operated (step L6). When the function button R11 has been operated (step L6: function button), the CPU 31 detects the amount of drag of the function button R11 (step L7), and further detects a drag direction (step L8). The amount of rotation and the rotation direction are determined on the basis of the amount of drag and the drag direction to perform the rotation process of the drawing data of the graphic G11 (step L9).

When the graph controller 23 has been operated (step L6: graph controller), the CPU 31 detects the type of the operated graph controller 23 (step L10). In other words, which of the graph controllers 23U, 23D, 23L, and 23R has been operated is detected. The number of times of the operation of the tap-out or the like for the graph controller 23 is detected (step L11). The movement process of the drawing data of the graphic G11 is performed on the basis of the number of times of the operation and the type of the operated graph controller 23 (step L12).

The CPU 31 performs the graphic drawing process (step L13; refer to FIGS. 36C and 36D).

FIG. 36C shows a case where the rotation display process of the graphic G11 is performed, and FIG. 36D shows the graph display screen 511 when the movement display process of the graphic G11 is performed.

The CPU 31 monitors the terminating operation, and determines whether or not the graph controller 23 has been operated by the input pen 17 (step L14). When it is determined that the terminating operation has been detected (step L14: Yes), the present process is terminated. When it is determined that the graph controller 23 has been operated by the input pen 17, the process returns to step L5.

As described above, according to the eleventh embodiment, the input pen 17 is used to operate the function button R11 so that the rotation display or the movement display of a 3D graphic displayed on the display device 38 can be performed. Therefore, the user can easily grasp the shape and the like of the 3D graphic. Further, when the user wants to return the displayed 3D graphic to the state before the rotation display, he/she can easily redisplay the same by operating the function button R11.

As described above, a description is given to the first to eleventh embodiments, but the graphic display control device according to the present invention is not limited to the above embodiments, and various modifications can be naturally applied within the range without departing from the spirit of the present invention.

The graphic display control device according to the above embodiments comprises a graphic display indicator (for example, the CPU 31 in FIG. 3) which displays a graph and coordinate axes in the display screen (for example, the display screen 15 in FIG. 1 or the display device 38 in FIG. 3) integrally formed with a touch panel, a detector (for example, the CPU 31 and the position detecting circuit 35 in FIG. 3) which detects a touch operation for a predetermined portion of the coordinate axes, and a processor (for example, the CPU 31 in FIG. 3) which, when a touch operation is detected by the detector, performs a display change process of the display screen.

According to this device, a touch operation is performed at the predetermined portion of the coordinate axes so that various display change processes can be performed for the display screen.

There may be configured the graphic display control device according to these embodiments wherein the detector includes an end portion operation detector (for example, the CPU 31 and the position detecting circuit 35 in FIG. 3; step A6 in FIG. 4) which assumes an end portion of the coordinate axes displayed on the display screen to be the predetermined portion and detects a touch operation on the end portion, and the processor includes a trace pointer display (for example, the CPU 31 and the display device 38 in FIG. 3; steps A4 and A11 in FIG. 4) which displays a trace pointer moving on the graph in response to the detection of the touch operation by the end portion operation detector.

According to this device, a touch operation is performed on an end portion of the coordinate axes so that the trace pointer can be displayed on the graph. Therefore, the tracing of the graph can be easily performed.

There may be provided a scroll display device (for example, the CPU 31 and the display device 38 in FIG. 3; steps C13 to C15 in FIG. 10) which, when a touch operation on an end portion of the coordinate axes is performed such that the trace pointer is moved out of the display screen, scrolling and displaying the graph and the coordinate axes such that the trace pointer after the movement is displayed within the display screen.

According to this device, the position or the coordinate of the trace pointer can be always confirmed within the display screen. Therefore, a task of performing scrolling or the like of the display screen in order to display the trace pointer moved out of the display screen can be omitted.

The detector may have end portion operation detector (for example, the CPU 31 and the position detecting circuit 35 in FIG. 3; step B3 in FIG. 7) which assumes an end portion of the coordinate axes displayed on the display screen to be the predetermined portion and detects a touch operation on the end portion, and the processor may have a screen moving and displaying unit (for example, the CPU 31 and the display device 38 in FIG. 3; steps B8 and B9 in FIG. 7) which moves and displays the graph and the coordinate axes in response to the detection of the touch operation by the end portion operation detector.

According to this device, a touch operation is performed on an end portion of the coordinate axes so that the graph and the coordinate axes can be moved and displayed. Further, the moving direction is set in an end portion of the coordinate axes so that the graph and the coordinate axes can be easily moved in a desired direction.

The detector may have an end portion operation detector (for example, the CPU 31 and the position detecting circuit 35 in FIG. 3; step K3 in FIG. 32) which assumes an end portion of the coordinate axes displayed on the display screen to be the predetermined portion and detects a touch operation on the end portion, and the processor may have a rotating and display unit (for example, the CPU 31 and the display device 38 in FIG. 3; step K6 in FIG. 32) which rotates and displays the graph in response to the detection of the touch operation by the end portion operation detector.

According to this device, a touch operation is performed on an end portion of the coordinate axes so that the graph can be rotated and displayed and the shape and the like of the graph can be easily grasped. When the rotation direction is set in an end portion of the coordinate axes, the graph can be rotated in a desired direction.

There may be provided a reference point display device (for example, the CPU 31 and the display device 38 in FIG. 3; step L4 in FIG. 35) which displays a display reference point indicating a reference position of the graph and capable of being moved by a touch operation on the display screen, and a rotating and display device (for example, the CPU 31 and the display device 38 in FIG. 3; steps L9 and K13 in FIG. 35) which, when the display reference point is moved by an touch operation, rotates and displays the graph displayed on the display screen.

According to this device, the display reference point is moved by a touch operation so that the graph can be rotated and displayed and the shape and the like of the graph can be easily grasped. When the rotation angle or the like is set according to the moving direction of the display reference point, or the like, the graph can be rotated in a desired direction.

The detector may include an end portion operation detector (for example, the CPU 31 and the position detecting circuit 35 in FIG. 3; step J3 in FIG. 29) which assumes an end portion of the coordinate axes displayed on the display screen to be the predetermined portion and detects a touch operation on the end portion, and the processor may have a display size changing unit (for example, the CPU 31 in FIG. 3; steps J6, J8, and J10 in FIG. 29) which displays the graph in an enlarged manner or a reduced manner in response to the detection of the touch operation by the end portion operation detector.

According to this device, a touch operation is performed on an end portion of the coordinates axes so that the graph can be displayed in a reduced manner or an enlarged manner.

The processor may have a display status switching unit (for example, the CPU 31 in FIG. 3; step D4 and step D11 in FIG. 13; step H8 in FIG. 26) which changes a display status of the graph in response to a detection of a touch operation by the detector.

According to this device, a touch operation is performed on the predetermined portion of the coordinate axes so that the display status of the graph can be switched. Therefore, a display of a specific graph can be easily switched when a plurality of graphs are displayed on the display screen, or a display of a page file can be easily switched when a plurality of page files which store the graph are present.

There may be further provided a function equation display device (for example, the CPU 31 and the display device 38 in FIG. 3; step E6 in FIG. 16; step F2 in FIG. 19) which displays a function equation of the graph, wherein the processor may have a coefficient changing unit (for example, the CPU 31 in FIG. 3; steps E11 and E12 in FIG. 16; steps F10 and F1 in FIG. 19) which changes a value of a coefficient included in the function equation, and a graph redisplay device (for example, the CPU 31 and the display device 38 in FIG. 3; step E14 in FIG. 16; step F16 in FIG. 19) which redisplays the graph along with the change in the coefficient by this coefficient changing unit.

According to this device, a touch operation is performed on the predetermined portion of the coordinate axes so that a coefficient of the function equation can be changed and the graph can be redisplayed. Therefore, the shape and the like of the graph along with the change in the coefficient of the function equation can be easily confirmed.

### Twelfth Embodiment

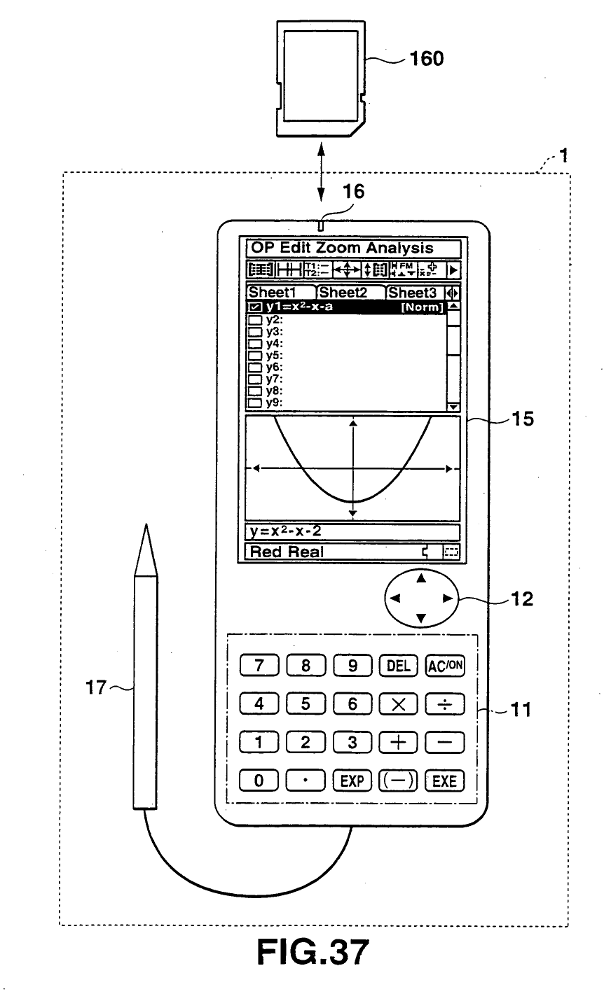

Hereinafter, a twelfth embodiment of a graphic display control device according to the present invention will be described in detail with reference to FIGS. 37 to 41B. In the following, the present invention will be described by way of an example of a case where a function electronic calculator having a graph & graphic display function is applied, but like numerals are denoted to the same constituents as those according to the first to eleventh embodiments.

In the drawing, the function electronic calculator 1 comprises a calculation unit (not shown) which performs a calculation process, the operation input keys 11 which perform inputting of numeric/function/calculation operation, the direction key 12 which performs scrolling of a screen or selection operation, the display screen 15 which displays input numerals or graphs, the input pen 17, and the power supply (not shown) such as an incorporated battery or a solar battery. The function electronic calculator 1 is cased, for example, in a card shape by a metal or a resin.

The operation input keys 11 and the direction key 12 are operation inputting means similar to the conventional function electronic calculator 1, and can be realized by a key switch, a touch panel, or the like, for example.

The display screen 15 is a portion on which various data such as characters, codes, or graph displays in response to the pressing of the operation input keys 11, which are required for using the function electronic calculator 1, are displayed, and on which characters or graphics are displayed by dots. The display screen 15 is an element such as a LCD (Liquid Crystal Display) or an ELD (Electronic Luminescent Display), and can be realized by a single element or a combination of several elements.

The function electronic calculator 1 comprises the slot 16 for the storage medium 160. The storage medium 160 is a storage medium which stores function equation data and the like therein, such as, for example, a memory card, a hard disk. The slot 16 is a device which detachably mounts the storage medium 160 and can read/write data from/into the storage medium 160, and is appropriately selected according to the type of the storage medium 160.

The tablet (touch panel) is integrally constituted on the display screen 15, where press-inputting by the input pen 17 can be sensed.

Various functions such as a calculating function, a graph function, a program function, and the like are mounted on the function electronic calculator 1, and each function described above can be performed by selecting an operation mode corresponding to the function to be utilized. For example, when the operation input keys 11 or the like are used to perform a selection operation of a graph mode, the operation mode is set to the graph mode so that a graphic such as a graph can be drawn in the coordinate system based on the set display range.

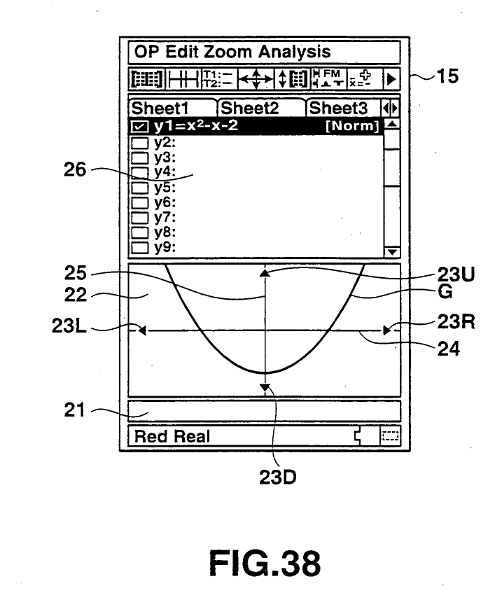

FIG. 38 is a diagram for explaining a display configuration of the display screen 15. A display area of the display screen 15 is divided into the equation display area 21, the graph display area 22, and a function equation input area 23. A function equation corresponding to a graph displayed on the graph display area 22, an equation generated by a calculation process for the graph, or the like is displayed in the equation display area 21. A function equation or the like input by an operation of the operation input keys 11 or the like is displayed in the function equation input area 26.

A graph G indicating a function equation displayed in the equation display area 21 or a function equation stored in an internal memory of the function electronic calculator 1 or the storage medium 160 is displayed in the graph display area 22. Assuming that a horizontal direction in the graph display area 22 is an x coordinate and a longitudinal direction is a y coordinate, the x-axis 24 and the y-axis 25 are displayed in the graph display area 22. Further, the graph controllers 23L and 23R, and the graph controllers 23U and 23D are displayed at both ends of the x-axis 24 and at both ends of the y-axis 25, respectively (hereinafter, the graph controllers 23L, 23R, 23U, and 23D are comprehensively referred to as the graph controller 23).

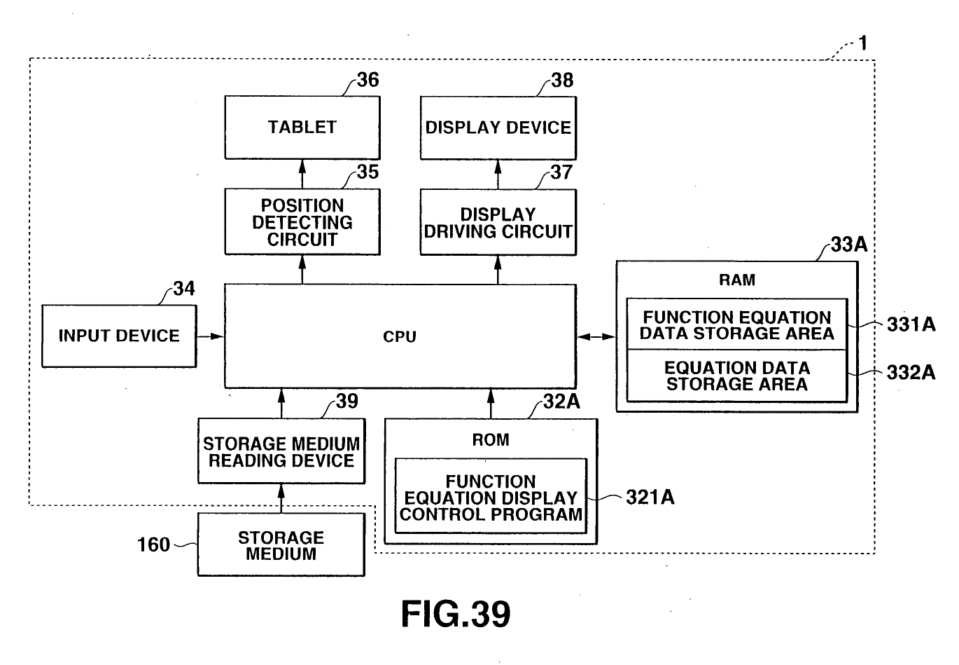

Hereinafter, this twelfth embodiment will be described more specifically. FIG. 39 is a block diagram showing a configuration of the function electronic calculator 1. As illustrated, the function electronic calculator 1 is constituted by comprising the CPU (Central Processing Unit) 31, a ROM (Read Only Memory) 32A, a RAM (Random Access Memory) 33A, the input device 34, the position detecting circuit 35, the tablet 36, the display driving circuit 37, the display device 38, and the storage medium reading device 39.

The CPU 31 performs a process based on a predetermined program in response to an input instruction, and performs instructing to each function section, transferring of data, and the like. Specifically, the CPU 31 reads out a program stored in the ROM 32A in response to an operation signal input from the input device 34 or the table 36, and performs a process according to the program. The CPU 31 stores a process result in the RAM 33A and appropriately outputs a display signal for displaying the process result to the display driving circuit 37 so as to display the display information corresponding to the display signal on the display device 38.

The ROM 32A stores various process programs relating to the operation of the function electronic calculator 1 such as various setting processes and various calculation processes, applications for realizing various functions which the function electronic calculator 1 comprises, and the like therein. Further, the ROM 32A stores a function equation display control program 321A therein.

The function equation display control program 321A is a program for causing the CPU 31 to perform a function equation display control process of holding a display status of the equation display area 21 even when a display screen of the display device 38 is switched by switching an application.

The RAM 33 comprises a memory area which temporarily holds various programs executed by the CPU 31, data relating to execution of these programs, and the like. The RAM 33A particularly comprises a function equation data storage area 331A and an equation data storage area 332A. For example, function equations required when a graph such as linear function, quadratic function, trigonometric function, circle is created are stored in the function equation data storage area 331A. An equation generated by execution of the calculation process for the graph displayed in the graph display area 22 is stored in the equation data storage area 332A. Here, the calculation process includes, for example, a root process of finding an intersecting point of a graph and an x-axis, a tangent process of finding a tangent equation of a graph, an integral process of integrating, and the like.

The input device 34 is means by which a user inputs numerals, execution instruction of the calculation process, and the like, and corresponds to the operation input keys 11 and the direction key 12 in the example in FIG. 37. A signal corresponding to the key pressed by the user is output to the CPU 31. The input device 34 may include a pointing device such as a mouse, or the like.

The function electronic calculator 1 comprises the tablet (touch panel) 36 as an input device. The tablet 36 senses a position on the display device 38 indicated (touched) by an input pen (corresponding to the input pen 17 shown in FIG. 37), and outputs a signal in response to the indicated (touched) position. The position detecting circuit 35 connected to the tablet 36 detects a position coordinate indicated on the display device 38 on the basis of the signal input from the tablet 36. When the tablet 36 is used, the position in the display area of the display device 38 can be directly designated. Particularly, the input pen 17 is touched on the tablet 36 so that operations such as tap-in, drag, tap-out, and drop can be realized.

Here, tap-in means an operation of contacting the input pen 17 on the display screen 15, and tap-out means an operation of releasing the input pen 17 from the display screen 15 after touched. Drag means an operation of sliding the input pen 17 onto the display screen 15 from tap-in to tap-out, and drop means an operation of tap-out after drag is performed.

The display driving circuit 37 controls the display device 38 on the basis of the display signal input from the CPU 31 and causes it to display various screens. The display device 38 is constituted by a LCD, an ELD, or the like. This display device 38 corresponds to the display screen 15 shown in FIG. 37, and is integrally formed with the tablet 36.

The storage medium reading device 39 is a function section for performing reading/writing of data from/into the storage medium 160 such as, for example, a memory card, or a hard disk. The slot 16 in FIG. 37 corresponds thereto.

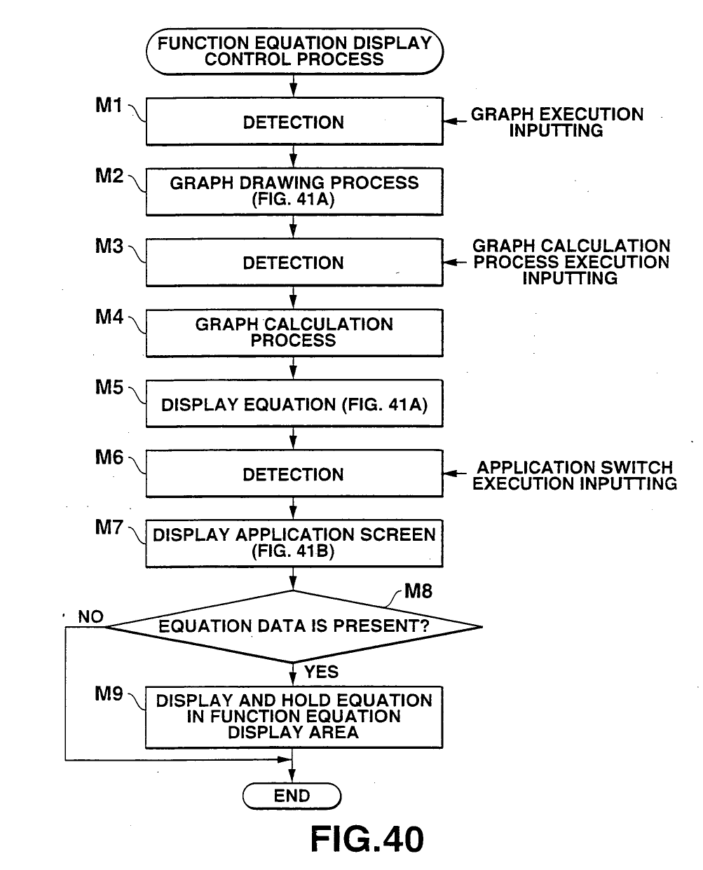

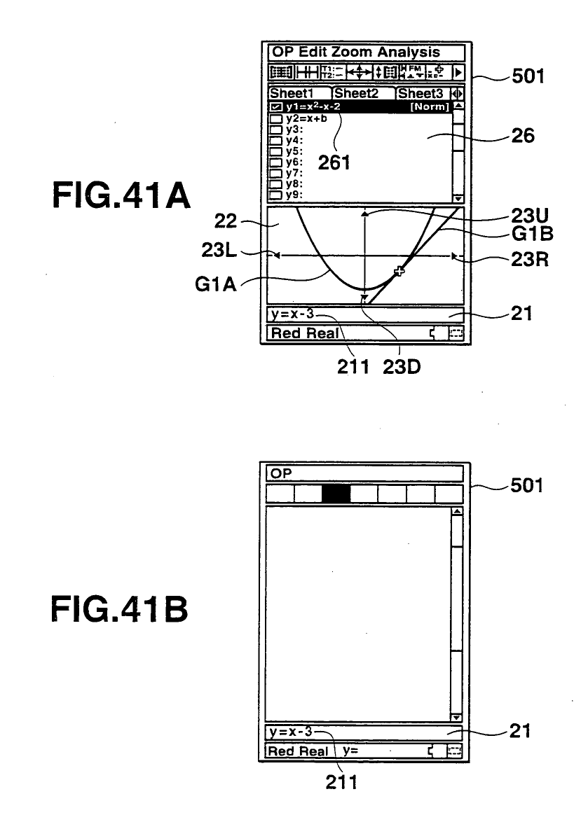

FIG. 40 is a flow chart for explaining an operation of the function equation display control process performed by the CPU 31 according to the function equation display control program 321A. FIGS. 41A and 41B are diagrams showing transition examples of a screen displayed on the display device 38. A flow of the function equation display control process will be described using FIGS. 40 to 41B.

When the graph mode is instructed by the mode switch operation, the CPU 31 starts execution of a predetermined program relating to the graph mode to set the graph mode, and waits for inputting of the setting items relating to the drawing of the graph such as inputting of an equation or a display range of the graph to be drawn. As shown in FIG. 40, when the CPU 31 detects graph execution inputting (step M1), the CPU 31 performs the graph drawing process according to the function equation selected in the function equation input area 26 and the input setting items (step M2; refer to FIG. 41A).

When the CPU 31 detects graph calculation process execution inputting (step M3), the CPU 31 performs the calculation process for a graph displayed in the graph display area 22 (step M4). Further, the CPU 31 displays an equation generated by the calculation process in the equation display area 21, and stores it in the equation data storage area 332A (step M4).

FIG. 41A is a diagram showing one example of the display screen 501 when a tangent G1B is displayed as a result of the tangent process for a graph G1A based on a function equation 261 in step M4. An equation 211 corresponding to the tangent G1B in step M5 is displayed in the equation display area 21.

When the CPU 31 detects a switch in an application (step M6), the CPU 31 switches the display screen of the display device 38 according to execution of the application (step M7).

The CPU 31 determines whether or not an equation is stored in the equation data storage area 332A (step M8). When an equation is not stored (step M8: No), the CPU 31 terminates the process. When an equation is stored (step M8: Yes), the CPU 31 holds the display of the equation display area 21 (step M4), and terminates the process.

FIG. 41B shows one example of the display screen 501 after the application has been switched. The display areas of the graph display area 22 and the function equation input area 26 are switched by execution of an application, but the equation display area 21 holds the display in a state where the equation 211 is displayed.

As described above, according to the twelfth embodiment, the display of the equation display area 21 can be held even when the display of the display device 38 is switched by the switch in the application. Therefore, for example, since the display of the equation generated during the graph process can be held even when an application is switched during the graph process, the equation can be processed by execution of other application.

### Thirteenth Embodiment

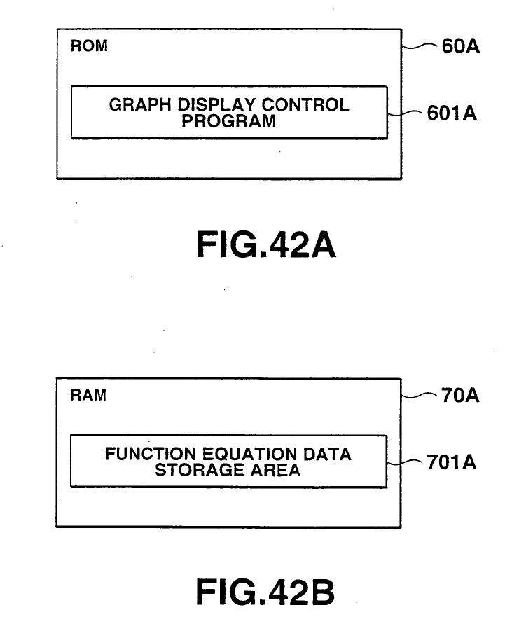

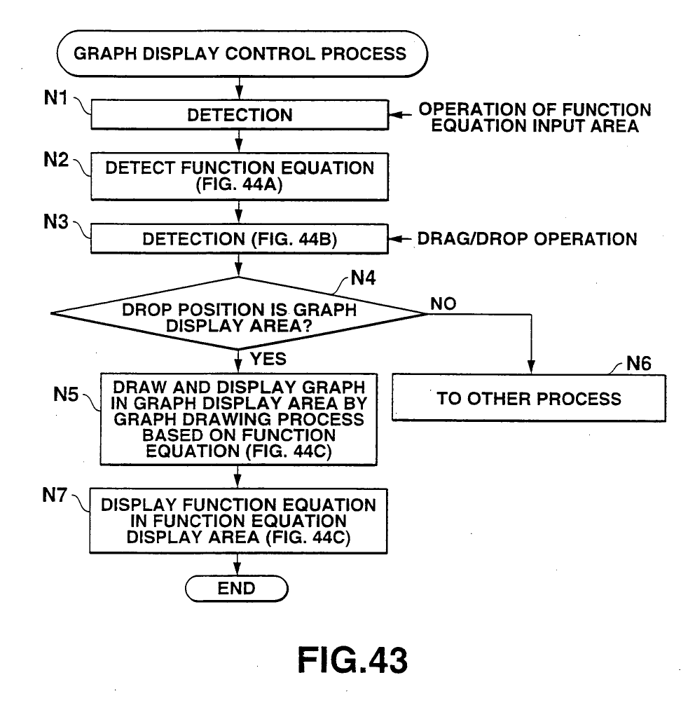

A thirteenth embodiment according to the present invention will be described. Since a configuration of a function electronic calculator according to the present embodiment is similar to a configuration where the ROM 32A and the RAM 33A are replaced with a ROM 60A shown in FIG. 42A and a RAM 70A shown in FIG. 42B, respectively, in the configuration of the function electronic calculator 1 described in FIG. 39 according to the twelfth embodiment, like numerals are denoted to like constituents and a description thereof will be omitted below.

As shown in FIG. 42A, the ROM 60A stores a graph display control program 601A therein. The graph display control program 601A is a program for causing the CPU 31 to perform a graph display control process of displaying a graph in the graph display area 22 on the basis of a selected function equation.

As shown in FIG. 42B, the RAM 70A comprises a function equation data storage area 701A. A function equation corresponding to the graph displayed on the display device 38 is stored in the function equation data storage area 701A.

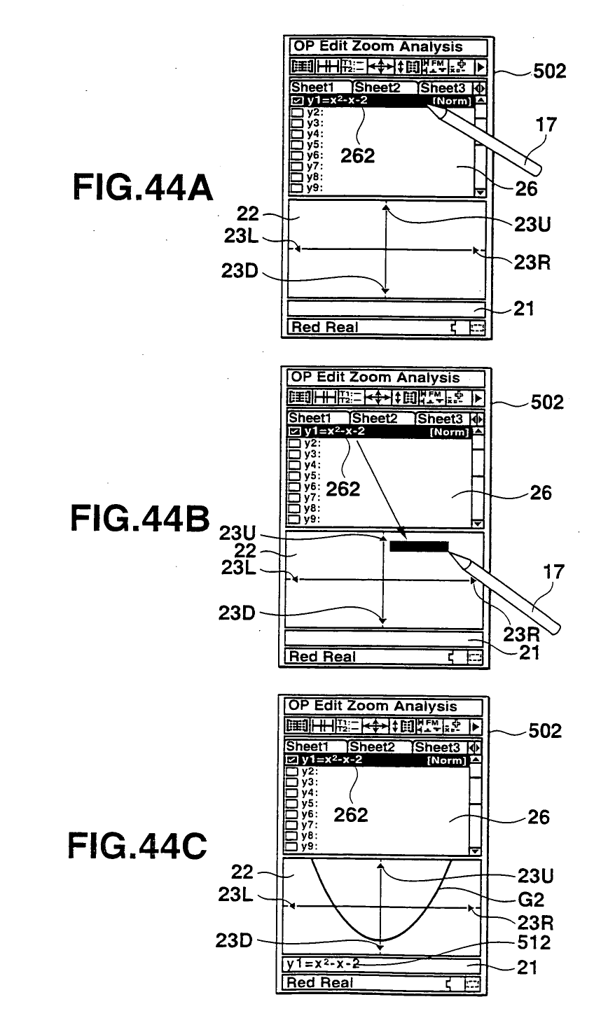

The graph display control process according to the thirteenth embodiment of the present invention will be described with reference to FIGS. 43 and 44A to 44C. FIG. 43 shows an operation flow of the function electronic calculator 1, and FIGS. 44A, 44B, and 44C are diagrams showing transition examples of a screen displayed on the display device 38.

When the graph mode is instructed by the mode switch operation, the CPU 31 starts execution of a predetermined program relating to the graph mode to set the graph mode, and waits for inputting of the setting items relating to the drawing of the graph such as inputting of an equation or a display range of the graph to be drawn. As shown in FIG. 43, when the CPU 31 detects an operation of the function equation input area 26 by the input pen 17 (step N1), the CPU 31 detects a function equation selected by the operation (step N2; refer to FIG. 44A). FIG. 44A shows one example of the display screen 502 when a function equation 262 displayed in the function equation input area 26 in step N2 is tapped in by the input pen 17.

When the CPU 31 detects a drag/drop operation of the function equation 262 by the input pen 17 (step N3; refer to FIG. 44B), the CPU 31 determines whether or not the drop position is within the graph display area 22 (step N4). When it is out of the graph display area 22 (step N4: No), the CPU 31 performs other process (step N6).

When the drop position is within the graph display area 22 (step N4: Yes), the CPU 31 performs the graph drawing process on the basis of the function equation 262 (step N5; refer to FIG. 44C). A graph G2 corresponding to the function equation 262 is displayed as shown in FIG. 44C by this process. On the other hand, the function equation 262 which is a target of this graph drawing process is displayed as an equation in the equation display area 21 as shown in FIG. 44C (step N7). The process is terminated.

As described above, according to the thirteenth embodiment, one function equation is selected or designated from among a plurality of function equations displayed in the function equation input area 26, and then operations of the drag operation and the drop operation by the input pen 17 are performed so that a graph based on the selected or designated function equation can be easily and rapidly drawn and displayed in the graph display area. Therefore, the user can easily perform displaying of the graph.

According to the thirteenth embodiment, one function equation is selected or designated from among a plurality of function equations displayed in the function equation input area 26 by the drag operation by the input pen 17, and then it is determined whether or not the drop operation of the selected or designated function equation from the drag operation position to the position in the graph display area has been performed. On the condition that the drop operation of the selected or designated function equation to the position in the graph display area has been performed, the graph based on the selected or designated function equation can be drawn and displayed in the graph display area so that the graph corresponding to the drop operation of the function equation into the graph display area can be visually displayed continuously in an associated manner.

Additionally, since the function equation corresponding to the displayed graph is displayed as an equation in the equation display area 21, the displayed graph and the function equation corresponding thereto are visually and easily grasped.

A display of the graph based on the selected or designated function equation may be performed by the tap-in operation or the cursor operation by the input pen 17 for the function equation input area 21 and the graph display area 26 instead of performing the display of the graph based on the selected or designated function equation by the drag operation and the drop operation by the input pen 17.

### Fourteenth Embodiment

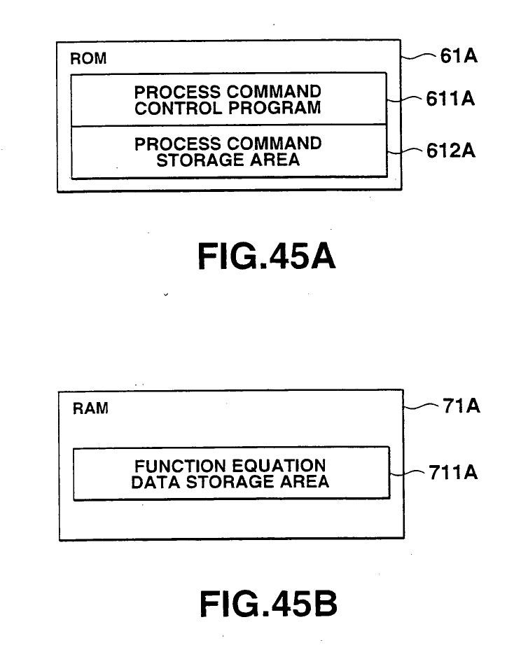

A fourteenth embodiment according to the present invention will be described. Since a configuration of a function electronic calculator according to the present embodiment is similar to a configuration where the ROM 32A and the RAM 33A are replaced with a ROM 61A shown in FIG. 45A and a RAM 71A shown in FIG. 45B, respectively, in the configuration of the function electronic calculator 1 described in FIG. 39 according to the twelfth embodiment, like numerals are denoted to like constituents and a description thereof will be omitted below.

As shown in FIG. 45A, the ROM 61A stores a process command control program 611A and a process command storage area 612A therein. The process command control program 611A is a program for causing the CPU 31 to perform a process command control process of, when a calculation process is performed for a graph displayed in the graph display area 22, assigning a process command to an equation to be displayed in the equation display area 21 on the basis of the calculation process and displaying the same. A process command name corresponding to the calculation process is stored in the process command storage area 612A.

The calculation process includes, for example, a root process of finding an intersecting point of a graph and an x-axis, a tangent process of finding a tangent equation of a graph, an integral process of integrating, and the like.

As shown in FIG. 45B, the RAM 71A comprises a function equation data storage area 711A. A function equation corresponding to the graph displayed on the display device 38 is stored in the function equation data storage area 711A.

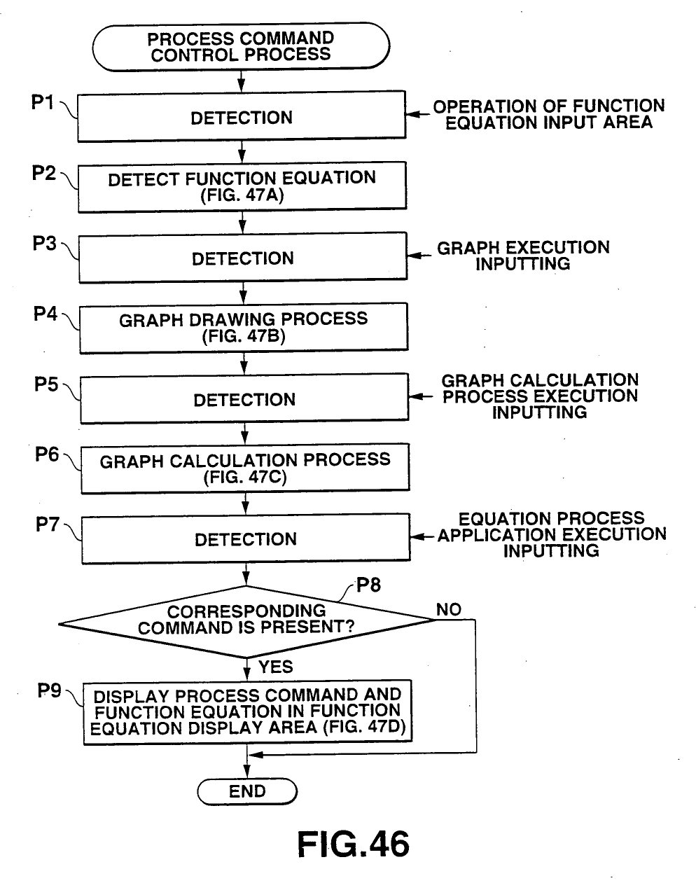

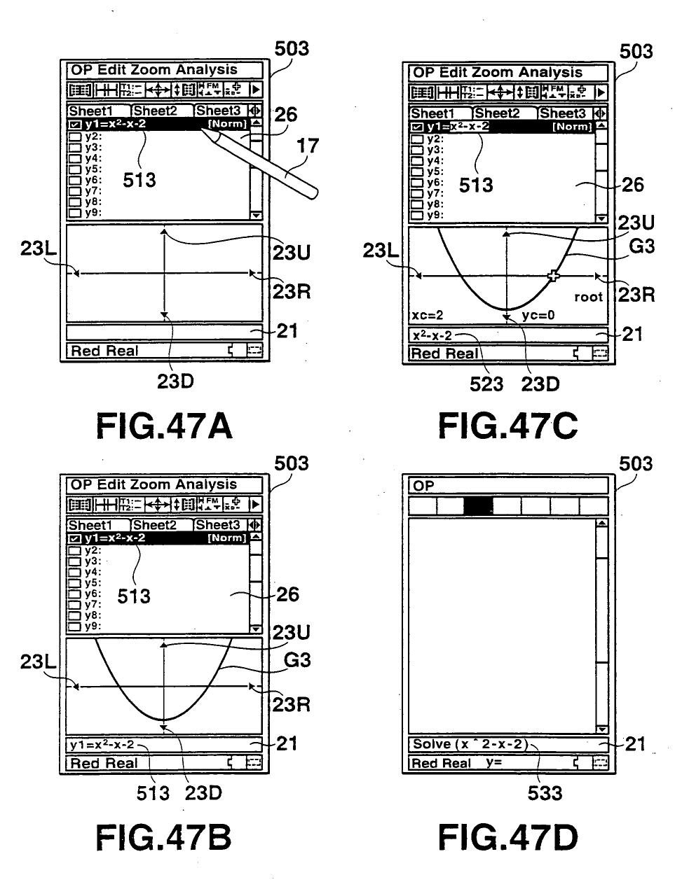

The process command control process performed by the CPU 31 according to the process command control program 611A will be described with reference to FIGS. 46 and 47A to 47D. FIG. 46 shows an operation flow of the function electronic calculator 1, and FIGS. 47A to 47D are diagrams showing transition examples of a screen displayed on the display device 38.

When the graph mode is instructed by the mode switch operation, the CPU 31 starts execution of a predetermined program relating to the graph mode to set the graph mode, and waits for inputting of the setting items relating to the drawing of the graph such as inputting of an equation or a display range of the graph to be drawn. As shown in FIG. 46, when the CPU 31 detects an operation of the function equation input area 26 by the input pen 17 (step P1), the CPU 31 detects a function equation selected by the operation (step P2; refer to FIG. 47A). FIG. 47A shows one example of the display screen 503 when a function equation 513 displayed in the function equation input area 26 is tapped in by the input pen 17 in step P2.

When the CPU 31 detects graph execution inputting (step P3), the CPU 31 performs the graph drawing process according to the function equation 513 selected by the input pen 17 and the input setting items (step P4; refer to FIG. 47B).

One example of the display screen 503 displayed at this stage is shown in FIG. 47B. As illustrated, a graph G3 based on the set display range is drawn in the graph display area 22. Further, an equation 523 corresponding to the graph G3 is displayed in the equation display area 21.

When the CPU 31 detects graph calculation process execution inputting (step P5), the CPU 31 performs the calculation process for the graph G3 (step P6; refer to FIG. 47C). At this time, an equation or the like generated by the execution of the calculation process is displayed in the equation display area 21. FIG. 47C shows one example of the display screen 503 when the root process, that is the process of finding an intersecting point of the graph G3 and the x-axis is performed for the graph G3. An equation 533 generated by the root process is displayed in the equation display area 21.

When the CPU 31 detects equation process application execution inputting (step P7), the CPU 31 determines whether or not a process command corresponding to the calculation process performed in step P6 is stored in the process command storage area 612A (step P8). When a corresponding process command is stored (step P8: Yes), the corresponding process command is inserted into a header of the equation 523 and is displayed (step P9; refer to FIG. 47D). When the corresponding process command is not stored (step P8: No), the CPU 31 terminates the process.

FIG. 47D is a diagram showing one example of the display screen 503 in step P9. For example, when the root process is performed in the graph calculation process in step P6, a command “solve” indicating a process of finding a value of an arbitrary variable included in the equation 533 is inserted into a header of the equation 533 to be displayed as an equation 534.

As described above, according to the fourteenth embodiment, the process command can be displayed in the equation display area 21 according to the calculation process performed for the graph displayed in the graph display area 22. Therefore, an equation process corresponding to the calculation process performed for the graph can be easily performed for a function equation displayed in the equation display area 21.

### Fifteenth Embodiment

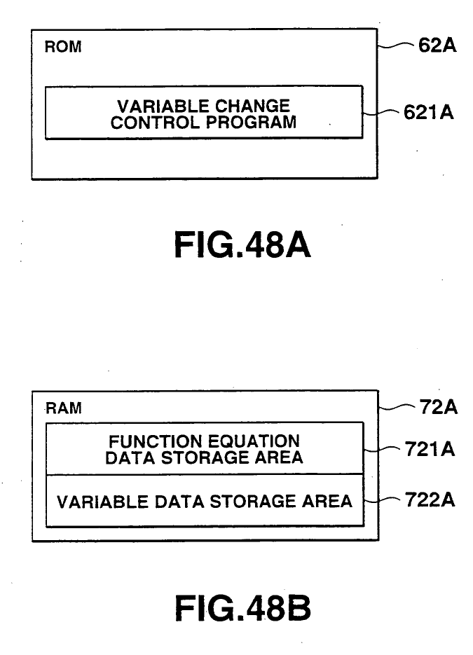

A fifteenth embodiment according to the present invention will be described. Since a configuration of a function electronic calculator according to the present embodiment is similar to a configuration where the ROM 32A and the RAM 33A are replaced with a ROM 62A shown in FIG. 48A and a RAM 72A shown in FIG. 48B, respectively, in the configuration of the function electronic calculator 1 described in FIG. 39 according to the twelfth embodiment, like numerals are denoted to like constituents and a description thereof will be omitted below.

As shown in FIG. 48A, the ROM 62A stores a variable change control program 621A therein. The variable change control program 621A is a program for causing the CPU 31 to perform a variable change control process for changing a selected coefficient in a function equation displayed in the equation display area 21.

As shown in FIG. 48B, the RAM 72A comprises a function equation data storage area 721A and a variable data storage area 722A. A function equation corresponding to the graph displayed on the display device 38 is stored in the function equation data storage area 721A. A value of a selected coefficient in a function equation displayed in the equation display area 21 is stored in the variable data storage area 722A.

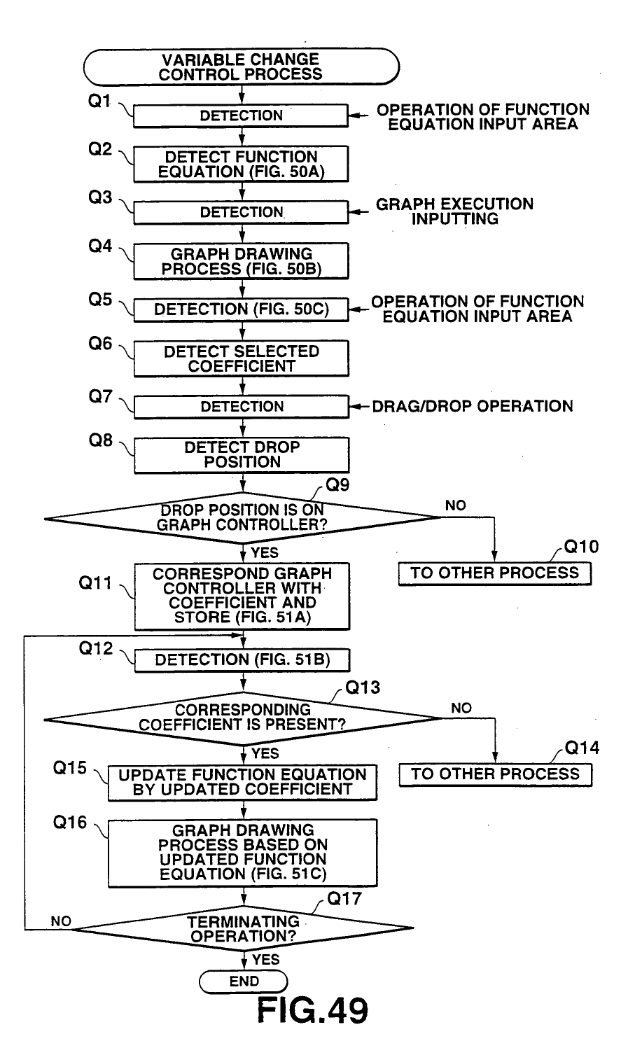

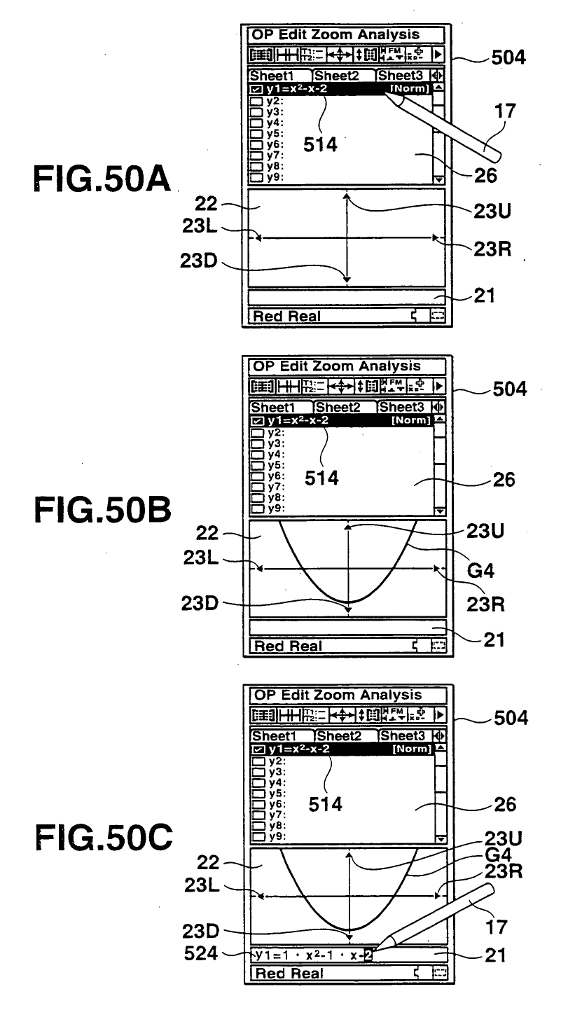

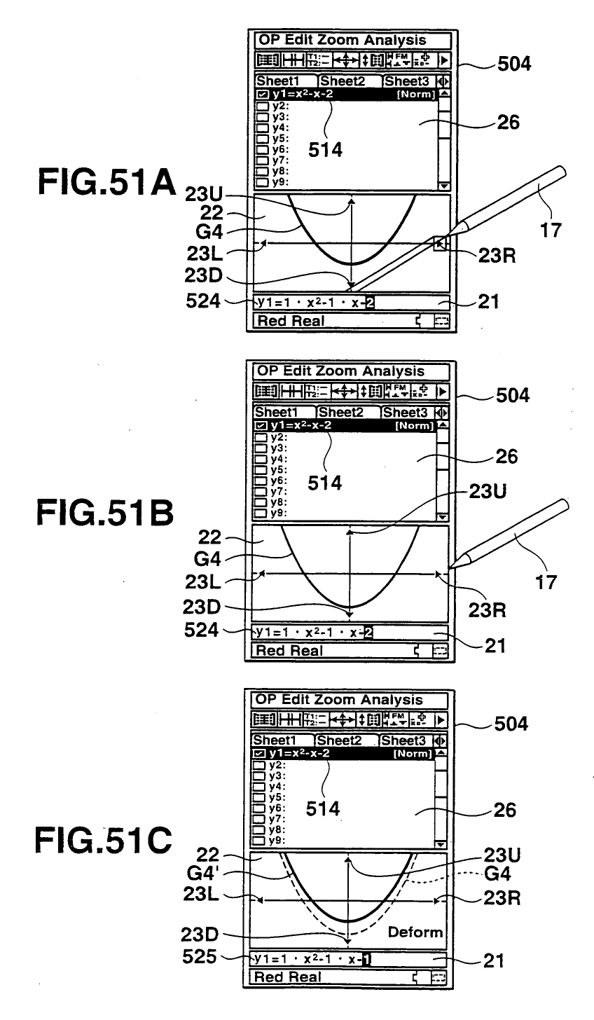

The variable change control process performed by the CPU 31 according to the variable change control program 621A will be described with reference to FIGS. 49 and 50A to 51C. FIG. 49 shows an operation flow of the function electronic calculator 1, and FIGS. 50A to 51C are diagrams showing transition examples of a screen displayed on the display device 38.

When the graph mode is instructed by the mode switch operation, the CPU 31 starts execution of a predetermined program relating to the graph mode to set the graph mode, and waits for inputting of the setting items relating to the drawing of the graph such as inputting of a function equation or a display range of the graph to be drawn. As shown in FIG. 49, when the CPU 31 detects an operation of the equation display area by the input pen 17 (step Q1), the CPU 31 detects a function equation selected by the operation (step Q2; refer to FIG. 50A). FIG. 50A shows one example of the display screen 504 when a function equation 514 displayed in the function equation input area 26 is tapped in by the input pen 17 in step Q2.

When the CPU 31 detects graph execution inputting (step Q3), the CPU 31 stores the selected function equation 514 in the function equation data storage area 721A, and performs the graph drawing process according to the function equation and the input setting items (step Q4; refer to FIG. SOB). One example of the display screen 504 displayed at this stage is shown in FIG. 50B. As illustrated, a graph G4 based on the set display range is drawn on the display screen 504.

When the CPU 31 detects an operation of the equation display area 21 by the input pen 17 (step Q5; refer to FIG. 50C), the CPU 31 detects a coefficient of a function equation 524 selected by the operation, and stores this selected coefficient in the variable data storage area 722A (step Q6; FIG. 50C).

When the CPU 31 detects a drag/drop operation of the coefficient by the input pen 17 (step Q7), the CPU 31 performs a detection of a drop position (step Q8). The CPU 31 determines whether or not the drop position is on the graph controller 23 (step Q9), and performs other process (step Q10) in the case of other than the graph controller 23 (step Q9: No).

When the drop position is on the graph controller 23 (step Q10: Yes), the CPU 31 stores the graph controller 23 and the selected coefficient in the variable data storage area 722A in a corresponding manner (step Q11; refer to FIG. 51A). For example, as shown in FIG. 51A, when a coefficient “2” of the function equation 524 is selected and dragged, and is dropped at the position of the graph controller 23R, the coefficient “2” and the graph controller 23R are corresponded to each other, and are stored in the variable data storage area 722A.

When the CPU 31 detects an operation of the graph controller 23 (step Q12; refer to FIG. 51B), the CPU 31 determines whether or not the operated graph controller 23 and the coefficient are stored in the variable data storage area 722A in a corresponding manner (step Q13). In the case of not being stored (step Q13: No), the CPU 31 performs other process (step Q14). In the case of being stored (step Q13: Yes), the CPU 31 adds or subtracts a predetermined value to/from the coefficient, and updates the function equation stored in the function equation data storage area 721A on the basis of the updated coefficient (step Q15). The graph drawing process is performed on the basis of the function equation (step Q16; refer to FIG. 51C).

The predetermined value means the amount of change by which the coefficient is increased/decreased by one operation for the graph controller 23, and is previously set such as before the variable change control process is performed. For example, the predetermined value may be added to the coefficient corresponded to the graph controller when the graph controller 23U or 23R has been operated, and the predetermined value may be subtracted from the coefficient corresponded to the graph controller when the graph controller 23D or 23L has been operated.

FIG. 51B shows one example of the display screen 504 when the graph controller 23R is tapped in by the input pen 17 in step Q12. Here assuming that the coefficient “2” of the function equation 524 is registered in, for example, the graph controller 23R among the four graph controllers 23U, 23D, 23L, and 23R, since “1” is added by one operation by the input pen 17 for the graph controller 23R, a graph G4′ (graph with solid line) corresponding to a function equation 525 based on the coefficient updated by this one operation is displayed in the graph display area 22 instead of the displayed graph G4 (graph with broken line) (FIG. 51C).

When one operation by the input pen 17 for the graph controller 23R is continuously performed, “1” is added and a graph corresponding to the function equation 525 based on the coefficient updated by this one operation is displayed in the graph display area 22.

The CPU 31 monitors the terminating operation, and determines whether or not the graph controller 23 has been operated by the input pen 17 (step Q17). When it is determined that the terminating operation has been detected (step Q17: Yes), the present process is terminated. When it is determined that the graph controller 23 has been operated by the input pen 17, the process returns to step Q12.

As described above, according to the fifteenth embodiment, after the input pen 17 is used to select a coefficient of the function equation displayed in the equation display area 21 and to register this selected coefficient in any one of the four graph controllers 23U, 23D, 23L, and 23R, each time when the operation of the input pen 17 is performed for the graph controller 23U, 23D, 23L, or 23R in which the selected coefficient is registered, a value of the registered coefficient can be changed. Therefore, the user can easily confirm a change in the shape of the graph along with the change in the coefficient by the operation of the input pen 17.

### Sixteenth Embodiment

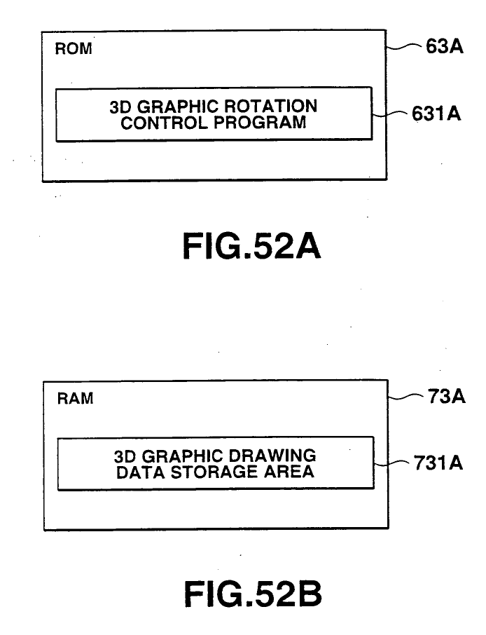

A sixteenth embodiment according to the present invention will be described. Since a configuration of a function electronic calculator according to the present embodiment is similar to a configuration where the ROM 32A and the RAM 33A are replaced with a ROM 63A shown in FIG. 52A and a RAM 73A shown in FIG. 52B, respectively, in the configuration of the function electronic calculator 1 described in FIG. 39 according to the twelfth embodiment, like numerals are denoted to like constituents and a description thereof will be omitted below.

As shown in FIG. 52A, the ROM 63A stores a function equation registration control program 631A therein. The function equation registration control program 631A is a program for causing the CPU 31 to perform a function equation registration control process of registering a function equation in each of the four graph controllers 23, and then displaying a graph on the basis of the function equation registered by the operation of the graph controller 23.

As shown in FIG. 52B, the RAM 73A comprises a function equation data storage area 731A. A plurality of pairs of the graph controller 23 and a function equation in a corresponding manner are stored by execution of the function equation registration control process by the CPU 31 in the function equation data storage area 731A.

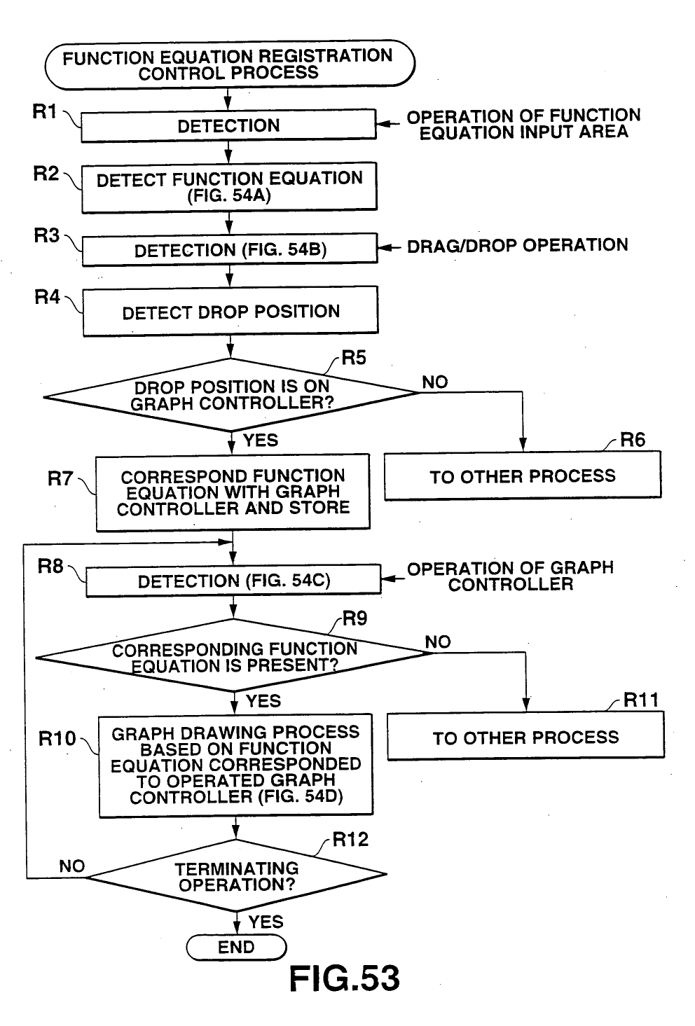

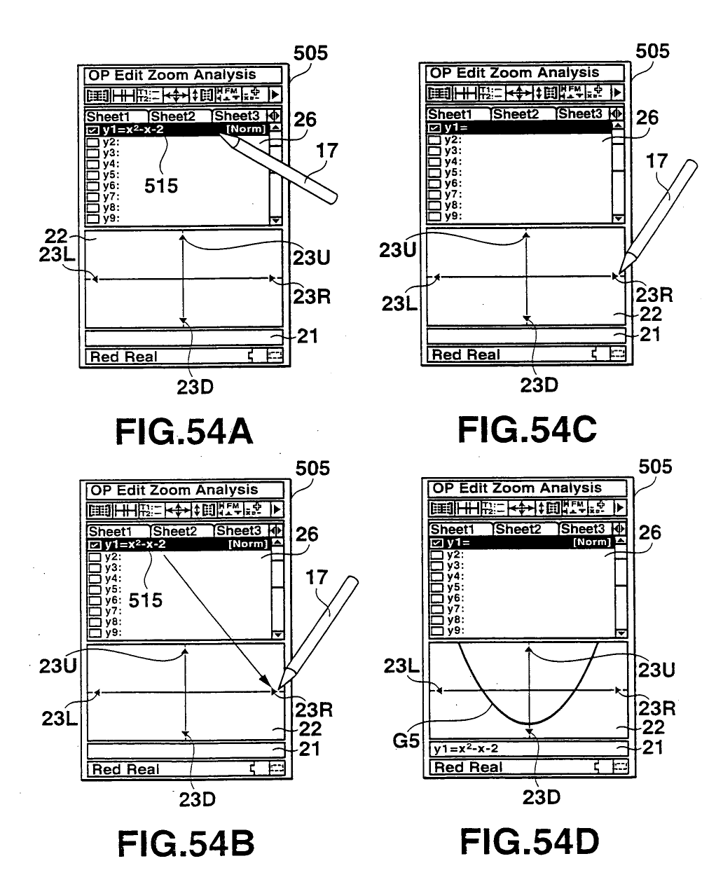

The function equation registration control process performed by the CPU 31 according to the function equation registration control program 631A will be described with reference to FIGS. 53 and 54A to 54D. FIG. 53 shows an operation flow of the function electronic calculator 1, and FIGS. 54A to 54D are diagrams showing transition examples of a screen displayed on the display device 38.

When the graph mode is instructed by the mode switch operation, the CPU 31 starts execution of a predetermined program relating to the graph mode to set the graph mode, and waits for inputting of the setting items relating to the drawing of the graph such as inputting of a function equation or a display range of the graph to be drawn. As shown in FIG. 53, when the CPU 31 detects an operation of the function equation input area 26 by the input pen 17 (step R1), the CPU 31 detects a function equation selected by the operation (step R2; refer to FIG. 54A). FIG. 54A shows one example of the display screen 505 when a function equation 515 displayed in the function equation input area 26 is tapped in by the input pen 17.

When the CPU 31 detects a drag/drop operation of the selected function equation (step R3; refer to FIG. 54B), the CPU 31 performs a detection of a drop position (step R4). The CPU 31 determines whether or not on which of the four graph controllers 23 the drop position is (step R5), and performs other process (step R6) in the case of other than the graph controllers 23 (step R5: No).

When the drop position is on any one of the four graph controllers 23 (step R5: Yes), the graph controller 23 and the selected function equation are stored in the function equation data storage area 731A in a corresponding manner (step R7). For example, as shown in FIG. 54B, when the function equation 515 is selected and dragged, and then the function equation 515 is dropped at the position of, for example, the graph controller 23R among the four graph controllers 23, the dropped function equation 515 and the graph controller 23R are corresponded to each other and stored in the function equation data storage area 731A.

When the CPU 31 detects an operation of the graph controller 23 (step R8; refer to FIG. 54C), the CPU 31 determines whether or not a function equation corresponded to the operated graph controller 23 is stored in the function equation data storage area 731A (step R9). When the function equation is not stored (step R9: No), the CPU 31 performs other process (step R11). When the corresponding function equation is stored (step R9: Yes), the CPU 31 performs the graph drawing process on the basis of the function equation (step R10; refer to FIG. 54D).

FIG. 54D is a diagram showing one example of the display screen 505 at this stage. A graph G5 is displayed on the graph display device 22 on the basis of the function equation stored in the function equation data storage area 731 in correspondence to the operated graph controller 23. Further, the function equation 525 corresponding to this graph G5 is displayed in the equation display area 21.

The CPU 31 monitors the terminating operation, and determines whether or not the graph controller 23 has been operated by the input pen 17 (step R12). When it is determined that the terminating operation has been detected (step R12: Yes), the present process is terminated. When it is determined that the graph controller 23 has been operated by the input pen 17, the process returns to step R8.

As described above, according to the sixteenth embodiment, a function equation can be registered to each graph controller 23. Therefore, when the user registers a function equation to the graph controller 23, and then performs a tap operation for the registered graph controller 23, he/she can easily and rapidly display the graph corresponding to the function equation registered for the graph controller 23.

### Seventeenth Embodiment

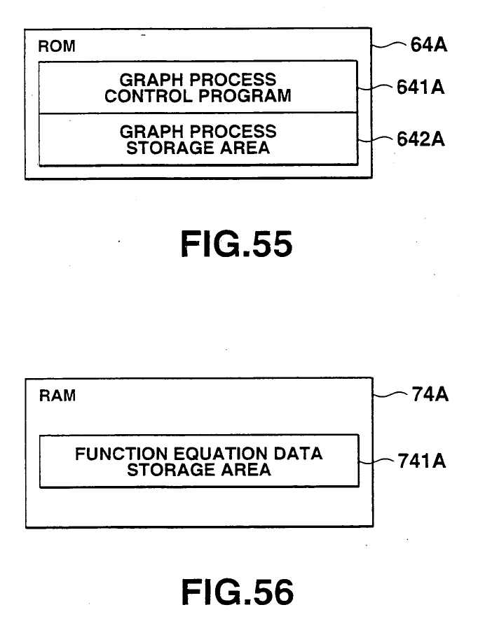

A seventeenth embodiment according to the present invention will be described. Since a configuration of a function electronic calculator according to the present embodiment is similar to a configuration where the ROM 32A and the RAM 33A are replaced with a ROM 64A shown in FIG. 55 and a RAM 74A shown in FIG. 56, respectively, in the configuration of the function electronic calculator 1 described in FIG. 39 according to the twelfth embodiment, like numerals are denoted to like constituents and a description thereof will be omitted below.

As shown in FIG. 55, the ROM 64A stores a graph calculation control program 641A and a graph calculation storage area 642A therein. The graph calculation control program 641A is a program for causing the CPU 31 to perform a graph calculation control process of dragging/dropping a function equation in the graph controller 23 to which various calculation processes are registered, and performing a calculation process registered for a graph based on the function equation. The respective graph controllers 23 and various calculation processes are stored in the graph calculation storage area 642A in a corresponding manner. For example, the graph controller 23R and the tangent process, the graph controller 23U and the integral process, and the like are corresponded to each other and stored, respectively. Here, the tangent process is a process of finding a tangent of a graph, and the integral process is a process of integrating a graph.

As shown in FIG. 56, the RAM 74A comprises a function equation data storage area 741A. A function equation corresponding to the graph displayed on the display device 38 is stored in the function equation data storage area 741A.

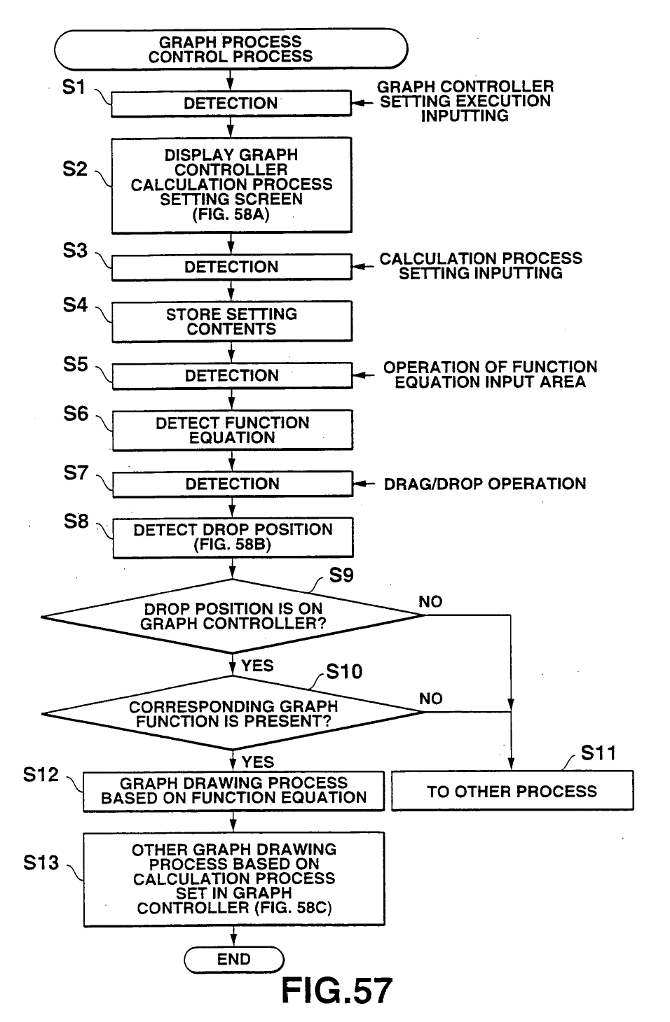

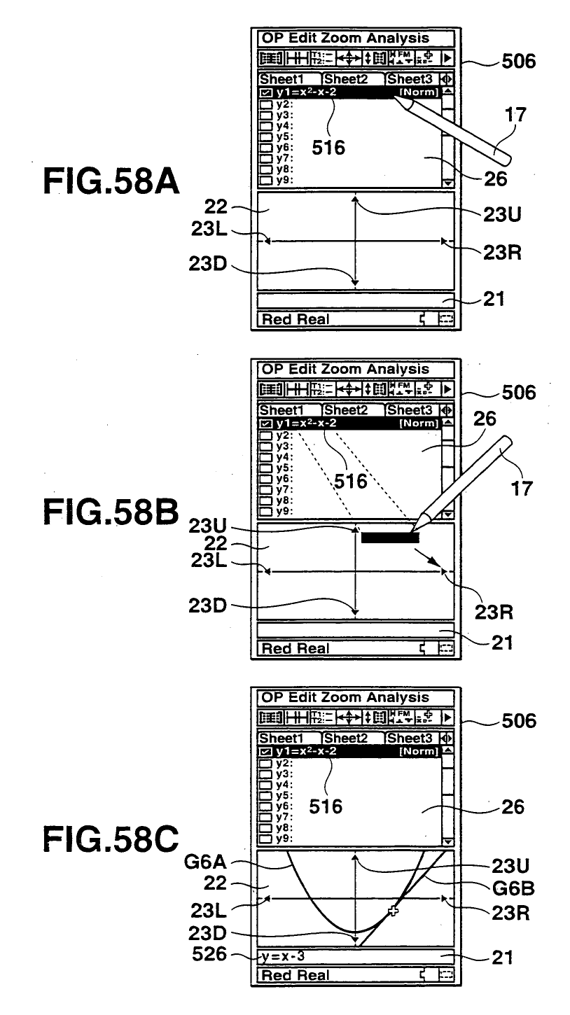

The graph calculation control process performed by the CPU 31 according to the graph calculation control program 641A will be described with reference to FIGS. 57 and 58A to 58C. FIG. 57 shows an operation flow of the function electronic calculator 1, and FIGS. 58A to 58C are diagrams showing transition examples of a screen displayed on the display device 38.

When the graph mode is instructed by the mode switch operation, the CPU 31 starts execution of a predetermined program relating to the graph mode to set the graph mode, and waits for inputting of the setting items relating to the drawing of the graph such as inputting of a function equation or a display range of the graph to be drawn. As shown in FIG. 57, when the CPU 31 detects graph controller setting execution inputting (step S1), the CPU 31 displays a graph controller calculation process setting screen on the display device 38 (step S2; refer to FIG. 58A). The graph controller calculation process setting screen is not shown, but is a setting screen by which the user registers an arbitrary calculation process to each graph controller 23. The CPU 31 stores setting contents in the graph process storage area 642A (step S4).

When the CPU 31 detects an operation of the function equation input area 26 by the input pen 17 (step S5), the CPU 31 detects a function equation selected by the operation (step S6). FIG. 58A shows one example of the display screen 506 when the function equation 516 displayed in the function equation input area 26 is tapped in by the input pen 17 in step S6.

When the CPU 31 detects a drag/drop operation of the selected function equation (step S7), the CPU 31 performs a detection of a drop position (step S8). The CPU 31 determines whether or not the drop position is on the graph controller 23 (step S9), and performs other process (step S11) in the case of other than the graph controller 23 (step S9: No).

When the drop position is on the graph controller 23 (step S9: Yes), it is determined whether or not the graph controller and the calculation process are corresponded to each other and stored in the graph process storage area 642A (step S10). When the corresponding calculation process is not present (step S10: No), the CPU 31 performs other process (step S11).

When the corresponding calculation process is present (step S10: Yes), the CPU 31 performs the graph drawing process on the basis of the selected function equation (step S12), and further performs the corresponding calculation process for the graph (step S13; refer to FIG. 58C).

Specifically, as shown in FIG. 58B, assuming that, for example, a tangent process is previously registered in the graph controller 23R, when the function equation 516 is selected and dragged, and then the selected function equation 516 is dropped on the position of the graph controller 23R, the corresponding graph G6A is displayed on the basis of the function equation 516 as shown in FIG. 58C. At the same time, the tangent process for the displayed graph G6A is performed, and the corresponding tangent G6B is drawn and processed on the basis of this performed tangent process, and further the function equation 526 corresponding to the drawn and processed tangent G6B is displayed in the equation display area 21.

Similarly, assuming that, for example, an integral process is previously registered in the graph controller 23L, when the function equation is selected and dragged, and the selected function equation 516 is dropped on the position of the graph controller 23L, the corresponding graph is displayed on the basis of the function equation 516. At the same time, the integral process for the displayed graph is performed, and the integral drawing process for the displayed graph is performed on the basis of this performed integral process, and the function equation 526 corresponding to the drawn and processed integral is displayed in the equation display area 21.

As described above, according to the seventeenth embodiment, a graph corresponding to a function equation can be displayed by a simple operation of registering a calculation process to any one of the respective graph controllers 23, and then dropping the function equation on any position of the graph controllers 23 to which the calculation process is registered. At the same time, the calculation process corresponded to the graph controller 23 is performed for this displayed graph so that other graph drawing process for the graph can be performed. Therefore, the graph based on the function equation and the graph based on the calculation process registered in the graph controller are associated to each other, thereby being simultaneously or continuously drawn and displayed.

A description is given to the twelfth to seventeenth embodiments, but the graphic display control device according to the present invention is not limited to the above embodiments, and various modifications can be naturally applied within the range without departing from the spirit of the present invention.

For example, in each embodiment described above, there is shown an example where three display devices of the function equation input area 26 in FIG. 38 or the display device 38 in FIG. 39 which is a function equation display device for displaying a plurality of registered function equations, the graph display area 22 in FIG. 38 or the display device 38 in FIG. 39 which is a graph display device for displaying a graph, and the equation display area 21 in FIG. 38 or the display device 38 in FIG. 39 which is an equation display device for displaying an equation are partitioned and provided on the single display panel, but, not limited to this, the three display devices may be arranged and provided at physically distant positions.

The above embodiment relates to a graphic display control device comprising an equation display device (for example, the equation display area 21 in FIG. 38; the display device in FIG. 39) which displays an equation and a graph display device (for example, the graph display area 22 in FIG. 38; the display device 38 in FIG. 39) which displays a graph based on the equation and the coordinate axes, which comprises a registering unit (for example, the CPU 31 in FIG. 39; step Q11 in FIG. 49) which, when a first operation (for example, the CPU 31 in FIG. 39; step Q5 in FIG. 49; FIG. 50C) of designating or selecting a coefficient of an equation displayed on the equation display device and a second operation (for example, the CPU 31 in FIG. 39; step Q7 in FIG. 31; FIG. 51A) for a predetermined portion of the coordinate axes displayed on the graph display device after the first operation are performed, registers the coefficient designated or selected by the first operation in the predetermined portion of the coordinate axes, a coefficient changing unit (for example, the CPU 31 in FIG. 39; step Q15 in FIG. 49) which, when a third operation (for example, the CPU 31 in FIG. 39; step Q12 in FIG. 49; FIG. 51B) for the predetermined portion of the coordinate axes is performed after the coefficient is registered by this registering means, changes a value of the registered coefficient, and a graph redisplay control unit (for example, the CPU 31 in FIG. 39; step Q16 in FIG. 49; FIG. 51C) which redisplays a graph displayed on the graph display device along with the change in the coefficient by this coefficient changing unit.

According to this embodiment, a value of the registered coefficient can be changed and the graph displayed on the graph display device can be redisplayed along with this change in the coefficient by a simple operation where when the two operations of the first operation of designating or selecting a coefficient of an equation displayed on the equation display device and the second operation for the predetermined portion of the coordinate axes displayed on the graph display device after the first operation are performed, the coefficient of the function equation displayed on the equation display device is registered in the predetermined portion of the coordinate axes, and then the second operation is performed for the predetermined portion of the coordinate axes. Therefore, the user can easily confirm a change in the shape of the graph along with the change in the registered coefficient.

Another embodiment relates to a graphic display control device comprising a function equation display device (for example, the function equation input area 26 in FIG. 38; the display device 38 in FIG. 39) which displays a function equation and a graph display device (for example, the graph display area 22 in FIG. 38; the display device 38 in FIG. 39) which displays a graph and the coordinate axes, which comprises a display control unit (for example, the PCU 31 in FIG. 39) which, when a first operation (for example, the CPU 31 in FIG. 39; step R1 in FIG. 53; FIG. 54A) of designating or selecting a function equation displayed on the function equation display device and a second operation (for example, the CPU 31 in FIG. 39; step R3 in FIG. 53; FIG. 54B) of moving the function equation designated or selected by this first operation to the graph display device after the first operation are performed, displays and controls a graph based on the designated or selected function equation on the graph display device, a registering unit (for example, the PCU 31 in FIG. 39; step R7 in FIG. 53) which, when a third operation (for example, the CPU 31 in FIG. 39; step R8 in FIG. 53; FIG. 54C) for a predetermined portion of the coordinate axes displayed on the graph display device is performed after the first operation for a function equation displayed on the function equation display device, registers the function equation designated or selected by the first operation in the predetermined portion of the coordinate axes, and a registered graph display control unit (for example, the CPU 31 in FIG. 39; step R10 in FIG. 53; FIG. 54D) which, when the third operation is performed after the function equation designated or selected by the first operation is registered in the predetermined portion of the coordinate axes by this registering means, displays and controls a graph based on the registered function equation on the graph display device.

According to the another embodiment, when the third operation for the predetermined portion of the coordinate axes displayed on the graph display device is performed after the first operation for the function equation displayed on the function equation display device, the function equation designated or selected by the first operation is registered in the predetermined portion of the coordinate axes, and then the third operation for the predetermined portion of the coordinate axes is performed so that the graph based on this registered function equation can be displayed and controlled on the graph display device. Therefore, the user can rapidly and easily display the graph corresponding to the registered function equation by performing the third operation for the predetermined portion of the coordinate axes at an arbitrary timing after he/she registers the function equation in the predetermined portion of the coordinate axes.

Another embodiment relates to a graphic display control device comprising a function equation display device (for example, the function equation input area 26 in FIG. 38; the display device 38 in FIG. 39) which displays a function equation and a graph display device (for example, the graph display area 22 in FIG. 38; the display device 38 in FIG. 39) which displays a graph and the coordinate axes, which comprises a display control unit (for example, the CPU 31 in FIG. 39) which, when a first operation (for example, the CPU 31 in FIG. 39; step S5 in FIG. 57; FIG. 58A) of designating or selecting a function equation displayed on the function equation display device and a second operation (for example, the CPU 31 in FIG. 39; step S7 in FIG. 57; FIG. 58B) of moving the function equation designated or selected by this first operation to the graph display device are performed, displays and controls a graph based on the function equation designated or selected by the first operation on the graph display device, a registering unit (for example, the CPU 31 in FIG. 39; step S4 in FIG. 57) which registers a predetermined calculation process by a third operation for a predetermined portion of the coordinate axes, and a calculation result graph display control unit (for example, the CPU 31 in FIG. 39; step S13 in FIG. 57; FIG. 58C) which, when the first operation for the function equation displayed on the function equation display device and a fourth operation for the predetermined portion of the coordinate axes are performed, displays and controls a graph as a result of execution of the calculation process for a graph based on the function equation designated or selected by the first operation on the graph display device.

According to the another embodiment, the calculation process corresponded to the predetermined portion can be performed and the graph as a result of this execution can be displayed and controlled on the graph display device by a simple operation of registering the calculation process in the predetermined portion of the coordinate axes, and then moving the designated or selected function equation to the predetermined portion on the coordinate axes. Therefore, the user can easily perform the calculation process for the graph.

### Eighteenth Embodiment

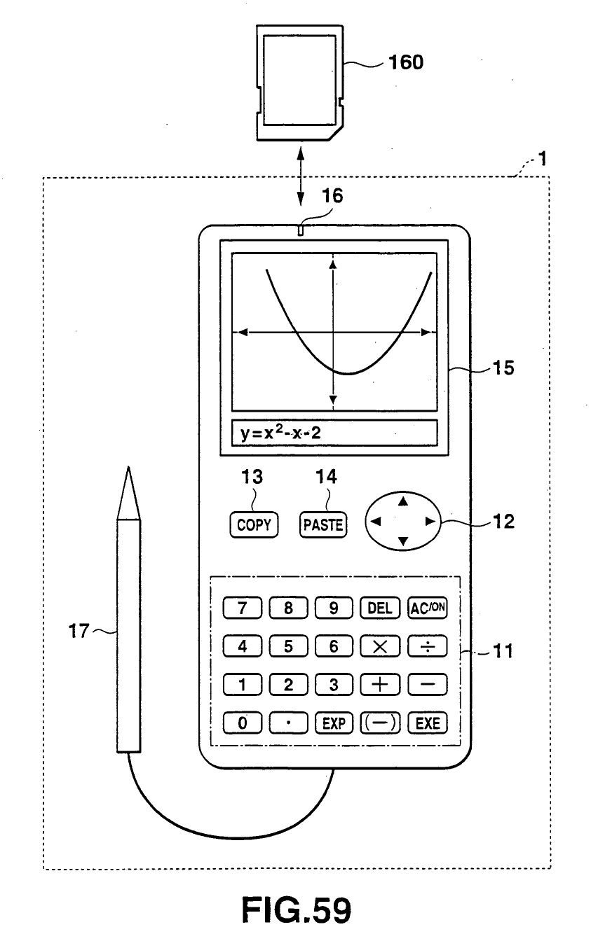

Hereinafter, an eighteenth embodiment of a graphic display control device according to the present invention will be described in detail with reference to FIGS. 59 to 64A to 64E. In the following, the present invention will be described by way of an example of a case where a graph function electronic calculator (simply referred to as “function electronic calculator”, hereinafter) having a graph display function is applied, but the present invention is not limited thereto.

FIG. 59 is a view showing one example of an appearance of the function electronic calculator 1 according to the present embodiment. A case where a typical function electronic calculator is applied is exemplified as the function electronic calculator 1, but a calculation device (computer) comprising a calculating function may be employed and the function electronic calculator is not limited to the above.

The function electronic calculator 1 comprises a calculation unit (not shown) which performs a calculation process, the operation input keys 11 which perform inputting of numeric/function/calculation operation, the direction key 12 which performs scrolling of a screen or selection operation, a copy key 13, a paste key 14, the display screen 15 which displays input numerals or graphs, the input pen 17, and the power supply (not shown) such as an incorporated battery or a solar battery. The function electronic calculator 1 is cased, for example, in a card shape by a metal or a resin.

The operation input keys 11 and the direction key 12 are operation inputting means similar to the conventional function electronic calculator 1, and can be realized by a key switch, a touch panel, or the like, for example. The copy key 13 is a key for storing characters and the like selected on the display screen 15 in an internal buffer (not shown). The paste key 14 is a key for displaying the characters and the like stored in the internal buffer by the copy key 13 on the display screen 15.

The display screen 15 is a portion on which various data such as characters, codes, or graph displays in response to the pressing of the operation input keys 11, the paste key 14, or the like, which are required for using the function electronic calculator 1, are displayed, and on which characters or graphics are displayed by dots. The display screen 15 is an element such as a LCD (Liquid Crystal Display) or an ELD (Electronic Luminescent Display), and can be realized by a single element or a combination of several elements.

The function electronic calculator 1 comprises the slot 16 for the storage medium 160. The storage medium 160 is a storage medium which stores function equation data and the like therein, such as, for example, a memory card, or a hard disk. The slot 16 is a device which detachably mounts the storage medium 160 and can read/write data from/into the storage medium 160, and is appropriately selected according to the type of the storage medium 160.

The tablet (touch panel) is integrally constituted on the display screen 15, where press-inputting by the input pen 17 can be sensed.

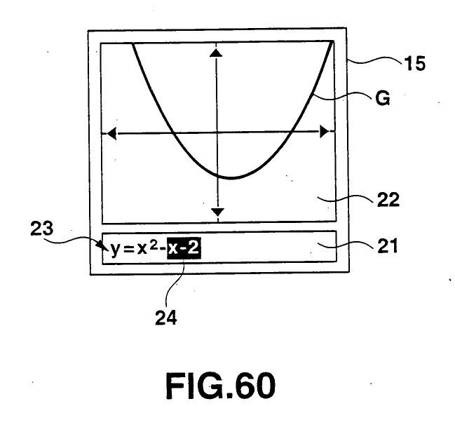

FIG. 60 is a diagram for explaining a display configuration of the display screen 15. A display area of the display screen 15 is divided into the function equation display area 21 and the graph display area 22. A function equation 23 input by the operation of the operation input keys 11 is displayed in the function equation display area 21. Further, when part of the function equation 23 is selected by dragging of the input pen 17, the light and dark of the selected area is inverted and displayed like a portion 24.

For example, assuming that the function equation 23 of “y=x²−x−2” is input by the user. When the user uses the input pen 17 to tap in a position where “x” is displayed in the function equation display area 21 and to drag to “2”, an equation of “x−2” is selected, and a display area of “x−2” is inverted for the light and dark to be displayed like the portion 24.

Here, “tap-in” means an operation of contacting the input pen 17 on the display screen 15. “Tap-out” means an operation of releasing the input pen 17 from the display screen 15 after touched, and “drag” means an operation of sliding the input pen 17 onto the display screen 15 from tap-in to tap-out.

A graph G corresponding to the function equation 23 displayed in the function equation display area 21 is displayed in the graph display area 22 according to an instruction operation key (for example, execution (EXE) key) which instructs to display a graph. Alternatively, when part (equation indicated in the portion 24) of the function equation 23 selected by the input pen 17 is dropped in the graph display area 22, a graph corresponding to the part of the equation is displayed. Assuming that a horizontal direction in the graph display area 22 is an x-axis and a longitudinal direction is a y-axis. Here, drop means an operation of tap-out after drag is performed.

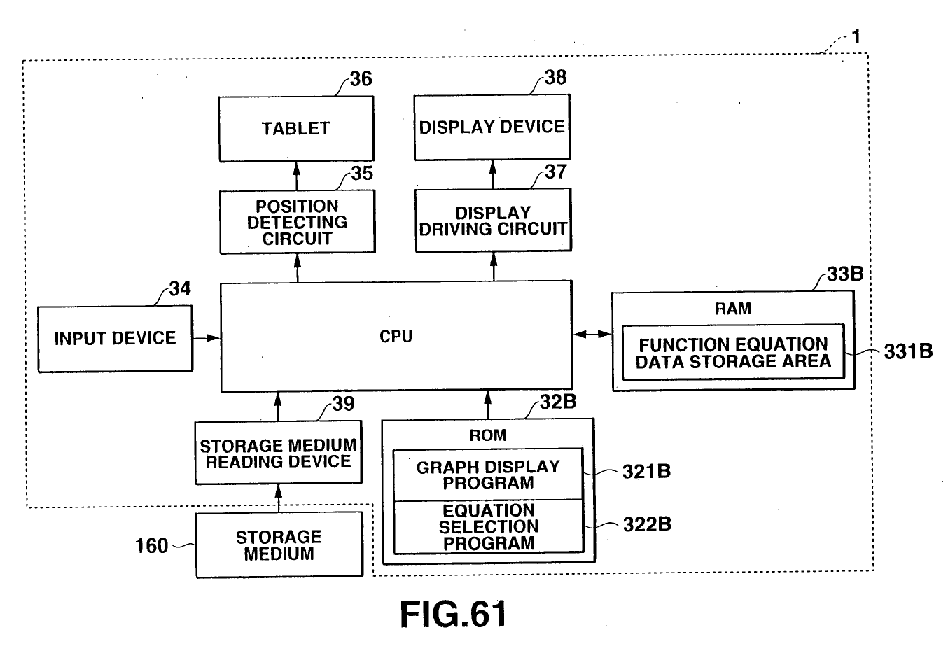

FIG. 61 is a block diagram showing a configuration of the function electronic calculator 1. As illustrated, the function electronic calculator 1 is constituted by the CPU (Central Processing Unit) 31, a ROM (Read Only Memory) 32B, a RAM (Random Access Memory) 33B, the input device 34, the position detecting circuit 35, the tablet 36, the display driving circuit 37, the display device 38, and the storage medium reading device 39.

The CPU 31 performs a process based on a predetermined program in response to an input instruction, and performs instructing to each function section, transferring of data, and the like. Specifically, the CPU 31 reads out a program stored in the ROM 32B in response to an operation signal input from the input device 34 or the table 36, and performs a process according to the program. The CPU 31 stores a process result in the RAM 33B and appropriately outputs a display signal for displaying the process result to the display driving circuit 37 so as to display the display information corresponding to the display signal on the display device 38.

The ROM 32B stores various process programs relating to the operation of the function electronic calculator 1 such as various setting processes and various calculation processes, applications for realizing various functions which the function electronic calculator 1 comprises, and the like therein. Further, the ROM 32B stores a graph display program 321B and an equation selection program 322B therein.

The graph display program 321B is a program for causing the CPU 31 to realize a function of forming a graph by performing calculation based on a function equation stored in a function equation data storage area 331B described later, and displaying a plot at a corresponding coordinate position on the display device 38.

The equation selection program 322B is a program for causing the CPU 31 to realize a function of forming a graph by performing the graph display program 321B when part of a function equation displayed on the display device 38 is dragged by a touch operation of the input pen 17 on the tablet 36, and is dropped in the graph display area 15.

The RAM 33B comprises a memory area which temporarily holds various programs performed by the CPU 31, data relating to execution of these programs, and the like. Particularly, the RAM 33B comprises the function equation data storage area 331B which holds a function equation of a graph to be drawn, and the like.

The input device 34 is means by which the user inputs numerals, execution instruction of the calculation process, and the like, and corresponds to the operation input keys 11, the direction key 12, the copy key 13, and the paste key 14 in the example in FIG. 59. A signal corresponding to the key pressed by the user is output to the CPU 31. The input device 34 may include a pointing device such as a mouse, or the like.

The function electronic calculator 1 comprises the tablet (touch panel) 36 as an input device. This tablet 36 is a device which senses a position in the display area of the display device 38 indicated (touched) by an input pen (corresponding to the input pen 17 shown in FIG. 59) for instructing a position on the display area of the display device 38, and outputs a signal according to the position indicated (touched) in the display area. The position detecting circuit 35 connected to the tablet 36 detects a position coordinate indicated on the display device 38 on the basis of the signal input from the tablet 36. When this tablet 36 is used, the position in the display area of the display device 38 can be directly designated. Particularly, the input pen 17 is touched on the tablet 36 so that operations such as tap-in, drag, tap-out, and drop can be realized.

The display driving circuit 37 controls the display device 38 on the basis of the display signal input from the CPU 31 and causes it to display various screens. The display device 38 is constituted by a LCD, an ELD, or the like. This display device 38 corresponds to the display screen 15 shown in FIG. 59, and is integrally formed with the tablet 36.

The storage medium reading device 39 is a function section for performing reading/writing of data from/into the storage medium 160 such as, for example, a memory card, or a hard disk. The slot 16 in FIG. 59 corresponds thereto.

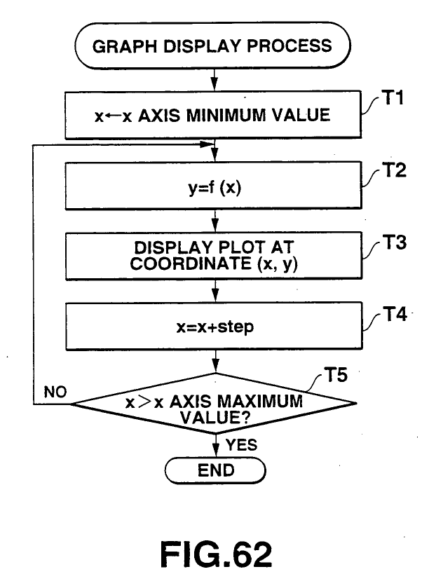

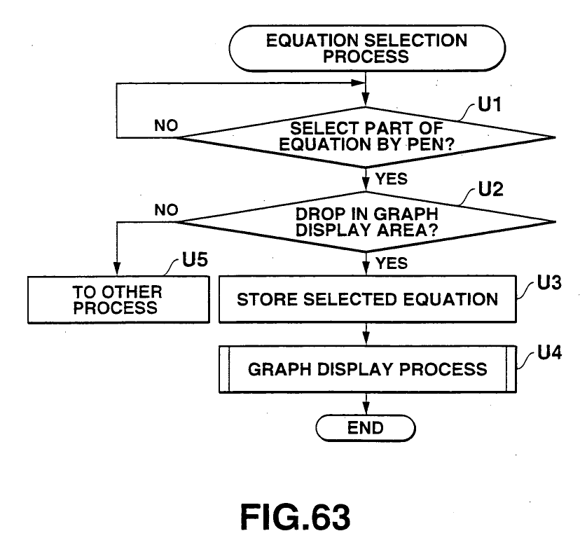

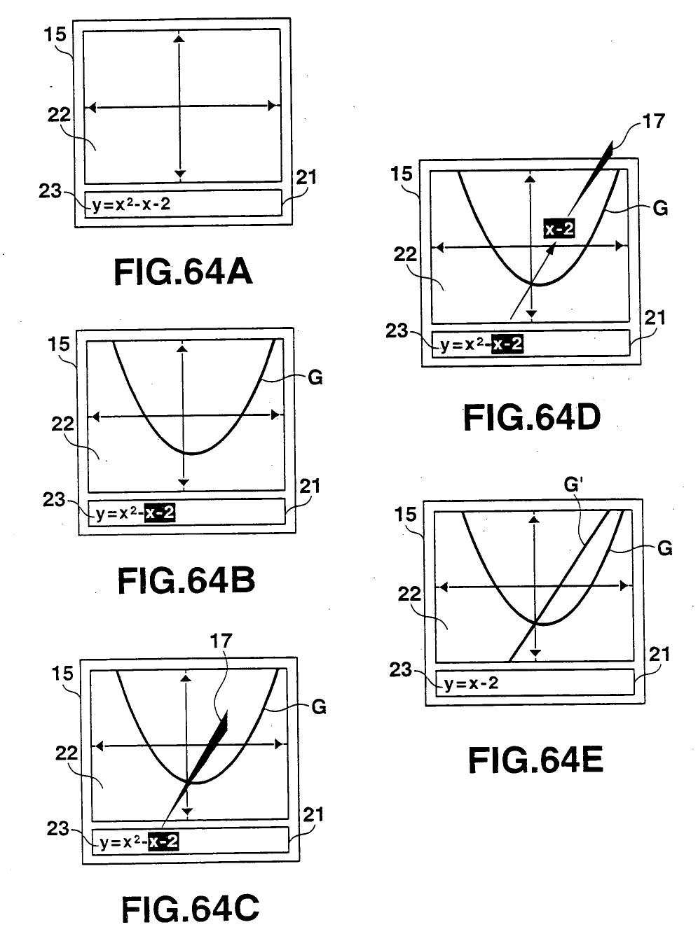

FIG. 62 is a flow chart for explaining an operation of the graph display control process performed by the function electronic calculator 1, and FIG. 63 is a flow chart for explaining an operation of the equation selection process performed by the function electronic calculator 1. FIGS. 64A to 64E are diagrams showing transition examples of a screen displayed on the display device 38. A flow of the process where when part of the function equation 23 displayed in the function equation display area 21 is dragged and dropped in the graph display area 22, a graph corresponding to the part of the function equation is displayed will be described using FIGS. 62 to 64A to 64E.

In FIGS. 64A to 64E, when the function equation 23 is input by the operation of the input device 34 by the user, the CPU 31 outputs a signal corresponding to the pressed signal of the input device 34 to the display driving circuit 37. The display driving circuit 37 outputs characters (function equation 23) to the function equation display area 21 according to the signal input from the CPU 31. The CPU 31 stores the input function equation in the function equation data storage area 331 (FIG. 64A).

When the instruction operation key for instructing to display a graph corresponding to the function equation 23 displayed in the function equation display area 23 is pressed, the CPU 31 performs the graph display process on the basis of the graph display program 321B.

As shown in FIG. 62, at first the CPU 31 substitutes a minimum value of the x-axis into the variable “x” (step T1). The minimum value of the x-axis is data previously set such as before the present process is performed.

The CPU 31 reads out a function equation of y=f(x) (“y=x²—x−2” in FIG. 64A) stored in the function equation data storage area 331B, and substitutes the value of the variable “x” into the function equation to find a value of “y” (step T2). A plot is displayed at the corresponding position on the coordinate displayed on the display device 38 on the basis of the values of the variables “x” and “y” (step T3).

The CPU 31 adds the value of the variable “step” to the variable “x” (step T4). The variable “step” is the amount of increase per one dot in the x-axis of the coordinate displayed on the display device 38. The variable “step” is previously set such as before the graph display process is performed.

The CPU 31 compares the value of the variable “x” in the function equation of y=f(x) and a maximum value of the x-axis (step T5). The maximum value of the x-axis is data previously set such as before the present process is performed. When the value of the variable “x” is larger than the maximum value of the x-axis (step T5: Yes), the CPU 31 terminates the process. When the value of the variable “x” is not larger than the maximum value of the x-axis (step T5: No), the CPU 31 proceeds the process to step T2.

A graph corresponding to the function equation 23 is displayed in the graph display area 22 by execution of the graph display process by the CPU 31 (FIG. 64B). The CPU 31 performs the equation selection process on the basis of the equation selection program 322B.

As shown in FIG. 63, the CPU 31 determines whether or not part of the function equation 23 displayed in the function equation display area 21 has been selected by the drag operation of the input pen 17 (step U1). When it has been selected (step U1: Yes; FIG. 64C), it is determined whether or not the selected part of the function equation 23 has been dropped in the graph display area 22 (step U2). When is has not been dropped in the graph display area 22 (step U2: No), the CPU 31 proceeds to other process (step U4).

When it has been dropped in the graph display area 22 (step U2: Yes; FIG. 64D), the CPU 31 converts the selected part of the function equation 23 into a form of the function equation of y=f(x) (for example, “y=x−2” in FIG. 64E) to store it in the function equation data storage area 331B (step U3), and proceeds the process to the graph display process (step U4).

The graph G′ is displayed in the graph display area 22 as shown in FIG. 64E by the graph display process in step U4 in FIG. 63. When a plurality of graphs are displayed in the graph display area 22, a function equation of a graph in an active state (selected state) is displayed in the function equation display area 21. In the case of FIG. 64E, the function equation of “y=x−2” of the graph G′ is displayed.

As described above, part of the function equation 23 displayed in the function equation display area 21 is selected by the input pen 17, and is dropped in the graph display area 22 so that a graph corresponding to the part of the equation can be easily displayed. In other words, when the graph corresponding to the part of the function equation 23 is desired to display, the graph can be displayed by the drag & drop operation by the input pen 17 without the need to input the part of the equation as a new function equation again. Therefore, it can be easily confirmed how the part of the function equation 23 is concerned with the function equation 23 or the graph.

The graphic display control device according to the present embodiment is not limited to the above illustrated embodiments, and various modifications can be naturally applied within the range without departing from the spirit of the present invention.

A description is given by way of the case where the input pen 17 is used to realize the copy operation in order to select part of the function equation 23 displayed in the function equation display area 21, but part of the equation may be selected by using the direction key 12, the EXE key, or the like. Specifically, in FIG. 60, the direction key 12 is used to move the cursor to the position of “x” in the function equation 23 in the function equation display area 21 and to press the EXE key. The direction key 13 is reused to move the cursor to the position of “2” and to press the EXE key so that “x−2” is selected. When an equation selected by the pressing of the copy key 13 is assumed to be “y=x−2” to be stored in the RAM 33B and the paste key 14 is pressed in the state where the graph display area 22 is selected, a graph corresponding to “y=x−2” stored in the RAM 33B is displayed in the graph display area 22. The copy operation may be realized in this manner.

As described above, this embodiment relates to a graphic display control device which comprises a first display device (for example, the function equation display area 21 in FIG. 60) to display a function equation and a second display device (for example, the graph display area 22 in FIG. 60) which displays a graph, and is directed for displaying and controlling a graph based on a function equation displayed on the first display device on the second display device, comprising a display control unit (for example, the CPU 31 in FIG. 61; step T3 in FIG. 62) which, when a predetermined copy operation is performed for part of a function equation displayed on the first display device, assumes the part as a function equation, and displays and controls a graph based on the assumed function equation on the second display device.

According to another embodiment, a graph corresponding to part of the function equation displayed on the first display device can be easily displayed. For example, when a function equation is polynomial and a graph corresponding to part thereof is desired to display, it is not necessary to input the partial term as a new function equation again, and a predetermined copy operation is performed so that the graph can be easily displayed. Therefore, it can be easily confirmed how the part of the function equation is concerned with the entire function equation or the graph.

What is claimed is:

1. A graphic display control device comprising:
a first display area which displays a function equation;
a second display area which displays a first graph corresponding to the function equation displayed in the first display area;
a selector to select a part of the function equation displayed in the first display area in accordance with a user operation;
a detector to detect, after the selector selects the part of the function equation, a user-input instruction to display a graph corresponding to the selected part of the function equation; and
a graph display controller which displays a second graph in the second display area based on the selected part of the function equation when the detector detects the instruction after the selector selects the part of the function equation.

2. The graphic display control device according to claim 1, wherein the instruction detected by the detector comprises a designation of the second display area by a user operation after the selector selects the part of the function equation.

3. The graphic display control device according to claim 1, further comprising:
an equation display controller which displays the selected part of the function equation in the first display area.

4. The graphic display control device according to claim 1, further comprising:
a touch pen;
wherein the selector selects the part of the function equation in accordance with a touch operation with the touch pen, and the instruction detected by the detector comprises a designation of the second display area with the touch pen.

5. The graphic display control device according to claim 1, wherein the graph display controller displays the second graph so as to overlap with the first graph.

6. A graphic display control device comprising:
means for displaying a function equation in a first display area;
means for displaying a first graph corresponding to the displayed function equation in a second display area;
means for selecting a part of the function equation displayed in the first display area in accordance with a user operation;
means for detecting, after the part of the function equation is selected, a user-input instruction to display a graph corresponding to the selected part of the function equation; and
graphic display control means for displaying a second graph in the second display area based on the selected part of the function equation when the detecting means detects the instruction after the selecting means selects the part of the function equation.

7. The graphic display control device according to claim 6, wherein the instruction detected by the detecting means comprises a designation of the second display area by a user operation after the selecting means selects the part of the function equation.

8. The graphic display control device according to claim 6, further comprising:
equation display control means for displaying the selected part of the function equation in the first display area.

9. The graphic display control device according to claim 6, further comprising:
a touch pen;
wherein the selecting means selects the part of the function equation in accordance with a touch operation with the touch pen, and the instruction detected by the detecting means comprises a designation of the second display area with the touch pen.

10. The graphic display control device according to claim 6, wherein the graph display control means displays the second graph so as to overlap with the first graph.

11. A computer-readable recording medium having a computer program stored therein that is executable by a CPU of a graphic display control device to cause the CPU to execute functions comprising:
displaying a function equation in a first display area of the graphic display control device;
displaying a first graph corresponding to the displayed function equation in a second display area of the graphic display control device;
selecting a part of the function equation displayed in the first display area in accordance with a user operation;
detecting, after the part of the function equation is selected, a user-input instruction to display a graph corresponding to the selected part of the function equation; and
displaying a second graph in the second display area based on the selected part of the function equation when the instruction is detected after the part of the function equation is selected.

12. The graphic display control device according to claim 11, wherein the user-input instruction comprises a designation of the second display area by a user operation after the part of the function equation is selected.

13. The graphic display control device according to claim 11, further comprising:
displaying the selected part of the function equation in the first display area.

14. The graphic display control device according to claim 11, wherein the part of the function equation is selected in accordance with a touch operation with a touch pen, and the user-input instruction comprises a designation of the second display area with the touch pen.

15. The graphic display control device according to claim 11, wherein the second graph is displayed so as to overlap with the first graph.
